(19) United States
(12) Patent Application Publication
(10) Pub. No.: US 2022/0222591 A1
(43) Pub. Date: Jul. 14, 2022

(54) A COMPUTER-ENABLED METHOD, SYSTEM AND COMPUTER PROGRAM FOR PROVIDING AN INTUITIVE USER INTERFACE ARRANGED TO CREATE A DYNAMIC FLOOR PLAN UTILISABLE BY AN ALLOCATION ALGORITHM TO PERFORM THE TASK OF ALLOCATING A SPACE, FURNITURE, EQUIPMENT OR SERVICE

(71) Applicant: GRAND PERFORMANCE ONLINE PTY LTD, Sydney, New South Wales (AU)

(72) Inventor: Peter PETROULAS, Sydney (AU)

(21) Appl. No.: 17/607,392

(22) PCT Filed: Apr. 28, 2020
(86) PCT No.: PCT/AU2020/050408

§ 371 Date: Oct. 28, 2021

(30) Foreign Application Priority Data
Apr. 29, 2019 (AU) 2019901444
Aug. 19, 2019 (AU) 2019903010
Sep. 20, 2019 (AU) 2019903511

(51) Int. Cl. G06Q 10/02; G06Q 10/04; G06Q 10/06

(52) U.S. Cl. CPC G06Q 10/025; G06Q 50/12; G06Q 10/06311; G06Q 10/04

(57) ABSTRACT

In one embodiment, there is provided a computer-enabled method for creating a volumetric space/time framework of constraints for the dynamic allocation of a booking request to one or more spaces in a venue. In one embodiment, the invention is directed to a computer-enabled method including a user interface accessible via a remote device such as a Point of Sale device, wherein the Point of Sale device is arranged to receive an interactive, real-time, dynamic floor plan including allocated and unallocated bookings, table numbers, chair position numbers and interact with a restaurant operator or operators.

### TECHNICAL FIELD

The present invention relates to a system, method and computer program for providing a dynamic and intuitive user interface arranged to create a floor plan utilisable by allocation methodologies, or one or more configurable allocation algorithms to perform the task of allocation of space in a restaurant.

In one embodiment, the invention is directed to a computer-enabled method including a user interface accessible via a remote device such as a Point of Sale device, wherein the Point of Sale device is arranged to receive an interactive, real-time, dynamic floor plan including allocated and unallocated bookings, table numbers, chair position numbers and interact with a restaurant operator or operators.

### BACKGROUND

To better understand the inventive concepts and embodiments of the invention described herein, an abridged history of the restaurant industry and known booking systems is may be found in an earlier filed PCT application PCT/AU2018/051168 (and co-pending PCT application PCT/AU2018/051169, PCT/AU2018/051170 and PCT/AU2018/051171), as well as Australian provisional application AU2019/900128.

To provide flexibility and efficient booking systems, restaurants require the ability to offer customised experiences for customers. Such customised experiences, have, in the past, been solely reliant on the staff of the restaurant performing various tasks manually, including interacting with customers, organising table allocations, providing specialised menus, providing specific ancillary services (such as the provision of flowers, etc.).

The earlier filed PCT applications listed above provide a system and method, which, amongst other tasks, is capable of offering a full and rich set of options to potential customers, including various dining times, menus, ancillary services, etc.

However, providing such a large range of options/potential outcomes requires a large amount of flexibility in a restaurant layout. The system and method outlined in the above-mentioned PCT applications is required to offer what is potentially a staggering number of interrelated options. To provide such an array of options relies on the ability of a restaurant operator to provide the “building blocks” which can be arranged in any number of manners to provide a multitude of solutions. It is also necessary to be able to communicate those solutions in a manner that is understandable and actionable by staff who have no specific expertise. It is known that restaurant staff develop certain habits and generally interact with restaurant booking systems in specific ways, and that restaurant staff, in general, have no specific training or knowledge of expert systems, programming, yield management or devising floor plans to optimise desired outcomes. To the extent that staff have any expertise in the aforementioned areas, it is generally ad hoc or based on information passed on by other individuals and is not based on a coherent set of principles and underlying interconnected framework for decision making.

Moreover, it is common nowadays for service providers to provide specific options to some customers and not to others, based on customer requirements. Such options require the relevant choice of options to be relayed to restaurant staff in a manner that is reliable, easy to understand and intuitive, so that the restaurant staff can provide correct and prompt service. Such options may involve additional cost and sometimes additional logistical considerations, such as the need to organise third party services. Such tasks require not only the relaying of information, but the application of cognitive ability and knowledge in order to provide a relevant service or product.

In the present specification, there is reference made to the use of “artificial intelligence”, which is generally acknowledged, in the context of the present specification, as referring to analytical artificial intelligence—namely, the ability of a software application to perform tasks that require some form of “cognitive intelligence”, including the ability to generate a cognitive representation of a real-world situation, and utilising past learning from the performance of similar tasks to inform present and future decisions regarding present and future tasks.

### SUMMARY

In a first aspect, there is provided a computer-enabled method for creating a volumetric space/time framework of constraints for the dynamic allocation of bookings to one or more spaces in a venue, comprising the steps of,

providing a user interface arranged to receive input regarding spatial and qualitative attributes of the one or more spaces as represented within a volumetric space/time framework, and also to receive input regarding physical and spatial and qualitative attributes of one or more furniture items including modifications to the furniture items and the associability of the one or more furniture items to the one or more spaces in the venue as represented within the volumetric space/time framework, whereby the attributes define a plurality of relativities and contextual relationships between the one or more spaces and each one of the one or more furniture items,

whereby the relativities and contextual relationships within the volumetric space/time framework provide dynamic variation in the allocation of furniture items within the one or more spaces in response to a booking request for one or more of the one or more furniture items in the one or more spaces in the venue, to satisfy quantitative and qualitative optimisation criteria associated with the booking request.

In one embodiment, the physical constraints include at least one of a dimension, a size and a shape of a space or furniture item.

In one embodiment, the further constraint includes a characteristic of the space or furniture item.

In one embodiment, a further constraint includes at least one of a set of products and services associated with at least one of a furniture item and the space to define the plurality of relativities, utilities, contextual relationships and contexts between the space and each one of the one or more furniture items.

In one embodiment, the method includes the further step of, upon receiving the booking request, collecting customer identity information, the customer identity information being utilisable to create or identify one or more further constraints associated with at least one of the space and the furniture items to define the plurality of relativities, utilities, contextual relationships and contexts between the space, each one of the one or more furniture items and at least one of a booking requestor and other persons associated with the booking request.

In one embodiment, the method includes the further step of identifying a channel associated with a booking request, the channel identity being utilisable to create or identify one or more further constraints associated with at least one of the space and the furniture items with at least one of the space and the furniture items defining the plurality of relativities, utilities, contextual relationships and contexts between the space, each one of the one or more furniture items and at least one of a booking requestor and other persons associated with the booking request.

In one embodiment, the set of products and services associated with the at least one of a furniture item and the space is further selected dependent upon at least one of the customer identity information and the channel identity.

In one embodiment, the relativity of one of the space or furniture items is a constraint that is only operational in specific placements of the space or furniture item relative to another space or furniture item.

In one embodiment, the utility of the one of the space or furniture items is a constraint that produces, when applied, a qualitative outcome, and is derived from one or more quantitative physical or operational constraints associated with the space or furniture item.

In one embodiment, the method includes the further step of utilising the volumetric space/time framework as an input to an allocation algorithm, wherein the allocation algorithm utilises the space/time framework to dynamically allocate furniture to allow for the allocation of a booking request.

In one embodiment, for each booking request in a plurality of received booking requests, the allocation algorithm iteratively allocating each booking request to produce an optimised allocation instruction set.

In one embodiment, the method includes the further step of displaying the optimised allocation instruction set on a graphical user interface.

In one embodiment, the optimised allocation instruction set is displayed as a two-dimensional floor plan.

In one embodiment, the allocation algorithm, on not being able to dynamically allocate a booking, varies at least one of the operational constraints to vary the plurality of relativities, utilities, contextual relationships and contexts between the space and each one of the one or more furniture items, to allow the allocation of the booking request.

In one embodiment, there is provided a further strategic framework arranged to interface with the allocation algorithm, the strategic framework including user selectable strategic constraints that define an integrated set of quantitative and qualitative criteria utilisable to vary the operational constraint information, whereby the strategic constraints are variable based on one of a threshold and an event value.

In one embodiment, the threshold value is associated with a seat which is in turn associated with a table, table combination or other furniture or fitting.

In one embodiment, the determination of the threshold value includes the selection of at least one of a table, table combination, other furniture or fittings to which a booking has been allocated to for a specific time period, a specific group size or other constraint information associated with the booking and the type of seats that can be utilised for that table or table combination.

In one embodiment, the determination of the threshold value includes the variables of at least one of a minimum or maximum preferred number of seats around a table, table combination, other furniture or fittings and the preferred physical locations of those seats, stool and seats around each table or table combination.

In one embodiment, the method includes the further step of varying the threshold value over time, whereby the varied thresholds is applied to re-allocate seats.

In one embodiment, the method includes the further step of arranging seats into sub-groupings and associating the seating sub-groupings with sub-groupings of tables, table combinations, other furniture and fittings utilising operational constraint information, whereby the allocation module iteratively allocates requests for each sub-group independently of other sub-groups.

In one embodiment, the method includes the step of the allocation module utilising physical and operational constraint information to allocate at least a sub-set of seats to tables, table combinations, other furniture or fittings in the space to one or more classes, whereby a ranking is associated with the at least a sub-set of the allocated seats with the tables, table combinations, furniture or fittings.

In one embodiment, the method includes the further step of utilising constraint information including the ranking of each seat, table, table combination, other furniture and fittings to create combined chair and table rankings within a venue and spaces within a venue.

In one embodiment, the physical constraint information includes the space required for a person to be seated at a table, table combination, furniture or fitting.

In one embodiment, the method includes the further step of allocating position numbers for seats associated with a table, table combination, other furniture or fitting.

In one embodiment, the method includes the further step of utilising the physical constraint information to determine the physical maximum number of seats that can be accommodated around a table, table combination, furniture or fitting.

In one embodiment, the method includes the further step of allocating an arbitrary limit lower than the maximum physical number of seats that can be physically allocated to a table or table combination, other furniture or fittings.

In one embodiment, the method includes the further step of utilising customer identity information including booking requestor identity information received from at least one of an internal and a third-party database of information, whereby the identity of the booking requestor and or one or more diners is utilised to determine the types of seats to be allocated to the table, table combination, other furniture or fittings that are allocated to the booking requestor.

In one embodiment, the customer identity information includes booking requestor identity information received from at least one of an internal and a third-party database of information, whereby the identity is utilised to determine the seat position number allocated to the booking requestor.

In one embodiment, the method includes the further step of dynamically allocating each one of the tables, table combinations, other furniture and fittings a variable identifier such that each one of the tables, table combinations, furniture and fittings retain a unique identifier to allocate the correct number of seats.

In one embodiment, the method includes the further step of utilising a seating allocation algorithm to allocate each of the seats associated with each table, table combination, other furniture or fitting in a pre-defined location relative to the table, table combination, other furniture or fitting.

In one embodiment, the method includes the further step of the seat allocation module interfacing with a menu module arranged to vary the constraint determining the seats available and that can be allocated to a table, table combination, other furniture or fixtures.

In one embodiment, the method includes the further step of varying the number of seats available that can be allocated to a table, table combination, other furniture or fixtures as a function of the occasion, class, promotion, date, service, menu or any other operational constraint associated with the table, table combination, other furniture or fixture.

In one embodiment, the physical constraints include at least one of the quantity and types of seats located within the venue, stored within the venue or receivable by the venue within a specified period of time.

In one embodiment, the further step of generating one of a floor plan, Gantt chart and figures table which is provided to a space allocation user interface.

In one embodiment, the space allocation user interface is interactive, whereby each of the representations of a table, table combination, other furniture, fixture and seat are selectable by the user of the interface.

In one embodiment, the method includes the further step of, on selection of a seat at a table by the user, the interface providing the user with access to an ordering interface arranged to allow the input of orders or associated information against the seat and associated table, table combination, other furniture or fixture selected by the user.

In one embodiment, the table plan, Gantt chart or figures table is integrated within a point of sale system whereby the displayed representations of tables, seats, other furniture and fittings vary in real time in accordance with events and changes within a venue.

In one embodiment, the method includes the further step of interfacing with an artificial intelligence module arranged to receive the booking request information and review the one or more of the plurality of constraints to determine whether variation of the one or more constraints to allow acceptance of the booking request results in a greater maximisation in the probability of achieving the selected outcome, whereby if the variation of the one or more constraints to allow acceptance of the booking request results in a maximisation in the probability of achieving the selected outcome, the one or more of the plurality of constraints are varied and the varied constraints are utilised for all subsequent booking requests for the service period, and the initial booking request information is provided to an allocation module arranged to accept the booking request and allocate the booking request together with all previously received booking requests to one or more spaces in the venue, whereby if all booking requests can be allocated, the received booking request is accepted and utilised to produce an optimised allocation instruction set which is utilisable by one or more users associated with the venue.

In another aspect, the invention provides a computer-enabled method for creating a list of tables for the dynamic allocation of booking requests to a table in an area or a sub-area in a venue, comprising the steps of,

providing a user interface arranged to receive input regarding constraint information including multiple physical characteristics of each table within an area or sub-area and further constraints associated with each table, whereby the input of multiple physical constraints and further constraints define a plurality of relativities, utilities, contextual relationships and contexts between the area or sub-area and each table,

whereby the relativities, utilities, contextual relationships and contexts define a table/time framework

whereby a further framework includes selectable strategic constraints for the development of an integrated set of quantitative and qualitative criteria utilisable to vary the constraint information

whereby the strategic constraints are variable based on threshold or event values to thereby enable a dynamic allocation of each table in the area or sub-area to meet desired quantitative and qualitative optimisation criteria in response to the receipt of the booking requests.

In another aspect, the invention provides a computer-enabled method for creating a table/time framework for the dynamic allocation of bookings to a space comprising one or more subs-spaces in a venue, comprising the steps of,

providing a user interface arranged to receive input regarding physical and operational constraints associated with a set of tables and table combinations associated with the one or more sub-spaces within the space,

whereby a further set of tables and table combinations are input, whereby at least one or more of the tables and table combinations in the further set are interchangeable with one or more of the tables and table combinations in the set of tables and table combinations, such that a different number of individual tables are used or a different type or size of table is used in the booking allocation process to achieve an optimised outcome.

In another aspect, the invention provides a computer-enabled method for creating a table/time framework for the dynamic allocation of bookings to a space in a venue, comprising the steps of, providing a user interface arranged to receive input regarding physical and operational constraints associated with a first set of tables and table combinations associated with the space,

receiving input regarding physical and operational constraints associated with at least one further set of tables and table combinations, the further set of tables including at least one of a different number of tables or at least one table of a different size or shape,

whereby at least one or more of the tables and table combinations in the further set are interchangeable with one or more of the tables and table combinations in the first set of tables and table combinations,

whereby the physical and operational constraints regarding the first set of tables and table combinations and the further set of tables and table combinations are utilised by an allocations module to define a plurality of relativities, utilities, contextual relationships and contexts between the sets of tables and table combinations,

whereby the allocations module utilises a further framework including selectable strategic constraints for the development of an integrated set of quantitative and qualitative criteria utilisable to vary the physical and operational constraint information of the first and further sets of tables and table combinations,

whereby the strategic constraints are variable based on threshold or event values to thereby enable a dynamic allocation of each table to meet desired quantitative and qualitative optimisation criteria in response to the receipt of the booking requests.

In one embodiment, the framework is utilised, when populated with booking requests, to provide at least one of accounting functionality, financial transaction functionality, point of sale functionality, rostering functionality and operational functionality.

In one embodiment, the method includes the further step of the framework utilising at least one of a forecasting module and an artificial intelligence module to operate at least one of an accounting system, a financial transaction system, a point of sale system, a rostering system and an operational system.

In another aspect, the invention provides a computer-enabled method to allocate a user to a predetermined table within a volumetric space/time framework or a table and table combination framework comprising the steps of, for a booking allocation system including allocated bookings, reviewing all allocated bookings to create a priority booking allocation list including one or more of the following criteria:
Membership level;
Table preference(s);
Highest ranked table available;
Transaction history;
Social media ranking;
Relationship with the venue;
Relationship with a person working at the venue or associated with the venue;
Relationship with the venue as a supplier, re-seller, or other business relationship with the venue;
The alternate requests or preferences for a particular table by a user; and
Day, time, duration requirements;
   whereby all allocated booking requests are allocated on the basis of the final ranking of each booking relative to each other booking.

In another aspect, the invention provides a computer-enabled method to allocate a user to a predetermined table available within a volumetric space/time framework or a table and table combination framework comprising the steps of, for a booking allocation system including allocated bookings, reviewing all allocated bookings to create one of a table, remove a table or maintain a predetermined list of tables, whereby on addition or removal of a table or table combination, the framework maintains unique table identifiers and unique seat identifiers.

In another aspect, the invention provides a computer-enabled method for creating a volumetric space/time framework or a table/table combination framework of constraints for the dynamic allocation of bookings to a space in a venue, comprising the steps of,

providing a user interface arranged to receive input regarding physical and further constraints of the space and time to the volumetric space/time framework or table/table combination framework, and also to receive input regarding physical and further constraints of one or more furniture items in the venue, whereby the input of physical constraints and further constraints define a plurality of relativities, utilities, contextual relationships and contexts between the space and each one of the one or more furniture items,

whereby the relativities, utilities, contextual relationships and contexts define a volumetric space/time framework or table/table combination framework over time that allows for the dynamic variation of the allocation of furniture items in the space in response to the receipt of a booking request for the space in the venue to meet desired quantitative and qualitative optimisation criteria,

whereby the volumetric space/time framework or table/table combination framework includes an allocation instruction set, the allocation instruction set being capable of being provided with a representation of a floor plan to a third party application.

In one embodiment, the third party application is a point of sale application.

In another aspect, the present invention provides a computing system for allocating furniture to devise a floor plan capable of receiving bookings allocated to one or more spaces in a venue, comprising:

an allocation module including one or more optimisation algorithms in communication with a processor and arranged to receive at least one request to assign chairs to a table, table combination or other furniture or fittings and communicate with a database of other saved booking requests,

wherein the allocation module determines whether one or more predetermined chair, stool or other seat thresholds designated to a table, table combination or other furniture or fittings have been exceeded, and if so, the allocation module receives the saved booking requests and combines the at least one booking request with the saved booking requests to form a pool of requests, retrieve constraint information regarding the chairs, stools, seats, tables, table combinations, other furniture and or fittings and iteratively allocates chairs, stools and other seats to each of the requests from the pool of requests to a table or table combination utilising the constraint information to select the chairs, stools, seats to a table, table combination, furniture or fittings,

wherein an optimised allocation instruction set of allocated chairs, stools and seats for each booking is produced,

wherein the optimised allocation instruction set is saved in the database,

wherein the optimised allocation instruction set is further provided by a space allocation user interface in the form of a floor plan, Gantt chart, diagram or figures table that shows the exact chairs optimised, assigned, or allocated for the booking request for the booking accepted for the table, table combination, other furniture or fittings to one or more users associated with the venue.

In one embodiment, the determination of the threshold value includes at least one of the table, table combination, other furniture or fittings selected upon which a booking has been allocated to for a specific time period, a specific group size or other constraint information associated with the booking and the type of chairs, stools or seats that can be utilised for that table, table combination or other furniture and fittings.

In one embodiment, the determination of the threshold value includes at least one of a minimum or maximum preferred number of chairs, stools, seats around a table, table combination, other furniture or fittings and the preferred physical locations of those seats, stool and seats around each table, table combination, other furniture or fittings.

In one embodiment, the determination of the threshold value is varied over time, wherein the multiple thresholds are applied to re-allocate chairs, stools or seats.

In one embodiment, the chairs, stools and seats are arranged into sub-groupings and matched to different subgroupings of tables, table combinations, other furniture and fittings based on constraint information, wherein the allocation module iteratively allocates requests for each sub-group independent of other sub-groups.

In one embodiment, the allocation module is arranged to utilise constraint information to group at least a sub-set of chairs, stools and seats to tables, table combinations, other furniture or fittings in the space into different classes to create a ranking for the at least the sub-set of the allocated chairs, stools and seats with the tables, table combinations, furniture or fittings.

In one embodiment, the allocation module utilises constraint information including the ranking of each chair, stool, seat, table, table combination, other furniture and fittings to create combined chair and table rankings within a venue and spaces within a venue.

In one embodiment, the constraint information includes the dimensions of all the different chairs, stools, seats, tables, table combinations, furniture and fittings, the relativities of the different items and the relativities of the different items within a venue or a space within the venue.

In one embodiment, the constraint information includes the space required for a diner around a table, table combination, furniture or fittings.

In one embodiment, the constraint information includes a methodology to determine and allocate position numbers for chairs, stools and seats around specific tables, table combinations, other furniture or fittings.

In one embodiment, an algorithm utilises the constraint information to determine the physical maximum chairs, stools and seats that can be accommodated around a table, table combination, furniture or fitting.

In one embodiment, the constraint information includes an arbitrary limit which is less than the maximum physical number of chairs, stools and seats that can be physically accommodated around a table, table combination, other furniture or fittings which can be used to limit the number of chairs, stools, seats placed around a table, table combination, other furniture or fittings.

In one embodiment, the constraint information includes booking requestor identity information received from at least one of an internal and a third-party database of information, wherein the identity is utilised to determine the number types of chairs, stools or seats to be allocated to the table, table combination, other furniture or fittings allocated to the booking requestor.

In one embodiment, the constraint information includes booking requestor identity information received from at least one of an internal and a third-party database of information, wherein the identity is utilised to determine the chair, stool, seat position number for the booking requestor to be allocated to.

In one embodiment, each of the tables, table combinations, other furniture and fittings are allocated a dynamically variable identifier such that each one of the tables, table combinations, furniture and fittings retain a unique consistent identity to which the chair, stool and seat algorithm and allocator can determine the correct number of chairs, stools and seats required for that booking based on the table, table combination, other furniture or fittings to which that booking was allocated.

In one embodiment, the chairs, stools and seats are placed in specific position around the table, table combination, other furniture or fittings to which they have been allocated are given unique and easily identifiable position numbers in accordance with the chair, stool, seat position numbering constraints such that each chair, stool, seat within a venue has a consistent and unique identifier in the form of a table and position number and saved in the database

In one embodiment, the chair, stool and seat allocation module interfaces with a menu module arranged to vary the constraint determining the chairs, stools and seats available and that can be allocated to a table, table combination, other furniture or fixtures.

In one embodiment, the chair, stool and seat allocation module interfaces with a group size module arranged to vary the constraint determining the chairs, stools and seats available and that can be allocated to a table, table combination, other furniture or fixtures

In one embodiment, the chair, stool and seat allocation module interfaces with an occasion module arranged to vary the constraint determining the chairs, stools and seats available and that can be allocated to a table, table combination, other furniture or fixtures

In one embodiment, the chair, stool and seat allocation module interfaces with a class module arranged to vary the constraint determining the chairs, stools and seats available and that can be allocated to a table, table combination, other furniture or fixtures

In one embodiment, the chair, stool and seat allocation module interfaces with a promotion module arranged to vary the constraint determining the chairs, stools and seats available and that can be allocated to a table, table combination, other furniture or fixtures

In one embodiment, the chair, stool and seat allocation module interfaces with a calendar module arranged to vary the constraint determining the chairs, stools and seats available and that can be allocated to a table, table combination, other furniture or fixtures by time and by service.

In one embodiment, the constraints include the number in quantity and types of chairs, stools and seats located within the venue, stored within the venue or can be brought in and used by the venue

In one embodiment, the module determines chair, stool and seat availability.

In one embodiment, the floor plan, Gantt Chart or figures table generated are provided by a space allocation user interface where tables and chairs are touch sensitive and all chairs, stools and seats allocated to all tables, table combinations, other furniture and fittings are uniquely identified and when touch activated contain unique references.

In one embodiment, the selection of a chair at a table on a device such as a touch screen device opens up a module to permit the placement of orders and information against that specific chair, stool or seat within that table, table combination, and other furniture or fixture identifier.

In one embodiment, the order or information placed against a chair, stool or seat within a booking for a table, table combination, other furniture or fixture can be used at least in one of the following manners:
a) To permit the booking requestor to determine within their allocated table, table combination, other furniture or fixture which chair, stool or seat that each of their individual guests within the booking are allocated to;
b) To permit the booking requestor to enter the names, emails and other details of the individual guests against the actual chairs, stools and seats that they have been allocated to;
c) To permit the booking requestor to request name cards be printed for their guests and placed on their allocated table in front of their allocated chair, stool or seat;
d) To permit the booking requestor to invite his guests to log into the system and pre-order and or prepay for their requested food and beverage items;
e) To permit the individuals to place orders for food and beverages while sitting at the venue against their seat and identifier
f) To permit orders from different seats within a table to be consolidated together and summarised prior to those orders being sent to the kitchen or bar for preparation, such that multiple orders for the same table can be consolidated and added together to ease of use and reference by kitchen staff or by any robotics process; and
g) To permit the creation of individual bills by seat number within a table or alternatively any combination of seats within an allocated table, table combination, other furniture or fittings.

In one embodiment, the table plan, Gantt chart or figures table is integrated within a separate point of sale system to provide dynamic floor plans, Gantt charts and figures tables whereby the tables, chairs, seats, other furniture change locations within the screen in real time in accordance with actual events and changes within a venue.

In one embodiment, the chair optimising, assigning and allocation algorithms work in conjunction with and simultaneously with the table allocation algorithms in the allocation of bookings within a venue with one or more spaces. to create a further amended and optimised allocation instruction set of allocated chairs, stools and seats for each table, table combination, other furniture and fittings set which is saved in the database, wherein the optimised allocation instruction set is further provided by a space allocation user interface.

In one embodiment, the chair optimising assigning and allocation algorithms are applied subsequent to the table, table combination, other furniture or fixtures allocation algorithms utilising arbitrary minimum and maximum chairs, stools and seats per table, table combination, other furniture or fittings in the allocation of bookings within a venue with one or more spaces and where additional chairs, stools and seats constraints are different to those minimum and maximum chair, stool and seat values including the physically logical maximum chairs, stools and seats that can be optimised, assigned or allocated to the tables, table combinations, other furniture or fittings then the allocation of chairs, stools and seats will be changed in accordance with the additional chair, stool and seat constraints to create a further amended and optimised allocation instruction set of allocated chairs, stools and seats for each table, table combination, other furniture and fittings set which is saved in the database, wherein the optimised allocation instruction set is further provided by a space allocation user interface.

In one embodiment, the chair, stool, and seat optimising, assigning and allocation algorithms are utilised to determine and select which one or more tables, table combinations, or other furniture or fixtures to which one or more bookings could be allocated to as part of the booking allocation process to create a further amended and optimised allocation instruction set of allocated chairs, stools and seats for each table, table combination, other furniture and fittings set which is saved in the database, wherein the optimised allocation instruction set is further provided by a space allocation user interface.

In one embodiment, the allocation of a booking request to a chair, stool, seat, a table, table combination, other furniture or fixture is undertaken on a first booking received first booking allocated basis or when one or more specific threshold values are met or completely dynamically and iteratively with all previous booking requests forming a pool of requests and the bookings being allocated from that pool of requests using one or more ordering processes for the optimisation of the quantitative and qualitative outcomes set by the venue.

In one embodiment, there is provided an artificial intelligence model arranged to receive the request information and review the one or more of the plurality of constraints to determine whether variation of the one or more constraints to allow acceptance of the booking request result in a greater maximisation in the probability of achieving the selected outcome, whereby if the variation of the one or more constraints to allow acceptance of the booking request results in a maximisation in the probability of achieving the selected outcome, the one or more of the plurality of constraints are varied and the varied constraints are utilised for all subsequent booking requests for the service period, and the initial booking request information is passed on to an allocation module arranged to accept the booking request and allocate the booking request together with all previously received booking requests to one or more spaces in the venue, whereby if all booking requests can be allocated the received booking request is accepted, whereby the booking information is utilised to produce an optimised allocation instruction set which is utilisable by one or more users associated with the venue.

In a further aspect, the invention provides a computer-enabled method for creating a framework for the dynamic allocation of a booking request to one or more tables and table combinations furniture items in a space, comprising the steps of,

providing a user interface arranged to receive input regarding spatial and qualitative attributes of one or more furniture items including modifications to the furniture items and the associability of the one or more tables and table combinations furniture items to each other and to the space, whereby the attributes define a plurality of relativities and contextual relationships between the space and each one of the one or more furniture items, the user interface further being arranged to receive input regarding one or more quantitative and qualitative constraints utilisable by the framework to optimally allocate the booking request,
whereby the relativities and contextual information and the constraints are utilised by an algorithm to create the framework that provides for the dynamic variation in the allocation of the one or more tables and table combinations furniture items within the space in response to the booking request for the one or more of the one or more tables and table combinations furniture items in the space, to satisfy the quantitative and qualitative optimisation criteria, whereby upon execution of the algorithm, the framework is arranged to produce an optimised allocation instruction set for the space and the allocated bookings, whereby the optimised allocation instruction set is saved in the database and displayed, upon request, by a space allocation user interface to one or more users.

In a further aspect, the invention provides a computer-enabled method for creating a framework for the dynamic allocation of a booking request for a defined time period to one or more items and to a space, comprising the steps of,

providing a user interface arranged to receive input regarding spatial and qualitative attributes of one or more items associable with the booking request and the associability of the one or more items to each other, to the space and to a defined time range, whereby the attributes define a plurality of relativities and contextual relationships between the space, the defined time range and each one of the one or more items, the user interface further being arranged to receive input regarding one or more quantitative and qualitative constraints utilisable by the framework to optimally allocate the booking request,
whereby the relativities and contextual relationships include information utilised by an algorithm to create the framework that provides for the dynamic variation in the allocation of one or more items in the space for the defined time period within the defined time range in response to the booking request, to satisfy quantitative and qualitative optimisation criteria,
whereby upon execution of the algorithm, the framework is arranged to produce an optimised allocation instruction set for the defined time periods and the allocated bookings, whereby the optimised allocation instruction set is saved in the database and displayed, upon request, by a space allocation user interface to one or more users.

In a further aspect, the invention provides a computer-enabled method for creating a framework for the dynamic allocation of a booking requests to one or more tables and table combinations in a space, comprising the steps of,

providing a user interface arranged to receive input regarding spatial and qualitative attributes of one or more tables and table combinations including the attributes of the tables and table combinations to each other and to the space, whereby the attributes define a plurality of relativities and contextual relationships between the space and each one of the one or more tables and table combinations, the user interface further being arranged to receive input regarding one or more quantitative and qualitative constraints utilisable by the framework to optimally allocate the booking request,
whereby the relativities and contextual provide information utilised by an algorithm to create the framework that provides for the dynamic variation in the allocation of tables and table combinations within the space in response to a booking request in a manner to satisfy the quantitative and qualitative optimisation criteria, whereby upon execution of the algorithm, the framework is arranged to produce an optimised allocation instruction set for the tables and table combinations and the allocated bookings, whereby the optimised allocation instruction set is saved in the database and displayed, upon request, by a space allocation user interface to one or more users.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1a is an example computing system on which a method and/or a computer program may be operated, in accordance with an embodiment of the invention;

FIG. 1b is an example of a flowchart illustrating a computer system upon which a computer enabled method may be operated, in accordance with an embodiment of the invention;

FIG. 1c is an example of an interface in accordance with an embodiment of the invention;

FIGS. 1d-f are examples of an interface of a prior art booking system;

FIGS. 1g-j are illustrations of a volumetric (three-dimensional) framework for providing a complex product and service in accordance with an embodiment of the invention;

FIGS. 2a-2e are flowcharts illustrating a computer enabled method for a booking process in accordance with an embodiment of the invention;

FIGS. 2f-2g are flowcharts illustrating a computer enabled method for a booking process in accordance with the prior art;

FIG. 3 is a modular diagram illustrating a computer enabled method for a booking process in accordance with an embodiment of the invention;

FIG. 4 is a modular diagram illustrating a computer enabled method for a booking process utilising an app/widget in accordance with an embodiment of the invention;

FIG. 5 is an illustration of a floorplan for an interface that demonstrates the reduction to practice of a volumetric approach to providing a dynamic interface in accordance with an embodiment of the invention;

FIG. 6a is a flowchart illustrating a computer enabled method for a setup process in accordance with an embodiment of the invention;

FIGS. 6b-6c are screenshots of an interface for a setup process in accordance with an embodiment of the invention;

FIG. 6d is a flowchart illustrating a setup process in accordance with an embodiment of the invention;

FIGS. 6e-f are screenshots of an interface for a setup process in accordance with an embodiment of the invention;

FIG. 7a is a flowchart illustrating a setup process in accordance with an embodiment of the invention;

FIG. 7b is a screenshot of an interface for a setup process in accordance with an embodiment of the invention;

FIGS. 8a-c are flowcharts illustrating a setup process in accordance with an embodiment of the invention;

FIGS. 8d-i are screenshots of an interface for a setup process in accordance with an embodiment of the invention;

FIG. 9a is a flowchart illustrating a setup process in accordance with an embodiment of the invention;

FIGS. 9b-c are screenshots of an interface for a setup process in accordance with an embodiment of the invention;

FIG. 10a is a flowchart illustrating a setup process in accordance with an embodiment of the invention;

FIGS. 10b-c are screenshots of an interface for a setup process in accordance with an embodiment of the invention;

FIG. 11a is a flowchart illustrating a setup process in accordance with an embodiment of the invention;

FIGS. 11b-l are screenshots of an interface for a setup process in accordance with an embodiment of the invention;

FIG. 12a is a flowchart illustrating a setup process in accordance with an embodiment of the invention;

FIG. 12b is a screenshot of an interface for a setup process in accordance with an embodiment of the invention;

FIG. 13a is a flowchart illustrating a setup process in accordance with an embodiment of the invention;

FIGS. 13b-e are screenshots of an interface for a setup process in accordance with an embodiment of the invention;

FIGS. 14a-b are screenshots of an interface showing an example of a Gantt chart in accordance with an embodiment of the invention;

FIGS. 15a-g are screenshots of an interface in accordance with an embodiment of the invention;

FIG. 16a is a flowchart illustrating a setup process in accordance with an embodiment of the invention;

FIG. 16b is a screenshot of an interface for a setup process in accordance with an embodiment of the invention;

FIG. 17a is a flowchart illustrating a setup process in accordance with an embodiment of the invention;

FIGS. 17b-c are screenshots of an interface for a setup process in accordance with an embodiment of the invention;

FIGS. 18a-e are screenshots of an interface illustrating an aspect of a dynamic floor plan interface in accordance with an embodiment of the invention;

FIG. 19a is high level schematic illustrating the links between various hardware devices and software applications which interface with an embodiment of the present invention;

FIG. 20a-e are screenshots of a dashboard in accordance with another embodiment of the invention;

FIG. 21a-b are screenshots of a floor plan interface in accordance with another embodiment of the invention;

FIG. 22a-b are screenshots of a floor plan interface in accordance with another embodiment of the invention;

FIG. 23a-d are high level schematic diagrams illustrating the ResButler system, including a depiction of the multiple Customer Relationship Management (CRM) systems and integration into a passport system in accordance with an embodiment of the invention;

FIG. 23e-g are flowcharts illustrating the use of the multiple CRM systems in accordance with an embodiment of the invention; and

FIG. 23h-l are screenshots of a user interface illustrating use of the passport system in accordance with an embodiment of the invention.

### DETAILED DESCRIPTION OF PREFERRED EMBODIMENTS

The present invention relates generally to a computing system, method, computer program and data signal for allocating furniture to devise a floor plan capable of receiving bookings allocated to one or more spaces in a venue.

The system generally comprises an allocation module including one or more optimisation algorithms in communication with a processor and arranged to receive at least one request to assign chairs to a table, table combination or other furniture or fittings and communicate with a database of other saved booking requests.

The allocation module determines whether one or more predetermined chair, stool or other seat thresholds designated to a table, table combination or other furniture or fittings have been exceeded, and if so, the allocation module receives the saved booking requests and combines the at least one booking request with the saved booking requests to form a pool of requests, retrieve constraint information regarding the chairs, stools, seats, tables, table combinations, other furniture and or fittings and iteratively allocates chairs, stools and other seats to each of the requests from the pool of requests to a table or table combination utilising the constraint information to select the chairs, stools, seats to a table, table combination, furniture or fittings.

This in turn creates an optimised allocation instruction set of allocated chairs, stools and seats for each booking produced, wherein the optimised allocation instruction set is saved in the database and the optimised allocation instruction set is further provided by a space allocation user interface in the form of a floor plan, Gantt chart, diagram or figures table that shows the exact chairs optimised, assigned, or allocated for the booking request for the booking accepted for the table, table combination, other furniture or fittings to one or more users associated with the venue.

The determination of the threshold value includes at least one of the table, table combination, other furniture or fittings selected upon which a booking has been allocated to for a specific time period, a specific group size or other constraint information associated with the booking and the type of chairs, stools or seats that can be utilised for that table, table combination or other furniture and fittings.

The determination of the threshold value includes at least one of a minimum or maximum preferred number of chairs, stools, seats around a table, table combination, other furniture or fittings and the preferred physical locations of those seats, stool and seats around each table, table combination, other furniture or fittings.

The determination of the threshold value is varied over time, wherein the multiple thresholds are applied to re-allocate chairs, stools or seats.

The chairs, stools and seats are arranged into sub-groupings and matched to different subgroupings of tables, table combinations, other furniture and fittings based on constraint information, wherein the allocation module iteratively allocates requests for each sub-group independent of other sub-groups.

The allocation module is arranged to utilise constraint information to group at least a sub-set of chairs, stools and seats to tables, table combinations, other furniture or fittings in the space into different classes to create a ranking for the at least the sub-set of the allocated chairs, stools and seats with the tables, table combinations, furniture or fittings.

The allocation module utilises constraint information including the ranking of each chair, stool, seat, table, table combination, other furniture and fittings to create combined chair and table rankings within a venue and spaces within a venue.

The constraint information includes the dimensions of all the different chairs, stools, seats, tables, table combinations, furniture and fittings, the relativities of the different items and the relativities of the different items within a venue or a space within the venue.

The constraint information includes the space required for a diner around a table, table combination, furniture or fittings.

The constraint information includes a methodology to determine and allocate position numbers for chairs, stools and seats around specific tables, table combinations, other furniture or fittings.

The algorithm can utilise the constraint information to determine the physical maximum chairs, stools and seats that can be accommodated around a table, table combination, furniture or fitting.

The constraint information includes an arbitrary limit which is less than the maximum physical number of chairs, stools and seats that can be physically accommodated around a table, table combination, other furniture or fittings which can be used to limit the number of chairs, stools, seats placed around a table, table combination, other furniture or fittings.

The constraint information includes booking requestor identity information received from at least one of an internal and a third-party database of information, wherein the identity is utilised to determine the number types of chairs, stools or seats to be allocated to the table, table combination, other furniture or fittings allocated to the booking requestor.

The constraint information includes booking requestor identity information received from at least one of an internal and a third-party database of information, wherein the identity is utilised to determine the chair, stool, seat position number for the booking requestor to be allocated to.

Each of the tables, table combinations, other furniture and fittings are allocated a dynamically variable identifier such that each one of the tables, table combinations, furniture and fittings retain a unique consistent identity to which the chair, stool and seat algorithm and allocator can determine the correct number of chairs, stools and seats required for that booking based on the table, table combination, other furniture or fittings to which that booking was allocated.

The chairs, stools and seats are placed in specific position around the table, table combination, other furniture or fittings to which they have been allocated are given unique and easily identifiable position numbers in accordance with the chair, stool, seat position numbering constraints such that each chair, stool, seat within a venue has a consistent and unique identifier in the form of a table and position number and saved in the database.

The chair, stool and seat allocation module interfaces with a menu module arranged to vary the constraint determining the chairs, stools and seats available and that can be allocated to a table, table combination, other furniture or fixtures.

The chair, stool and seat allocation module interfaces with a group size module arranged to vary the constraint determining the chairs, stools and seats available and that can be allocated to a table, table combination, other furniture or fixtures.

The chair, stool and seat allocation module interfaces with an occasion module arranged to vary the constraint determining the chairs, stools and seats available and that can be allocated to a table, table combination, other furniture or fixtures.

The chair, stool and seat allocation module interfaces with a class module arranged to vary the constraint determining the chairs, stools and seats available and that can be allocated to a table, table combination, other furniture or fixtures.

The chair, stool and seat allocation module interfaces with a promotion module arranged to vary the constraint determining the chairs, stools and seats available and that can be allocated to a table, table combination, other furniture or fixtures.

The chair, stool and seat allocation module interfaces with a calendar module arranged to vary the constraint determining the chairs, stools and seats available and that can be allocated to a table, table combination, other furniture or fixtures by time and by service.

The constraints include the number in quantity and types of chairs, stools and seats located within the venue, stored within the venue or can be brought in and used by the venue

The module determines chair, stool and seat availability.

The floor plan, Gantt Chart or figures table generated are provided by a space allocation user interface where tables and chairs are touch sensitive and all chairs, stools and seats allocated to all tables, table combinations, other furniture and fittings are uniquely identified and when touch activated contain unique references.

The selection of a chair at a table on a device such as a touch screen device opens up a module to permit the placement of orders and information against that specific chair, stool or seat within that table, table combination, other furniture or fixture identifier.

The order or information placed against a chair, stool or seat within a booking for a table, table combination, other furniture or fixture can be used at least in one of the following manners:

a) To permit the booking requestor to determine within their allocated table, table combination, other furniture or fixture which chair, stool or seat that each of their individual guests within the booking are allocated to;
b) To permit the booking requestor to enter the names, emails and other details of the individual guests against the actual chairs, stools and seats that they have been allocated to;
c) To permit the booking requestor to request name cards be printed for their guests and placed on their allocated table in front of their allocated chair, stool or seat;
d) To permit the booking requestor to invite his guests to log into the system and pre-order and or prepay for their requested food and beverage items;
e) To permit the individuals to place orders for food and beverages while sitting at the venue against their seat and identifier;
f) To permit orders from different seats within a table to consolidated together and summarised prior to those orders being sent to the kitchen or bar for preparation, such that multiple orders for the same table can be consolidated and added together to ease of use and reference by kitchen staff or by any robotics process; and/or
g) To permit the creation of individual bills by seat number within a table or alternatively any combination of seats within an allocated table, table combination, other furniture or fittings.

The table plan, Gantt chart or figures table can by integrated within a separate point of sale system so that dynamic floor plans, Gantt charts and figures tables whereby the tables, chairs, seats, other furniture change locations within the screen in real time in accordance with actual events and changes within a venue.

The chair optimising, assigning and allocation algorithms work in conjunction with and simultaneously with the table allocation algorithms in the allocation of bookings within a venue with one or more spaces. to create a further amended and optimised allocation instruction set of allocated chairs, stools and seats for each table, table combination, other furniture and fittings set which is saved in the database, wherein the optimised allocation instruction set is further provided by a space allocation user interface.

The chair optimising assigning and allocation algorithms are applied subsequent to the table, table combination, other furniture or fixtures allocation algorithms utilising arbitrary minimum and maximum chairs, stools and seats per table, table combination, other furniture or fittings in the allocation of bookings within a venue with one or more spaces and where additional chairs, stools and seats constraints are different to those minimum and maximum chair, stool and seat values including the physically logical maximum chairs, stools and seats that can be optimised, assigned or allocated to the tables, table combinations, other furniture or fittings then the allocation of chairs, stools and seats will be changed in accordance with the additional chair, stool and seat constraints to create a further amended and optimised allocation instruction set of allocated chairs, stools and seats for each table, table combination, other furniture and fittings set which is saved in the database, wherein the optimised allocation instruction set is further provided by a space allocation user interface.

The chair, stool, and seat optimising, assigning and allocation algorithms are utilised to determine and select which one or more tables, table combinations, or other furniture or fixtures to which one or more bookings could be allocated to as part of the booking allocation process to create a further amended and optimised allocation instruction set of allocated chairs, stools and seats for each table, table combination, other furniture and fittings set which is saved in the database, wherein the optimised allocation instruction set is further provided by a space allocation user interface.

The allocation of a booking request to a chair, stool, seat, a table, table combination, other furniture or fixture is undertaken on a first booking received first booking allocated basis or when one or more specific threshold values are met or completely dynamically and iteratively with all previous booking requests forming a pool of requests and the bookings being allocated from that pool of requests using one or more ordering processes for the optimisation of the quantitative and qualitative outcomes set by the venue.

In another aspect, there is also included an artificial intelligence module arranged to receive the request information and review the one or more of the plurality of constraints to determine whether variation of the one or more constraints to allow acceptance of the booking request result in a greater maximisation in the probability of achieving the selected outcome, whereby if the variation of the one or more constraints to allow acceptance of the booking request results in a maximisation in the probability of achieving the selected outcome, the one or more of the plurality of constraints are varied and the varied constraints are utilised for all subsequent booking requests for the service period, and the initial booking request information is passed on to an allocation module arranged to accept the booking request and allocate the booking request together with all previously received booking requests to one or more spaces in the venue, whereby if all booking requests can be allocated the received booking request is accepted, whereby the booking information is utilised to produce an optimised allocation instruction set which is utilisable by one or more users associated with the venue.

In the following description of an embodiment, specific terms will be used to broadly define particular features or aspects of the inventive concept or the information utilised to allocate a booking request, within the context of a specific example embodiment, namely the allocation of bookings in a restaurant. However, it will be understood that the invention has broader application than the allocation of bookings in a restaurant. Examples of the use of the interface are provided outside of the booking of restaurants.

### The Computing System

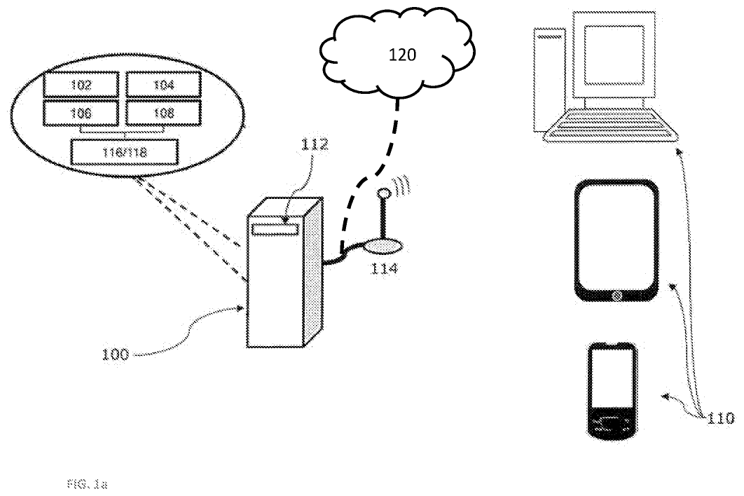

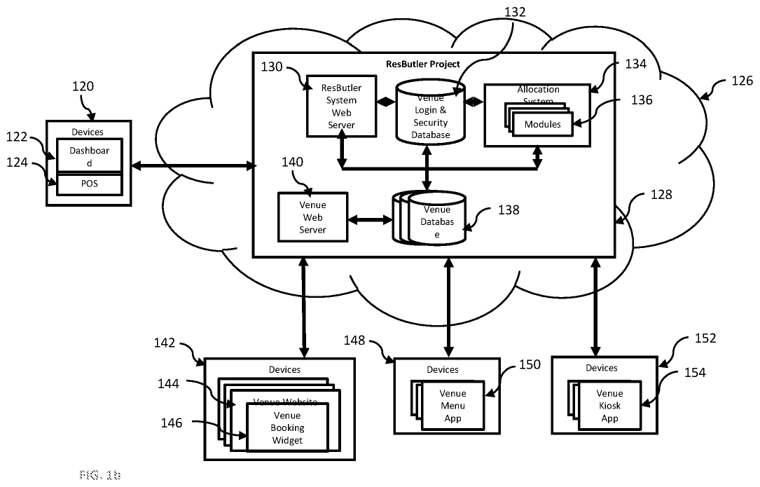

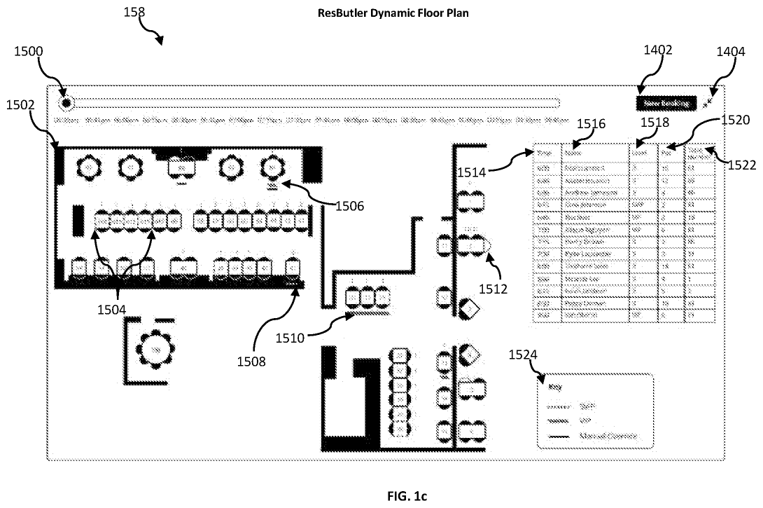

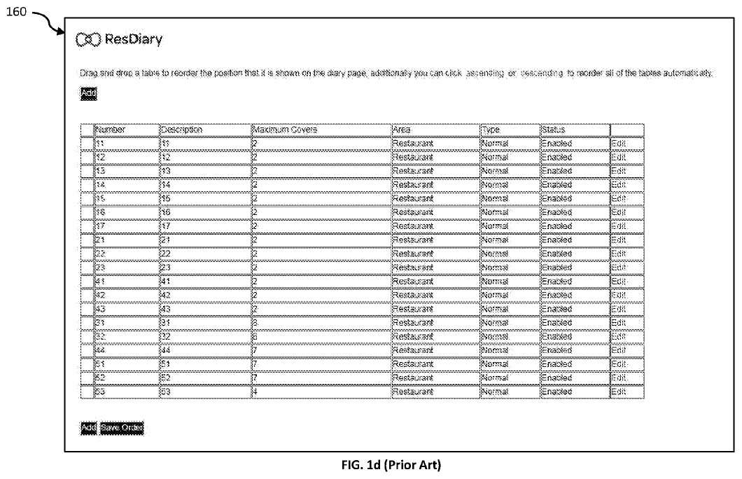

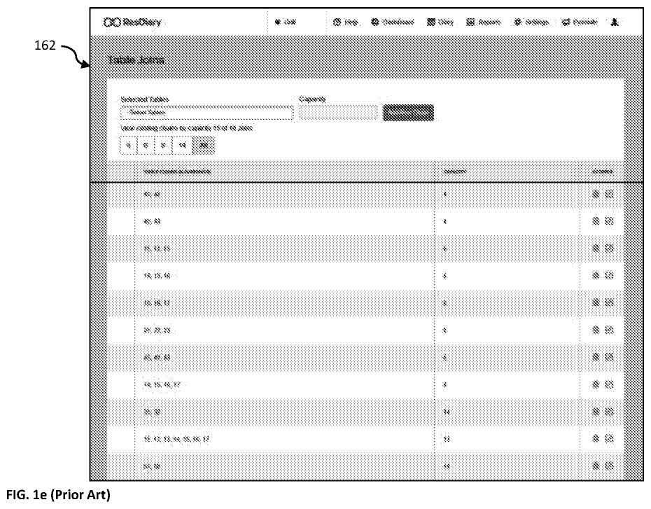

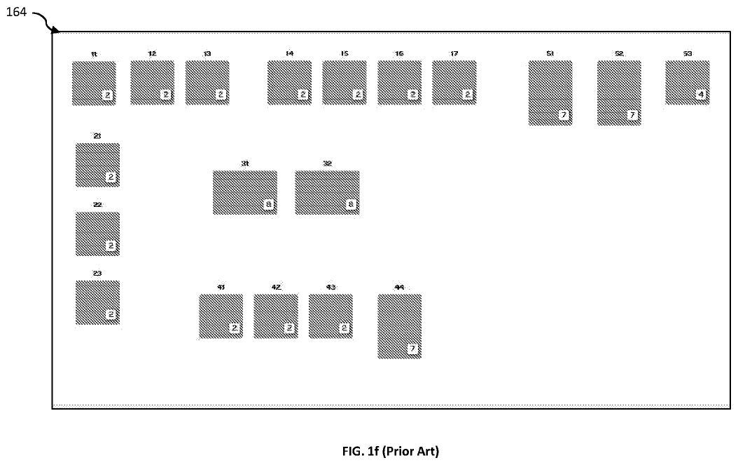

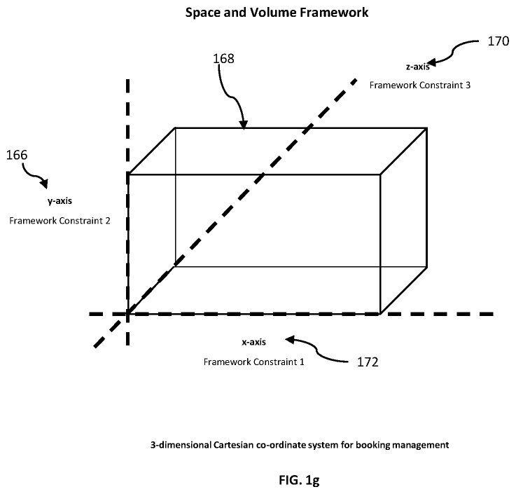

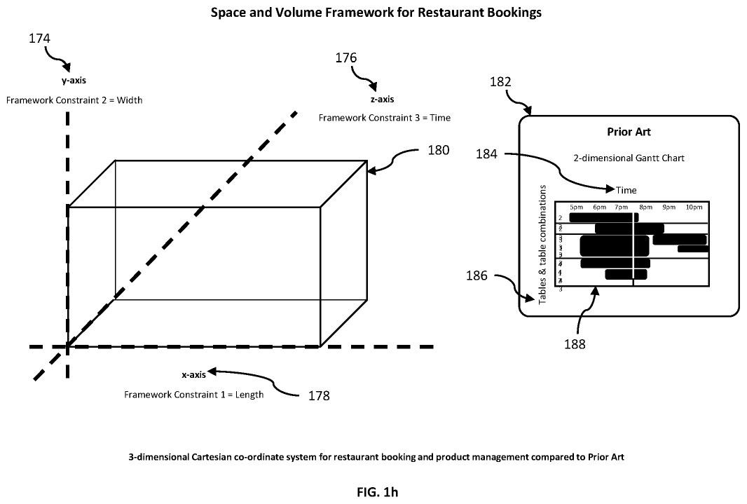

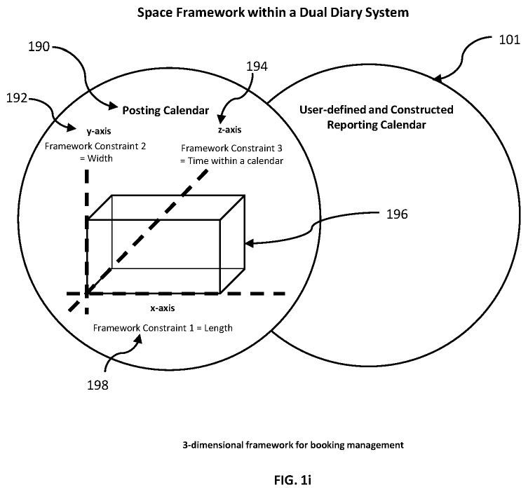

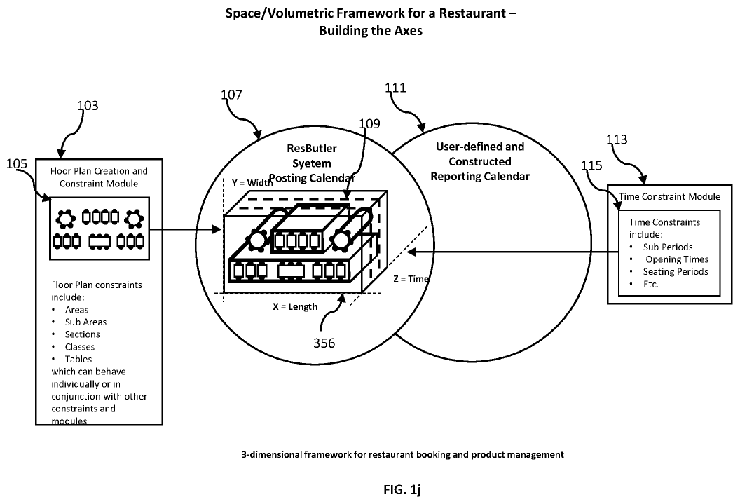

One embodiment of the computing system is shown at FIG. 1a.

In FIG. 1a there is shown a schematic diagram of a computing system, which in this embodiment is a computing system 100 suitable for use with an embodiment of the present invention. The computing system 100 may be used to execute application and/or system services such as a computer program and an interface in accordance with an embodiment of the present invention.

With reference to FIG. 1a, the computing system 100 may comprise suitable components necessary to receive, store and execute appropriate computer instructions. The components may include a processor 102, read only memory (ROM) 104, random access memory (RAM) 106, an input/output devices such as disc drives 108, remote or connected mobile devices 110 (such as computers, smartphones or tablets and the like), and one or more communications link(s) 114 including internet links to other applications, websites and system services including Internet cloud services 120.

The computing system 100 includes instructions that may be installed in ROM 104, RAM 106 or disc drives 112 and may be executed by the processor 102. There may be provided a plurality of communication links 114 which may variously connect to one or more user devices 110, such as computers, smartphones or tablets, wherein the one or more user devices have a user interface for interacting with user by collecting and displaying data or information using the conventional means provided by such devices. At least one of a plurality of communications link 114 may be connected to an external computing network through a telecommunications network, including Internet cloud services 120.

In one particular embodiment the device may include a database 116 which may reside on the storage device 112. It will be understood that the database may reside on any suitable storage device, which may encompass solid state drives, hard disc drives, optical drives or magnetic tape drives. The database 116 may reside on a single physical storage device or may be spread across multiple storage devices, either locally or remotely.

The computing system 100 includes a suitable operating system 118 which may also reside on a storage device or in the ROM of the server 100. The operating system is arranged to interact with the database 116 and with one or more computer programs to cause the server to carry out the steps, functions and/or procedures in accordance with the embodiments of the invention described herein.

The user interface 110 of one or more mobile devices facilitates the collection and display of user data for the computing system 100. The user interface 110 may be a program or website accessed on a computer or mobile device via a communication network, such as the Internet. Alternatively, the user interface 110 may be a widget arranged on a website that may be accessed by a user using a computer or mobile device via a communication network such as the Internet. The user interface 110 may also be provided as a mobile application or “app” present on the user device, such as a tablet or smart phone.

The at least one user interacts with the user interface 110 and may be a first user (also referred to as the “booking requestor”) requesting to use a space in a venue. The at least one user may also include a second user (referred to as the “operator” or “venue operator”), who is associated with the venue and utilizes the optimised space allocation instruction set provided by the allocation module to enable the use of the space by the booking requestor.

The booking requestor interacts with the computing system to make a request. The requestor may make a request for one or more patrons of the venue to use the space in a venue, where the requestor may also be one of the patrons of the venue. That is, a user that interacts with the system is referred (on their own behalf or on behalf of a group of people) is referred to as a booking requestor and the person (or group of people) that will be allocated a table (i.e. attend the venue or restaurant) may be variously referred to as the “patron” or “patrons”, the “customer” or “customers”, the “guest” or “guests” and/or the “diner” or “diners”, or any other term as appropriate for the venue.

An embodiment includes the computer system 100 processing the request and undertaking all subsequent steps in an autonomous manner. Alternatively, in another embodiment, the operator may use one of the user interfaces 110 provided to one or more devices to receive, input, or modify information in order to provide further input to the computer system 100, so that the computing system may process the request and provide instructions to the entity.

In processing the request, the computer system 100 may arrange objects in the space in accordance with the optimised space allocation instruction set. That is, the booking requestor acts as a customer making a request which is to be “serviced” by the operator in accordance with the optimised space allocation instruction set. As may be appreciated by a skilled addressee, there may be any number of remote users and operators who are able to interact with the computing system via the user interface 110 via any number of different devices.

Referring to FIG. 1b there is shown a schematic diagram of the ResButler project. The ResButler application 126 is hosted in a cloud computing environment. The ResButler project 128 includes a web server 130 a venue login and security database 132, an allocation module or system 134 comprising one or more modules or algorithms 136, which connect to a venue database 138 and a venue web server 140. The ResButler project 128 connects with multiple devices 142, 148 and 152. The device 142 is a third party desktop forward/laptop that is capable of displaying a website rendered by venue web server 140. The venue web server 144 incorporates a venue booking widget 146. Similarly, device 148 is a mobile device such as a smartphone or tablet computing system. The device 148 includes an instance of the menu app 150. Analogously, device 152 is a kiosk including a computing system capable of executing a venue kiosk app 154. The ResButler project 128 also interfaces with a device 120 which is located within the venue. The devices 120 may include a point of sale device (POS) 124 and or a device capable of displaying a dashboard 122 in accordance with an embodiment of the invention.

Referring to FIG. 1c, there is shown a screenshot of an embodiment of the invention. As can be seen, the floor plan 1502 is to scale and includes a slide bar 1500 to show how bookings and table movements occur across the period of service, allows for new bookings to be easily added by selecting button 1402, provides information regarding the booking on each table, such as by symbol 1506, 1508, 1510 and key 1524, includes a booking list denoted by columns 1514, 1516, 1518, 1520 and 1522. The system also provides information regarding the characteristics of a table, such as 1504 and the ability to add chairs 1512.

Referring now to FIGS. 1d-f, there is shown a prior art interface of a booking system, as shown generally at 160, 162 and 164. As can be seen, the simple nature of the layout and the lack of ability to provide any type of sophisticated segmenting, addition or deletion of tables, use of dimensions to arrange tables, the ability to seat according to class, amenity or any other variable, is lacking in the prior art system.

Referring now to FIGS. 1g-j, there is shown a conceptual illustration (with reference to a cartesian framework) for the underlying geometric and mathematical concept embodied in the embodiment of the invention described in more detail hereinbelow. As previously described, the embodiment described and defined herein is broadly directed to a system capable of developing, managing and utilising a floor plan for a space to allocate bookings and provide personalised service to customers, in addition to assisting in the operation of the space.

Broadly, referring to FIG. 1g, the operation of the method and system described herein is based on a cartesian three-dimensional framework, which acts as a frame of reference to allow for the visualisation of the elements required to operate a space, including the physical movement of items within the space. The volumetric framework 168 operates across three axes, generically labelled the x-axis 172, the y-axis 166 and the z-axis 170. Each of the axes allow a constraint to be physically mapped relative to the two other constraints that constitute the framework. This provides an additional dimension with which to provide a complete visualisation and operation of the management of a space, as can be seen with reference to FIG. 1h.

Referring to FIG. 1h, there is shown the three-dimensional framework 180 with dimension x 178, dimension y 174 and dimension z 176, compared to a prior art framework 182 which illustrates a Gantt chart 188 including a first dimension 184 and a second dimension 186.

Referring to FIG. 1i there is described a practical application of the concept of FIG. 1g where the framework 196 with dimensions x 198, y 192 and z 194 are located within the context of a posting calendar, which is arranged to interact with a user-defined reporting calendar 101. This reduction to practice is further described with reference to FIG. 1j, where a restaurant floor plan is overlaid on the three-dimensional framework. In more detail, a floor plan creation module 103 is utilised to create a floor plan for a restaurant, including the size and shape of the restaurant space, the creation of sub-areas and sections, the division of the areas and/or sub areas into classes, the addition of tables and chairs (including dimensions), etc. The floor plan is placed in the volumetric framework 109 within the calendar 107, where the x and y axes represent the length and width of the space, and the z axis represents time. As such, each area, sub area, class, table, chair, etc. can be tracked over time. The z axis is controlled by a time constraint module 113 which includes time constraints 115 such as opening hours, seating periods, etc.

In other words, the volumetric framework, in addition to the calendar and the floor creation module and time constraint module create a real time simulation of the restaurant, allowing the operator to track all aspects of the restaurant/space over time. This framework is derived from the realisation that the pivotal structure (both physical and conceptual) in the operation of a space such as a restaurant, is the booking and how the booking is allocated and managed. The placement of tables and chairs, the opening hours, the food served, the staff employed, etc., are ultimately all connected to the booking. As such, the volumetric model is a completely different manner in which to conceptualise the operation of a space (and in particular a restaurant space or any other space where a service is provided and there are multiple constraints).

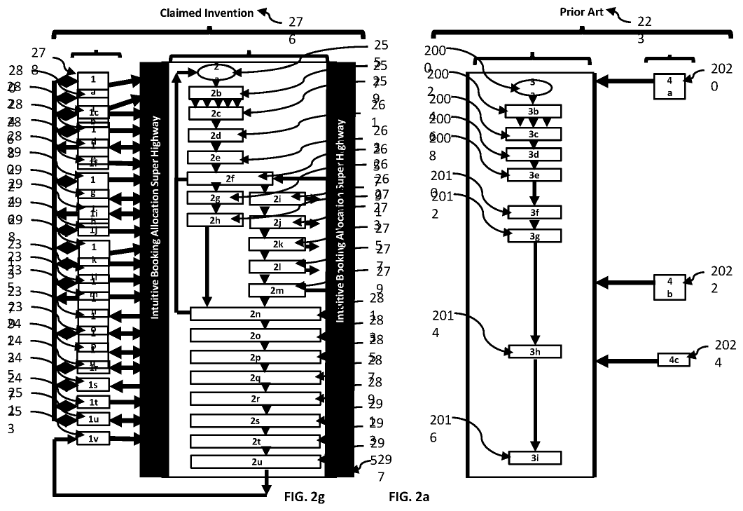

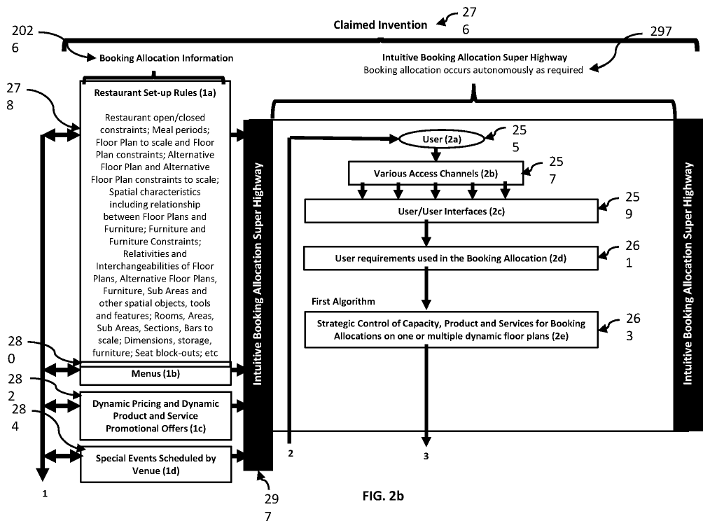

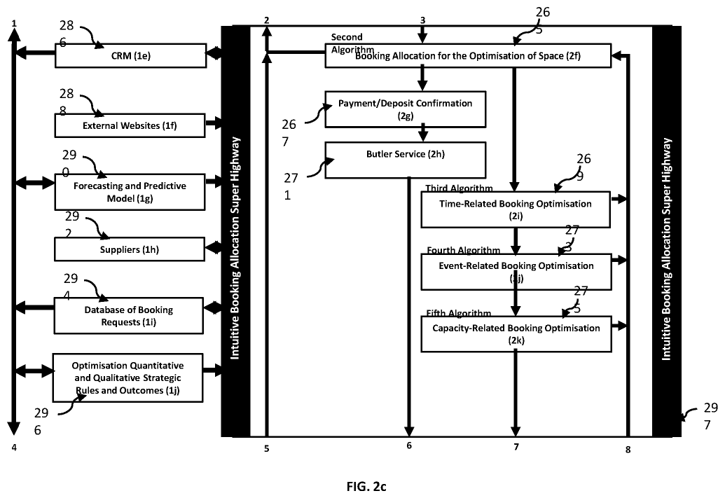

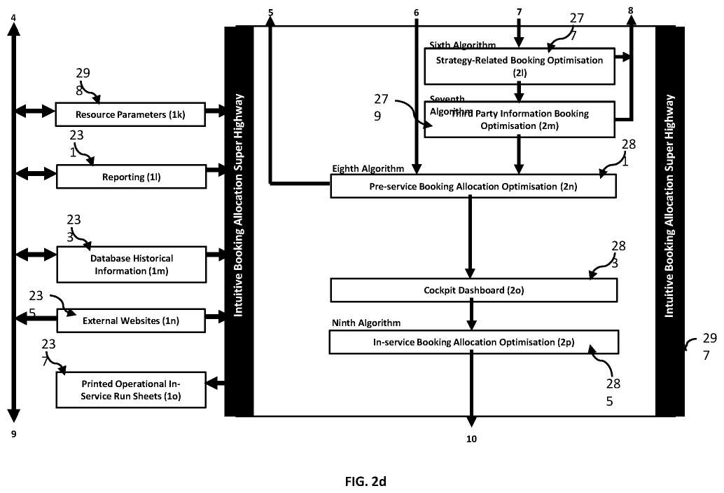

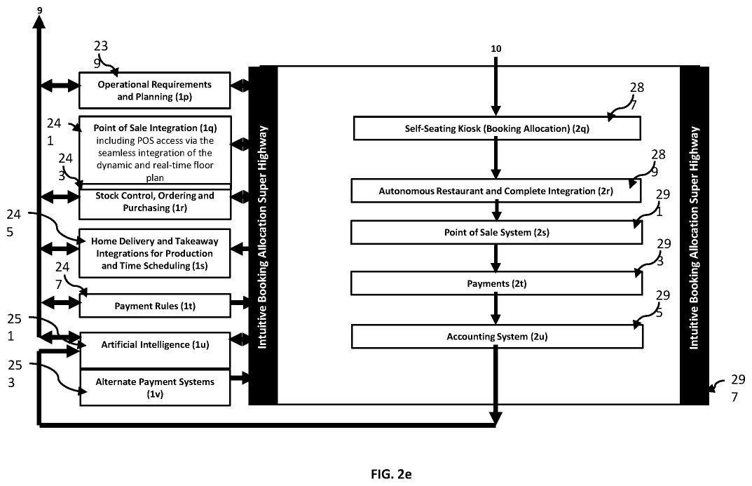

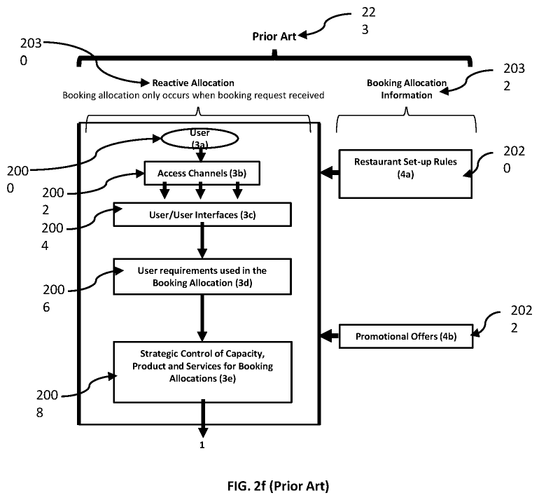

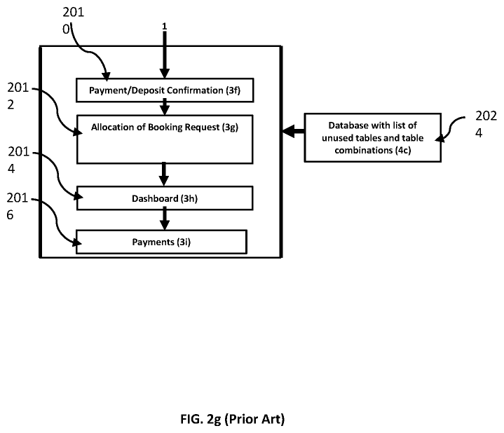

Referring to FIGS. 2a-2g, there is shown a series of flow charts illustrating a comparison between the prior art and a system in accordance with an embodiment of the invention. These figures were previously included in PCT application PCT/AU2018/051168 (and co-pending PCT application PCT/AU2018/051169, PCT/AU2018/051170 and PCT/AU2018/051171) as noted in the background above and also, in the artificial intelligence Australian provisional application AU2019/900128. These figures are also included in the further 11 additional co-pending Australian provisional patent applications lodged on 29 Apr. 2019 which are also related to and support this application. The aforementioned applications are incorporated herein, in their entirety, by reference and are listed below in table 1.

TABLE 1

| Title of related applications | Shorthand |
|---|---|
| A computer-enabled method, system and computer program for providing an | Space |
| intuitive user interface arranged to create a dynamic floor plan utilisable by an | (The present application) |
| allocation algorithm to perform the task of allocating a space, furniture, | |
| equipment or service | |
| A computer-enabled method, system and computer program for generating a | Widget |
| dynamic user interface for use by a user in the allocation of a space, furniture, | |
| equipment or service | |
| A computer-enabled method, system and computer program for dynamically | Yield Management |
| altering constraints utilised in the management of a space, furniture, equipment | |
| or service | |
| A computer-enabled method, system and computer program for the | POS Transactions |
| management of a multi stage transaction including management of a booking | |
| and service delivery process | |
| A computer-enabled method, system and computer program for providing an | Rosters |
| intuitive user interface and algorithm arranged to create a dynamic roster | |
| utilising an allocation algorithm to perform the task of the allocation of staff to | |
| tasks in a workplace | |
| A computer-enabled method, system and computer program for providing an | Operations |
| intuitive user interface arranged to create a dynamic floor plan utilisable by an | |
| allocation algorithm to perform the task of organising and operating a provision | |
| of a service | |
| A computer-enabled method, system and computer program for providing an | Menus |
| intuitive user interface arranged to create a dynamic product list integrable into | |
| a service provision process to perform the task of delivering a complex service | |
| and managing an associated transaction | |
| A computer-enabled method, system and computer program for providing an | Functions |
| intuitive user interface arranged to create a dynamic floor plan utilisable by an | |
| allocation algorithm to perform the task of managing a function or event | |
| A computer-enabled method, system and computer program for autonomously | Ordering and Allocation |
| allocating and managing a space, furniture, equipment and/or a service via an | Integration |
| electronic device | |
| A computer-enabled method, system and computer program for managing the | Exchange |
| exchange between third parties of service contracts for the provision of a | |
| restaurant booking or other analogous service | |
| A computer-enabled method, system and computer program for monitoring a | Gaming |
| plurality of gaming machines and other games of chance, and providing a | |
| booking and monitoring service for gaming enthusiasts and gaming venues | |
| An autonomous, integrated computer-enabled method, system and computer | Artificial Intelligence |
| program utilising an artificial intelligence engine for dynamic allocation and | |
| optimisation of space, furniture, equipment and/or services (AU2019/900128) | |
| PCT/AU2018/051168 (and co-pending PCT application PCT/AU2018/051169, | PCT Applications |
| PCT/AU2018/051170 and PCT/AU2018/051171) | |

Referring to now FIGS. 2a to 2e, there is shown a diagrammatic representation of each of the component parts of the system in accordance with an embodiment of the invention. The following descriptions and information add further matter to the original disclosure in the above-mentioned PCT applications to further particularise the features and embodiments described herein. To the extent that the additional description of features and integers contained herein contradicts any disclosure with respect to a feature or integer disclosed in the previous applications, it will be understood that, to the extent of the contradiction, the present application will be taken as being correct for the purpose of the inventions and embodiments disclosed and defined in the present application.

The following references serve as a summary of the information referred to within the embodiment detailed by FIGS. 2a-2g

### Information and Set-Up for Embodiments Described Herein

Restaurant Set-up Rules (278): There are three basic embodiments disclosed herein, each of which utilise a different set of rules to set up a restaurant or any other space that can be reserved for any purpose. In all embodiments, the rules and constraints are arranged to permit the proper contextual relationships, relativities, utility of and flexible table and chair or equipment capacity to allow for effective differentiation, discrimination, yield management, dynamic pricing, revenue management, cost and operations management and the achievement of bespoke (configurable) individual quantitative and qualitative goals of a restaurant.

In the context of the specification and the embodiments and broader invention described herein, the terms “relationship”, “relativity”, “utility” and “contextual relationships” have specific meanings as related to equipment, furniture and other items which can be arranged within a space/venue and which can be ascribed specific attributes, constraints and by extension rules which utilise the attributes and constraints.

Firstly, the term “relativity” in the context of the specification refers to quantifiable attributes and constraints that describe quantifiable variables of a table, chair, furniture or equipment that in turn form the basis for a qualitative assessment of the table, chair and/or equipment. For example, the size and shape of the table, which are quantitative variables, may have an impact on a qualitative attribute of the table, such as the “class” of table. A first class table may be of a larger size and a first class chair may be more luxurious (larger chair). The attribute, however, is relative to other attributes and therefore in and of itself may not be determinative of the overall qualitative assessment of the table. For example, in addition to a physical attribute of the table, the location of the table relative to the space may also be determinative of the class of the table. For example, a table that is near a window and has a view may be considered a first class table, even if the physical attributes of the physical table do not necessarily match those of a “first class” table.

In other words, the term “relativity” refers to quantifiable attributes of furniture/equipment.

Correspondingly, the term “utility” refers to the overall utility that is derivable from the relative attributes and constraints that are associated with each item of furniture, including tables, chairs and other items of equipment.

Secondly, the term “relationship” refers to an association between two or more items, objects etc. For example, a relationship may be that a table is capable of being placed in a particular section. This is a constraint that defines a relationship between the table and the section.

Relationships may be one-to-one, or may be multiple, in that an object or item may have a relationship with a number of other objects or items. In other words, the relationships behave as a constraint with respect to how the two objects or items can interact.

In the past specification, the reference to a “contextual relationship” or to “context”, refers to a relationship that acts as a constraint when specific conditions are met. For example, two tables may have a contextual relationship when placed adjacent to each other, or together, but have no such relationship when they are not placed adjacent to each other.

The rules and constraints stand in contrast to the prior art solutions, which are limited to a predetermined and unchanging limited solution set of non-descript tables and table combinations with simple minimum and maximum chair constraints. The three embodiments shown at (278) are “space”, “tables” and “tables, table combinations and shadow tables” described further below:

### Space

The space embodiment uses a volumetric framework, and a restaurant floor plan or other file or data base to provide a series of restaurant allocation and organisation rules, including the relationships, relativities, utility and capacity of tables, chairs, other furniture and all other constraints within the restaurant.

### Tables

Each table is ascribed an extensive set of characteristics and constraints, such that each table has a specific relativity, relationship, utility and capacity relative to each other table. Moreover, each chair is also ascribed a space relativity which is treated as a second aspect of the invention. This embodiment is similar to the space embodiment noted above. However, there is no utilisation of exact dimensions. In other words, less emphasis is placed on the spatial/dimensional aspect of the “space”, but the rules and algorithm still mimic the “space” embodiment above to achieve a similar outcome. This additional embodiment permits the addition and/or removal of tables from the total capacity of the restaurant.

The use of a list of tables and associated attributes as the underlying set of variables used to define the relativity, relationship, utility and capacity of each table and chair acts as a “common denominator” or as a benchmark for those relativities, relationships, utilities and capacities that provides that relativity. Hence, the use of a list of tables detailing the relationships, relativities, utilities and capacity between each other is an embodiment of the claimed invention. A further embodiment is any combination or permutation of relativities, relationships utilities and capacities of tables, chairs, and the restaurant rules that permits the differentiation, discrimination, yield management, dynamic pricing, revenue management, cost and operations management to achieve bespoke outcomes as disclosed within this and the other related applications.

### Tables, Table Combinations and Shadow Tables

Through an extensive definition of the relationship, relativity, utility and capacity of each table and table combination with each other table and table combination to define a set of constraints rules can be applied to achieve desired outcomes. The development of rules provide granular differentiation and improve outcomes.

Within this embodiment is the concept of “shadow tables”, defined as tables that do not physically exist in the total solution set of tables and table combinations as in the prior art. Alternatively stated, these “shadow tables” are not shown and do not exist on the floor plan within the prior art. These “shadow tables” are a list of permutations of tables that can be placed in an area, sub area, or space such that they can replace previously existing table or table combination within that area, sub area or space such that the allocation process permits the addition of or removal of tables and or chairs from the floor plan to provide a different and more optimised outcome than the prior art.

It will be understood that the permutations are not limited to a fixed number of tables, but can include the addition or removal of tables. For example, a permutation may include two separate tables T1 and T2 and a combined table T1+T2 as per the prior art. However, in the present embodiment, there can also be provided a further table not existing in the prior art (T3) which permits the addition of a different combined table T1+T2+T3. In other words, the permutation allows for the incorporation of additional tables or removal of tables providing completely different configurations and numbers of table to vary the seating capacity, orientation, or any other aspect of the table combination in the sub area or area.

Embodiments and aspects of this application are supported by, and with further details provided within the additional related patent applications, but more specifically with the following related patent applications:
1. Space—as described in Table 1
2. Widget—as described in Table 1
3. Menus—as described in Table 1
4. Yield Management—as described in Table 1
5. POS Transactions—as described in Table 1
6. Rosters—as described in Table 1
7. Operations—as described in Table 1
8. Ordering and Allocation Integration—as described in Table 1
9. Gaming—as described in Table 1
10. Exchange—as described in Table 1
11. Artificial Intelligence—as described in Table 1
12. PCT Applications—as described in Table 1

The restaurant set-up rules shown at (278) in one embodiment also include set-up rules for all other spaces or purposes such as for the set-up and booking of functions and/or events with an area, subarea, private room or the entire restaurant. In a further embodiment the set-up rules referred to at (278) also refer to function spaces, event spaces, theatre, show and other spaces, such that a complete event can be enquired, modified, confirmed with or without part or full payment on-line and without the requirement of manual intervention by venue staff.

Embodiments are further described in related co-pending patent applications, with particular reference to the following related patent applications:

1. Functions—as Described in Table 1

In a further embodiment, the restaurant set-up measurements provide information that permits a venue to detail the normal or standard set-up for a restaurant including the type, size and normal number of chairs that would be used for a table at a particular location. The restaurant set-up information can be used to determine if more than the standard number of chairs normally set for that table at that location is the physical maximum number of chairs that can be allocated to the table. In a further embodiment the restaurant set-up information can include information which indicates where one or more extra chairs can be placed on a table to increase the capacity of a table (which may also be determined by the relative location of the table in the venue).

For example where a table of two is placed up against a wall (and, hence the wall side is unusable) but, the other side can take an extra chair (as that chair will not be in a walk-way or interfere with any other table, the system is aware of the constraint and can add an extra chair to the table to increase its capacity if required during the booking allocation process.

In a further embodiment the information where the “change” of a table top from say one that is say 750 mm by 700 mm to one that is 800 mm round to permit the seating of 4 people and not 2 (as per the original 750 mm by 700 mm) in the same location, the restaurant set-up rules can include information as to when a restaurant reaches a certain threshold or capacity, such that the rules and algorithms can be used to apply one or more of increasing the capacity to some or all the tables to the maximum number of chairs; or to the maximum table top size, or some other permutation within the information provided and available within the restaurant set-up rules.

In another embodiment the restaurant set-up rules can be combined with any other information or any other permutation of the available information as described herein such that the restaurant allocation rules and algorithms can achieve any of the required quantitative and qualitative outcomes desired by the restaurant. For example, knowledge of the restaurant space, tables, table classes, table locations can be used in conjunction with the information available within a customer's history or CRM to allocate the customer's booking request instantaneously to their favourite or preferred table and preferred chair, or if the customer's favourite is not available to the customer's second preferred table and a preferred seating position, or failing that allocate the booking request to the next highest ranking class of table or table location as so on until that booking is allocated.

In one embodiment, the allocation of a booking can be associated with one physical space, physical item and the same booking can be transferred to another physical space or physical item such that a booking can comprise more that one “experience”. For example, a booking can be allocated to a bar table or bar stool for say 7 pm to 7:30 pm and then moved to the main dining room from 7:30 pm to 9:30 pm and then back to the bar at 9:30 pm for a night cap. In a further embodiment, as this sequence of events can treated as a single booking during the booking allocation process then the system can maintain all financial details and information within that one booking and one account so that information does not have to be manually transferred, or manually reconciled, including any pre-payments within the system or the process by which it is integrated within any POS system.

In a further embodiment the restaurant set-up rules referred to above could be applied to other industries and businesses including, for example, hairdressers, gyms, libraries, accommodation, car rentals and aviation, or any business that requires the allocation of a physical space, physical item during a booking allocation process.

In a further embodiment, the framework, rules, methods, procedures and algorithms, of the current invention can also be applied to the booking of appointments where the primary purpose of the appointment is not the physical space or a physical item but the provision of services such as legal advice, accounting advice, doctors' appointments, hospital appointments etc.

Menus (280): Menus and the use of menus, rather than simply being a presentation of products available for purchase, are integrated into various aspects of the broader system These include channel and widget configuration to offer different menus, not only by time, but by other constraints such as class and specific table; availability and search by different courses and menus; the ability to require customers to commit to different menus and different courses at different times; the ability to recognise and identify different channels and customers to offer specific menus and tailored menus with different conditions such as duration times, prices, payment conditions etc.; eliminate the need for indicating allergy details on menus as alternate menu items would be displayed that did not include the “offending” allergic ingredients, similarly with dietary requirements; the use of alternate menu items not only makes the display to the customer more friendly and personal but permits proper stock decrementing and revenue/sales analysis; the requirement for a customer to select a menu and the number of courses so that more accurate duration times can be calculated or requiring customers to accept variable duration times based on the number of courses they have selected in conjunction with one or more other constraints (such as occasion, time of booking, group size, etc.) in determining the duration a booking would be permitted to occupy a table; the integration of menus into a “product tree” to permit the seamless integration of pre-orders into point of sales systems and the seamless integration of the reconciliation process of prepayments and deposits without the need to create separate pre-paid accounts within POS systems. These embodiments shown at (280).

### Channel Configurability, Differentiation and Identification

In one embodiment, the claimed invention includes the ability of the operator to offer different menus with different dishes, different prices, different numbers of courses, different time durations and can be incorporated with different time durations and that specific information can be used and applied as part of the optimisation and booking allocation process.

### Individual Identification

In one embodiment, the booking allocation system can identify the customer seeking to make a booking and present them with an individual menu or another specific menu and with the knowledge of the individual access that individuals CRM details and apply other additional constraints with respect to their menu selection such as a different duration time or a different duration time at their preferred table as part of the optimisation and booking process.

### Required Selection of a Menus and or Courses

In one embodiment, a customer can be required to select a specific menu and or courses and with that required selection would be a set time such that the selection of the menu item and/o courses, a specific time duration could be applied to that selected menu and courses, incorporating other additional constraint information such as group size, occasion, day of the week, time of booking etc, to apply and or determine a duration time to be applied to that booking request and for that duration time to be used and applied as part of the booking allocation process.

### Alternate Menu Items

In one embodiment, a customer who has an allergy or dietary preference is only shown dishes that are compatible with their requirements, such that the menu item displayed does not include the inappropriate ingredients and simply shows the menu item as the dish will be presented when cooked.

### Menu Systems Integration

In one embodiment the booking allocation system contains a menu building module and/or a separate menu building module includes a product tree structure for the development of menu items (products) that contain ingredients for stock decrementing as well as alternate menu items and ingredients where those menu items are modified for allergies or dietary requirements so that proper stock decrementation can occur. In one embodiment, each menu item by being linked to a product tree permits seamless integration with POS systems, kitchen and bar printing.

In a further embodiment pre-orders are linked to the booking and there is no need to manually re-enter any pre-payments or pre-orders to a POS system as prepayment accounts as prepaid amounts can remain and be controlled within the ordering system and the booking allocation process such that an automatic reconciliation process can be applied when the booking arrives such that the manual transfer between accounts is not required.

Embodiments and aspects of this application are supported by, and with further details provided within the additional related patent application, but more specifically with the following related patent applications which are incorporated herein by reference:

1. Menus—as described in Table 1

2. Widget—as described in Table 1

3. Yield management—as described in Table 1

4. POS Transactions—as described in Table 1

5. Rosters—as described in Table 1

6. Functions—as described in Table 1

7. Artificial Intelligence—as described in Table 1

8. PCT Applications—as described in Table 1

Dynamic Pricing and Dynamic Product and Service Promotional Offers (282): The embodiments described herein include the complete differentiation of the products, services and benefits that can be utilised in the differentiation of a product and service during a booking or appointment process; the use of the complete list of options available for the differentiation of the product or service to create a unique set of differentiated products and services as compared to competitors that can then be offered to their customers; the use of the differentiated products and services as part of a booking or appointment process.

Through these processes, a restaurant online booking process, or other booking or appointment process can be used and permits a restaurant or other business to apply proper and complete yield management including dynamic pricing, peak period pricing, higher pricing of tables with better or higher utility, etc., as compared to the current practice of only offering simple discounts during off-peak periods and incorrectly referring to this as yield management. In a further embodiment the use of and the ability of adding the tailoring of a dining or other bookable experience or appointment such that additional, related or the simple re-arrangement of the sequence of activities can offer greater satisfaction and personalisation to create a total revenue management process. These embodiments are shown at (282) and include the differentiation of products.

In one embodiment additional constraints have been developed and incorporated within the booking allocation system including through the use of the volumetric framework within one embodiment of the invention to permit a full and complete differentiation of the products and services offered by a restaurant including differentiation not considered or accounted for by the prior art including by location, by ambiance, by class, by privacy, by individual table, by ranking of each individual table, by menu, by number of courses, by occasion, by category of customer, by ranking of customer, by event, by conditions or constraints by time of booking, by payment terms, by additional supplementary items committed to, by channel and then these additional differentiation aspects being incorporated and used within the booking allocation process so that the a restaurant can configure these items to optimise their preferred quantitative and qualitative outcomes.

### The Yield Management and Revenue Management of Products

In one embodiment the additional product differentiation referred to above is utilised by the claimed invention to permit the control of capacity offered by differentiated products and services and then to apply yield management techniques which permit the incorporation of dynamic pricing, differential pricing by the differentiated items. In a further embodiment the incorporation of additional and supplementary items including the ability to tailor the sequence of events within a booking or appointment (as one simple example of this embodiment is the ability to permit customers to design their own sharing platters and eliminating the need have an entrée and/or a main course in a traditionally three course a la carte restaurant.

### Promotions

In one embodiment the incorporation of configurable promotions, configurable back fill promotions, and interactive tactical upsell promotions to people hesitating during the booking process or to people who have already booked or to encouraging people to pre-order or while at the restaurant in-service ordering process.

### Sale of Specific Tables and Packages, Auction of Specific Tables and Packages and the Sale of Specific Tables or Packages Through a Restaurant Table Exchange.

In one embodiment the incorporation the sale of specific tables or packages by individual sale by the restaurant or through an “exchange”, “website” or other process that permits the resale of the tables and packages.

### Butler and Concierge Service

In one embodiment there is provided a module that allows the incorporation of additional third-party or ancillary items to personalise the restaurant experience, change the order of service, provide bespoke offerings and experiences not normally or traditionally provided by restaurants, upsell during the booking and ordering process unusual items so that a restaurant can create greater differentiation to competitors. These experiences are not limited to the experiences normally provided by restaurants but targeted at experiences and offering that are outside existing norms to include anything desired by a customer and within the level of acceptability of the restaurant. In a further embodiment the additional information, spending and revenue for a booking can be used within the booking allocation process to provide higher spending, higher revenue, higher contribution or other classification of customers, or more specific experience requirements in the booking allocation process of the claimed invention. In one embodiment this can result in a higher spending customer being given a better table or being provided with an upgrade to a better class of table, extended duration or other benefits or preferential treatment.

Embodiments and aspects of this application are supported by, and with further details provided within the additional related patent applications, but more specifically with the following related patent applications which are incorporated herein by reference:

1. Widget—as described in Table 1

2. Yield management—as described in Table 1

3. Space—as described in Table 1

4. Exchange—as described in Table 1

5. Gaming—as described in Table 1

6. Rosters—as described in Table 1

7. POS Transactions—as described in Table 1

8. Artificial Intelligence—as described in Table 1

Special Events Scheduled by Venue (284): In some embodiments, there is provided a process by which special events may be included by utilising the forecasting and planning modules to create and classify specific events as “one off” events so that they can be properly understood and interpreted by the forecasting modules and therefore also correctly classified and utilised as input data by the artificial intelligence module. More specifically these embodiments are shown at (284).

Embodiments and aspects of this application are supported by, and with further details provided within the additional related patent applications, but more specifically with the following related patent applications which are incorporated herein by reference:

1. Yield Management—as described in Table 1

2. Rosters—as described in Table 1

3. Artificial Intelligence—as described in Table 1

CRM (286): In the embodiments described herein, the CRM is not merely a repository of information and historical data base, as is the case with all prior art, but is a system that contains constraints and information that can be accessed and utilised as part of the booking allocation process. These embodiments include the allocation of a Super VIP and or VIP to their favourite or preferred table automatically during the booking allocation process and not through a manual allocation process undertaken after the booking is accepted, as is the case with the prior art.

Further, in additional embodiments the restaurant or the venue can provide additional information and constraints as to how this CRM information should be utilised, how it should be enhanced, modified or applied during the booking allocation process, including, the addition of complementary items being added to their “running sheet” or “order of service” for their booking, for example, a free glass of wine, or an extended booking duration time, that no deposit or prepayment is required unlike other bookings or other benefit or information.

In a further embodiment, the booking allocation process can automatically embellish the booking allocation process by permitting differentiation between customers and better tailoring and personalise a person's restaurant experience. More specifically these embodiments are shown at (286). Embodiments and aspects of this application are supported by, and with further details provided within all the additional related patent applications:

External Websites (288): In some embodiments, external websites are utilised as not merely a source of information or reference data but as data and information that can be accessed and utilised in the booking allocation process. Embodiments of the allocation methodology, processes and rules can include, a person's social media influence rating, a person's occupation, or other distinguishing feature as inputs to determine the constraints to be utilised by the booking allocation process. More specifically these embodiments are shown at (288).

Embodiments and aspects of this application are supported by, and with further details provided within the additional related patent applications.

Forecasting and Predictive Model (290): The level of detail used by the embodiments in the differentiation of the product or service, yield management, dynamic pricing, revenue management, the detail within a restaurant the personalisation of services etc., allow the forecasting and predictive model of the embodiment to be extremely sensitive and therefore results in far more accurate forecasts and predictions as there is greater monitoring ability as well as “levers” to make changes to achieve desired outcomes.

Specifically in one embodiment the forecasting and predictive model directly accesses the extensive constraints, variables, inputs, historical outcomes and trends, allocation rules, as well as planned events, third party websites, and use that information to develop its forecasts and then to monitor activity against those forecasts by the allocation methods, procedures, algorithms and allocation rules in the allocation of bookings to a space, a table, a table combination, chair or other item to achieve better forecasts and to make changes to the constraints so as to achieve even better outcomes. Embodiments also include the forecasts of functions and events as well as the monitoring of those events and the recommendation of changes or the making of changes to the applied constraints; booking capacities; booking classes; staffing; rosters; resource requirements; operational requirements; maintenance requirements, etc. More specifically these embodiments are shown at (290). Embodiments and aspects of this application are supported by, and with further details provided within the additional related patent applications, but more specifically with the following patent applications:

1. Yield management—as described in Table 1

2. Rosters—as described in Table 1

3. Artificial Intelligence—as described in Table 1

4. Functions—as described in Table 1

5. Operations—as described in Table 1

6. PCT applications—as described in Table 1

Suppliers (292): Orders; Deliveries; Constraints, details etc. (292) The embodiment includes the ability to link a supplier to the booking allocation process such that the suppliers items can be offered within the booking process, the selection of what a person has chosen can then be added to the booking allocation process and algorithm and then an order be placed with the supplier when a person confirms their booking to create a completely integrated process. Embodiments of this process are supported by, and with further details provided within the additional related patent applications.

Database of Booking Requests (294): In one embodiment, the historical booking requests are directly accessed by the booking allocation methods, procedures, algorithms and allocation rules for the allocation of bookings to a space, a table, a table combination, chair, other item or for the allocation or creation of an appointment.

In a further embodiment additional information can be added to the data base of historical booking requests, their behaviour at the restaurant, the allocation provided to them in previous booking requests, overall demand for a time or a service that could not be satisfied and the timing and booking profile of those bookings, etc., (294) Embodiments and aspects of this application are supported by, and with further details provided within the additional related patent applications.

Optimisation Quantitative and Qualitative Strategic Rules and Outcomes (296): Embodiments of the allocations, methods, procedures, algorithms and allocation rules include the creation of specific rules to undertake specific outcomes which can be selected by a venue to create specific outcomes dynamically (the prior art cannot dynamically allocate bookings and relies on a predetermined single priority table and table combination list to allocate bookings).

The specific dynamic allocation can also be combined in different sequences combinations by different time periods, different services, etc., so as to create bespoke outcomes for the benefit of individual venues to better meet their targeted goals and the requirements of their customers. Embodiments with respect to this aspect are not limited to the following examples, detailed; Floor Space Optimisation Algorithm; Time Related Optimisation Algorithm; Event Related Optimisation Algorithm; Strategy Related Optimisation Algorithm; Third-Party Optimisation Algorithm; Pre-service Optimisation Algorithm; In-service Optimisation Algorithm; Self-Seating Optimisation Algorithm (296). Embodiments and aspects of this application are supported by, and with further details provided within all the additional patent applications:

1. PCT applications—as described in Table 1

Resource Parameters (298): The resource parameters include; Venue set-up times, bar set-up times, hosting requirements, kitchen set-up times, roster structures and frameworks including staff metrics such as customers that each staff member can cater for, minimum staffing levels, amount of food that each chef or food station can produce, minimum hours, pay rates, broken chairs, broken tables, equipment out of service etc. (298). Embodiments and aspects of this application are supported by, and with further details provided within the additional related patent applications, but more specifically with the following patent applications:

1. Rosters—as described in Table 1

2. Operations—as described in Table 1

3. Artificial Intelligence—as described in Table 1

Reporting (231): Performance analysis; Customer satisfaction; Deliverables; Labour Analysis; Actual v. Predicted etc. (231) Reporting relates to the additional constraints possible within the claimed invention and the analysis of those constraints and their outcomes. In one embodiment, reporting relates to the use of that analysis to better forecast and utilise that information to create a feedback loop and information to the artificial intelligence module so that it can continually learn and improve this processes and outcomes. This application is supported by, and with further details provided within the additional related patent applications, but more specifically with the following patent applications:

1. Yield Management—as described in Table 1

2. Artificial Intelligence—as described in Table 1

Database Historical Information (233): Database historical information relate to information not currently available or used by the prior art. This information includes: booking duration times by courses, by individual table, by class of table, by occasion etc.; the time bookings made—booking time; classes of bookings; spend by booking types; yield management outcomes; revenue efficiency; walk-in promotions; etc. and wherein this information can be accessed and utilised within the booking allocation process and all other modules including forecasting and artificial intelligence (233) this application is supported by, and with further details provided within the additional related patent applications, but more specifically with the following patent applications, but more specifically with the following patent applications:

1. Yield—as described in Table 1

2. Artificial Intelligence—as described in Table 1

External Websites (235): External websites including weather information relate to information that is accessed and used by the current invention within it booking allocation process, forecasting and artificial intelligence. Embodiments relating to the use of information from external websites within the claimed are supported by, and with further details provided within the additional related patent applications.

Printed Operational In-Service Run Sheets (237): Printed operational and in-service run sheets relate to information that includes the results of the autonomous booking allocation process, the autonomous chair allocation or selection process etc., and is supported by, and with further details provided within the additional related patent applications.

Operational Requirements and Planning (239): Operational requirements and planning within this application refer to staffing levels; rosters, including roster frameworks and standard rosters, roster creation, staff allocation to rosters, adjustments to rosters based on bookings received as compared to bookings forecasted; start/finish times, including pre-times, set-up times, closing procedures and times; orders; delivery schedules; maintenance planning; equipment replacement; occupational health and safety; procedure and policy monitoring; etc. (239). Embodiments within this aspect of the application are supported by, and with further details provided within the additional related patent applications, but more specifically:

1. Rostering—as described in Table 1

2. Operations—as described in Table 1

3. POS Transactions—as described in Table 1

Point of Sale Integration (241): In one aspect, embodiments of the point of sale (POS) integration relate to transactional aspects. These embodiments include the “real time” dynamic floor plan created by the claimed invention being integrated into POS systems with or without the application of the Cartesian “volumetric framework” (which in one embodiment includes more than a three dimensional volumetric framework, as it can include more than three axis) within the integrated POS systems such that the “real time dynamic floor plan” including details of the table, the chairs and booking details by chair, replaces the existing static floor plan within the prior art POS systems. The benefits of this dynamic real time floor plan ensure that restaurant tables are always shown as how they appear in real life, that the tables have the correct table numbers, that the tables show the correct chair set up and all pre-orders are shown on the correct table and the correct chair numbers that change in accordance with the customers request and the booking allocation process.

In a further embodiment any pre-payments, part payments or deposits including food, beverage and other items are transferred and referenced in detail by the booking system or ordering system, to the POS system on arrival and eliminate the need for the opening of pre-paid accounts within POS systems or other accounting systems which then require manual transfer of amounts between accounts etc. and a subsequent manual reconciliation process. Embodiments, therefore include integrations for dynamic floor plans; table and chair seating plans, allocations and details; orders; payments; deposits; sale items; Etc.; CRM detail integration as it related to the booking allocation and ordering processes of the current invention (241) Embodiments of this application are supported by, and with further details provided within the additional related patent applications:

1. POS Transactions—as described in Table 1

2. Space—as described in Table 1

3. Menus—as described in Table 1

In a further embodiment, the booking allocation system incorporates a transaction system that replaces and enhances the functionality of a traditional P.O.S. system. A transaction system is far more efficient and renders a traditional P.O.S. system obsolete, as most transactions do not occur at one point (hence the current name and terminology of Point-of-Sale systems) but the transactions occur at multiple points and the traditional P.O.S. systems no longer represent an efficient core revenue or accounting system.

In a further aspect the current invention with respect to POS systems relates to the integration and use of POS systems with a booking allocation system such that a person making an order at a counter can be allocated a table and or seat within the venue at the same time with or without a stipulated duration time. In another embodiment a person making an order at an ordering kiosk within a venue can be allocated a table or a seat at the venue with or without a stipulated duration time. In another embodiment where a person is allowed to enter a venue and choose a table or seat of their choice and then order, the embodiment through the integration of a booking system can advise the person how long they can occupy or use the table or chair. In another embodiment through the integration of a seating kiosk (self-seating kiosk), an appointment app a person can be allocated a table including duration permitted. In other embodiments the application of the invention to gyms, hairdressers and even to the appointment setting processes of lawyers etc. Embodiments of this application are supported by, and with further details provided within the additional related patent applications and more specifically:

1. Ordering and Allocation Integration—as described in Table 1

Stock Control, Ordering and Purchasing (243): In one aspect, embodiments of stock control relate the creation of alternate menu item for allergies and dietary requirements of the claimed invention. In one aspect the ordering and purchasing of the claimed invention relate to the creation offering for sale items not traditionally associated with restaurants and the automation of the transactional aspects so that no manual intervention or work is required. This includes the ordering of additional tables and chairs if the allocation model determines the requirement for additional furniture. Embodiments and aspects of this application are supported by, and with further details provided within the additional related patent applications:

1. Space—as described in Table 1

2. Rosters—as described in Table 1

3. POS Transactions—as described in Table 1

Home Delivery and Takeaway Integrations for Production and Time Scheduling (245): In one aspect, embodiments of the home delivery, takeaway integrations for production and time scheduling include the monitoring of time durations, and the autonomous turning on, turning off, or provision of time information concerning food production times, yield management, dynamic pricing and point of sale (POS) integration of the transactional aspects. Embodiments and aspects of this application are supported by, and with further details provided within all the relevant patent applications.

Payment Rules (247): In one aspect, embodiments of payments include the ability to have different payment rules for different menus, different courses, different booking times, different prices by booking channel, etc, so that a completely dynamic pricing system and payment constraints are created. Embodiments include; payment decision trees; prepayment and payment constraints, different channel constraints, product differentiation, dynamic pricing etc. (247) Embodiments and aspects of this application are supported by, and with further details provided within the additional related patent applications.

Artificial Intelligence (251): In one aspect, embodiments of artificial intelligence include the complete automation of the entire restaurant process from a systems perspective which is beyond the ability and scope of prior art systems. Including data mining, advanced analytics, modelling and predictive analysis to automatically amend constraints. (251) Embodiments and aspects of this application are supported by, and with further details provided within additional patent applications and more specifically by the following applications:

1. Artificial Intelligence—as described in Table 1

2. Yield Management—as described in Table 1

Alternate Payment Systems (253): In one aspect, embodiments of the alternate payment systems is the ability of a venue to offer alternate payment such as a progress payment option, not available within the prior art. This becomes a viable option within the claimed invention as the autonomous reconciliation of part payments means that the manual reconciliation processes and labour burdens of the prior art are no longer cost prohibitive. Embodiments and aspects of this application are supported by, and with further details provided within the additional related patent applications.

Referring to FIGS. 2a to 2e, the following references are provided as a summary of one embodiment of the information referred to within the flow chart as “Claimed Invention” 276, “Intuitive booking allocation super highway” (297) and booking allocation information 2026, utilising the information and constraints identified and developed 1a to 1v above:

Processes, Methods and Algorithms within the Current Invention

User, in one embodiment (255)

Various Configurable Access Channels, such that the offers, products services etc., can be completely different by channel (257)

Configurable User/User Interfaces: Restaurant booking widget, function booking widget, self-seating kiosk, self-seating app, restaurant booking app, menu pre-ordering app/widget, promotional apps/widgets, booking form, and integrated systems such as POS systems. (259)

User requirements used in the Booking Allocation: Buy a specific table, request a specific table, request an extended dining duration, flowers, chocolates, card, entertainment, gift, different order of service, personal waiter, specific personal waiter, budget, occasion etc. (261)

Strategic Control of Capacity, Product and Services for Booking Allocations: Strategic capacity availability by Area, Sub-area, Section and Class. Strategic Product and Service Availability by Menu, by Courses, by Variable Time Durations to meet revenue and yield management targets. (263)

Booking Allocation for the Optimisation of Space: (Sale of specific tables with guaranteed allocation, Super VIP guaranteed seating, VIP prioritised seating, Optimisation of remaining table allocations to Area, Sub-areas, Sections and Classes based on venue strategy, the introduction of additional tables and/or chairs, the removal of tables and/or chairs, the interchange of tables, the interchange of table tops, etc. (265)

Payment/Deposit Confirmation (267)

Butler Service: Ordering of 3^{rd} Party Services/Products, the changing of the order of service, the introduction of items not traditionally offered by restaurants. (271)

Time-Related Booking Optimisation: At a predetermined time (e.g. 1 hr before service), reallocation of all bookings to offer the best tables to the highest ranking, non-guaranteed table-allocated customers (Musical Chairs) (269)

Event-Related Booking Optimisation: At the occurrence of an event, e.g.: Rain, reallocation of outdoor bookings to tables in undercover Areas, Sub-areas, Sections and Classes. Such a reallocation can be automatic through a linking of the booking process to a third party weather site or through a re-allocation allocation process that has been programmed and can identify the weather affected tables. (273)

Capacity-Related Booking Optimisation: An event that a particular class of table is at full capacity, a determination if demand for other classes of tables is such that they can be reduced and additional tables offered for the class in demand. (275)

Strategy-Related Booking Optimisation: An ambience re-allocation: if restaurant is not expected to fill up or other parameters apply. (277)

Third Party Information Booking Optimisation: Theatre information, website information which may have an impact on capacity decision. E.g. allocating bookings to a minimum space in anticipation of a full theatre next door. (279)

Pre-service Booking Allocation Optimisation: A final optimisation before service taking all the above factors into account, as well as opening up capacity for walk-ins, if such capacity had been previously excluded from the allocated capacity. Creation of run sheets and service notes for staff. If a venue selects self-seating option, floor plans and seating locations as they would appear at time of arrival of each booking are sent to each customer. (281)

Cockpit Dashboard: Dynamic Floor Plan; Time-based floor plan, the booking system having an inbuilt POS system, and the ability to take orders, receive orders, reconcile accounts, etc. including integration to other systems including other POS systems to create a completely integrated dynamic real-time systems environment (283)

In-service Booking Allocation Optimisation: Optimisation can be based on any combination or permutation of the above optimisation algorithms or different algorithms which can only use tables located within the restaurant and/or without moving pre-allocated bookings and/or allocating bookings based on space optimisation or other dimension such as allocation to the best table. (285)

Self-Seating Kiosk (Booking Allocation): Applicable for venues that have selected the self-seating option. The kiosk can provide information on the seating location of confirmed bookings as well as the ability of accepting new walk in bookings as well as providing direction such that a host or someone to seat guests is not required. (287)

Autonomous Restaurant and Complete Integration: Fully integrated information system including table and position sensors. (289)

Point of Sale System: A fully integrated with dynamic real-time table plan layout with orders sent to kitchen and bar as appropriate and automatic reconciliations. (291)

Payments: Fully integrated with links to original booking including part payments by table, customer and position number. (293)

Accounting System: The complete integration of the booking systems with all accounting and transaction systems to produce all reports including revenue; P&L statements such that manual input is minimal (295). Including the implementation of a volumetric framework within the various accounting systems, for example the use of the volumetric framework for per-ordering, the POS system and other accounting systems.

Referring to FIGS. 2f to 2g, the following references are provided as a summary of the information referred to within the flow chart as “Prior Art” 223, “Reactive Allocation” 2030 with booking allocation information 2032:

Prior Art (223)

User (2000)

Access Channels (2002)

User/User Interfaces: Restaurant Booking Widget, Booking Form. (2004)

User requirements used in the Booking Allocation: (Prior Art) Date, time, meal period, pax (2006)

Strategic Control of Capacity, Product and Services for Booking Allocations: (Prior Art) Capacity and Max Group Size by booking time interval for a standard time duration for the whole service or by group size (2008).

Payment/Deposit Confirmation (2010)

Allocation of Booking Request: (Prior Art) Use of a prioritised list of tables and table combinations to allocate bookings. Prior Art process finishes with this step. (2012)

Dashboard: Static Floor Plan (2014)

Payments (2016)

Referring to FIG. 2f and FIG. 2g, the following references are provided as a summary of the information referred to within the flow chart as “Prior Art” 223, “Booking Allocation Information” 2032:

Restaurant Set-up Rules: Open/closed; Meal periods; Floor Plan (not to scale); Seat block-outs; Rooms, Areas, Bars; Tables and table combinations prioritised list; Standard booking time duration or by group size (2020)

Promotional Offers: Discount by time interval (2022)

Database: List of unused tables and table combinations (2024)

It will be understood that the description with regard to FIG. 2a to FIG. 2e are not to be taken as an exhaustive description of the invention or embodiments, but rather a summary of an embodiment, to enable a person skilled in the art to gain an understanding of the broader inventive concept. It will be understood that the preceding and subsequent Figures describe the specific embodiments and aspects as are claimed herein in more detail and provide examples of reduction to practice. Moreover, the description with regard to FIG. 2a to FIG. 2e are not to be taken as evidence that the inventive concept is “abstract” or the mere implementation of an abstract concept. Rather, the description of FIG. 2a to FIG. 2e is intended as a primer or high-level view of the system as a whole, to enable the person skilled in the art to better understand the inventive concept.

It will be understood that the description with regard to FIGS. 2a to 2e are not prescriptive in that all herein features, steps and algorithms are required to be taken or taken in the order that they are shown the description or that they form a definitive list of features, steps and algorithms that comprise the invention. The purpose of FIGS. 2a to 2e and the comparison to a prior art system shown in FIGS. 2f and 2g is to highlight the inventive concept of using the knowledge of space, objects and their relativity and utility data combined with a series of algorithms optimise a space based on the strategic parameters or constraints of a venue.

Moreover, there is described below a series of algorithms, which for convenience, are numbered. However, it will be understood that each algorithm is independent, and the numbering is not reflective of any specific order in which the algorithms are to be applied. The embodiment may apply one or more algorithms dependent on constraint information and the application can be separate to other algorithms, in conjunction with one or more other algorithms, in different sequences with the one or more other algorithms to achieve the desired outcomes for the booking time period in question. The application, sequence, mixture of the algorithms can be configured by each individual restaurant in accordance with their individual strategies and required outcomes.

The first embodiment referred to as the First Algorithm is termed the “Strategic Capacity Control” algorithm, module 263, which makes an assessment of requests based on availability with reference to allocations by space, subspace, class, by time, allowing capacity for walk-ins, by menu, by course, etc.

The second embodiment referred to as the Second Algorithm is termed the “Optimisation of Space Outcomes” module 265, and is relevant to guaranteed table allocations. The algorithm which is an iterative seating optimisation algorithm which is arranged to allocate seating first to Super VIP's and guaranteed seating allocations then based on availability by VIP, group size, etc., to optimise the allocation and position of tables. This algorithm is arranged to optimise floor space efficiency around guaranteed table allocations.

The third embodiment referred to as the Third Algorithm is termed the “Time Related Optimisation” algorithm, module 269, which is best described by an example. For example, one hour before service, if it is decided that no new tables should be added, all bookings are reviewed, and, if there are two different bookings at 6 pm and one booking is from a regular customer and one is from a first time visitor, the regular customer is allocated to the better table and the first time customer is allocated to the other table.

The fourth embodiment referred to as the Fourth Algorithm is termed the “Event Related Optimisation” algorithm, module, 273, which is triggered or undertaken by the occurrence of an event. For example, if it rains, the algorithm would re-allocate part or all of the bookings to outside tables to inside tables as all or part of the outside tables may be rendered unusable.

The fifth embodiment referred to as the Fifth Algorithm is termed the “Full Capacity Optimisation”, module, 275, which is triggered or undertaken when one space, subspace, or class is full. For example, if a specific class within the restaurant was full the algorithm would evaluate if demand for the other classes for that service had availability. If other classes had availability then it would determine if those tables would be filled and what the revenue and contribution would be and if it then determined that it would be best to increase the size of the class that was full and reduce the seating availability in another class it could do so and increase the capacity within the class for which the booking request was received and allocate the booking request against one of the additional tables created in the expanded class.

The sixth embodiment referred to as the Sixth Algorithm is termed the “Strategy and Ambiance Optimisation”, module 277, algorithm. All bookings are reviewed, and if it is found that the restaurant will not be at capacity, the bookings are spread around the restaurant so that a better ambience is achieved within the restaurant. For example, if a restaurant only has two bookings for a Monday evening, the Second Algorithm may have sat both bookings next to each other in a back corner of the restaurant as this was the most efficient use of the restaurant space. This algorithm recognises that this arrangement is not an ideal seating arrangement for an empty restaurant and allocates the two bookings in this example to give both bookings the two best available tables.

The seventh embodiment referred to as the Seventh Algorithm is termed the “Third Party Information Optimisation”, module 279 algorithm. For example, the optimisation algorithm could access third party information such as the bookings for the local theatre and the start and finish times of a show to determine capacity allotments and constraints. Further, it can determine not to offer discounts or promotions at 9 pm as the theatre will finish and it expects numerous walk-in customers.

The eighth embodiment referred to as the Eighth Algorithm is termed the “Pre-Service Quantitative and Qualitative” algorithm, module 281. This is the final optimisation algorithm before a service and can be a combination of one or more of the previous algorithms at the discretion of the restaurant manager. It is run at a predetermined time before service and is also used to create run sheets and provide information to restaurant staff as well as provide final seating plans and arrangements for self-seating customers. As another example, as a restaurant can be split into different classes part of a restaurant can offer self-seating and part of a restaurant can offer full table service.

The ninth embodiment referred to as the Ninth Algorithm is termed the “In-service Allocations without additional tables or changing existing table allocations” algorithm, module 285. This algorithm is executed after service begins and new bookings are limited to the use of only tables physically available within the restaurant. The in-service optimisation process uses the In-service Allocations algorithm to provide a limited optimisation process which limits the allocation process by means of additional constraints to optimise request allocation process with minimise the disturbance to current patrons.

The Ninth Algorithm is not mandatory as the eighth algorithm or any other algorithm or a combination thereof could continue to be used without the need to unseat existing bookings whilst maintaining the ability to add or remove one or more tables. Further, additional algorithms or variations of the booking algorithms could be added to provide additional and different allocation outcomes and as a consequence provide additional tools for both the customer and the restaurant to achieve their preferred objectives and customer service standards.

Referring to Annexures 1 to 11 details are provided of the measures and metrics used by the prior art and by the embodiments and broader invention described herein which are significantly greater and beyond the scope, functionality, integration and ability of the prior art. Specifically the prior art measures and metrics are contained within Annexure 1 while embodiments of the measures and metrics utilised within our claimed invention are detailed in annexures 2 to 11. The prior art is extremely limited in the ability to analyse and report as the prior art firstly does not appreciate and recognise the importance of additional measures and metrics for reporting, forecasting and artificial intelligence. Secondly the prior art does not have the structures, methods and procedures to be capable of calculating the measures and metric calculations to achieve better outcomes. Two such measures are “revenue yield” and “efficiency”.

Referring to Annexures 1 to 11 the following references are provided as a summary of the measures and metrics detailed within the Annexures:

Annexure 1 Prior art measures and metrics: This annexure highlights the prior art metrics and measures are limited to a limited number of practical and theoretical measures that are used and taught within universities to measure restaurant performance and measurements.

Annexure 2 Floor plan guidelines, rankings, and space efficiency measures for the claimed invention: This annexure provides variables related to spatial guidelines and measures, such as; floor space allocation, dining, bar and customer spaces, table top guide, fixed and flexible seating areas including walkways, chair size guide, spacing between tables, waiter stations guide, bar space and bar stools guide, area per person size guide, area per person size guide, area, sub-area, class, section, and table and stool rankings, table analysis, tables for sale, tables for auction, tables dedicated to specific channels, location analysis and floor space efficiency.

Annexure 3 Capacity utilisation and revenue efficiency measures for the claimed invention: This annexure provides variables related to capacity, utilisation and revenue efficiency measures, which include the concept of dynamic floor plans which is a concept of the claimed invention where by additional tables and chairs can be added to a floor plan during the booking allocation process and these additional tables and chairs need to be included within these performance measures and metrics. These measures and metrics include; revenue yield, seat capacity (production) and utilisation, table capacity (production) and utilisation, units of measure of capacity, physical constraints, hours open, service periods open, service hours open, back of house (kitchen) hours, front of house (dining room) hours, revenue measures.

Annexure 4 Booking Analysis for the claimed invention: This annexure provides variables related to booking analysis, such as; Booking requests allocated analysis, booking profile analysis, booking requests rejected analysis, source of booking analysis.

Annexure 5 Duration Time Analysis for the claimed invention: This annexure provides variables related to duration time analysis, such as; duration times by booking size, by occasion, by menu selected, by courses selected, by booking time, by booking day, by customer type, by requests for extended durations, by duration times extended, by table, by class.

Annexure 6 Product Mix Analysis for the claimed invention: This annexure provides variables related to a product mix analysis, for areas, subareas, classes, sections, tables, distribution and channel for items such as; food: by time, by service, by day, by server, by channel; Beverage: by time, by service, by day, by server, by channel; Supplementary items: by time, by service, by day, by server, by channel.

Annexure 7 Revenue and Customer Performance Analysis for the claimed invention: This annexure provides variables related to revenue and customer performance analysis, such as; detailed revenue analysis, detailed customer analysis detailed customer ranking and detailed channel analysis.

Annexure 8 Staff and Roster Parameters for the claimed invention: This annexure provides variables related to staff ratios, requirements, hours, set-up times for the creation of forecasted rosters, performance measurements against those rosters and the use of artificial intelligence to update and maintain those performance measures and use the information to create further improvements to those rosters.

Annexure 9 Profit and Loss Layout (a la carte) structure and definitions for variable costs and fixed costs and contribution analysis for the claimed invention: This annexure variables related to the structure and the relationship between revenue and costs and how those revenues and costs can be determined and understood from a contribution perspective and marginal cost perspective such that decisions and actions taken can be measured in terms of cash generation, contribution and performance for reporting, forecasting as well as for feedback in the artificial intelligence loop.

Annexure 10 Break Even Analysis, Contribution Margins and Variable Pricing Analysis for the claimed invention: This annexure provides variables related to the specific analysis of the financial performance of the claimed invention, the monitoring of the financial performance, for forecasting and for the use of these measures and metrics for learning and artificial intelligence within the framework of the other annexures detailed within this embodiment. This analysis includes; break even analysis utilising the defined profit and loss statement within annexure 9 and other cost performance and analysis measures.

Annexure 11 Supplier Pricing Comparisons and Monitoring for the claimed invention: This annexure provides variables related to requesting comparative pricing, supplier performance and reliability and the monitoring of their performance for recommendations and the automatic placement of orders.

Those skilled in the art can appreciate that the structure of the claimed invention, and more specifically with the measures and metrics referred to within the annexures, that these measures and metrics can easily be converted or adopted within the other industries referred to and to which this claimed invention can be applied to.

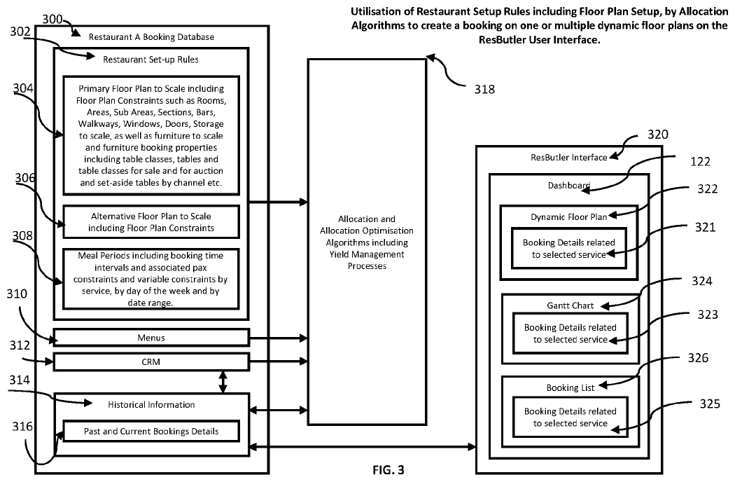

Referring to FIG. 3, there is shown a modular outline of the module and components that comprise an embodiment of the invention, in particular the application of the fundamental constraints or restaurant set-up rules, to allocation and yield management processes. At 300 there is shown a restaurant booking database that includes set-up rules 302. The set-up rules 302 include a primary floor plan 304, alternate floor plans 306 and meal periods 308. The database 300 also includes menu information 310, Customer Relationship Management information 312, and historical information 314 (which includes current and past booking details 316). The restaurant setup rules 302, the menu information 310, the Customer Relationship management information 312 and the historical information 314 are utilised by the allocation algorithm 318 to provide a dashboard 122 on an interface 320. The dashboard 122 includes a dynamic floor plan 322, a Gantt chart 324 and a booking list 326, each of which include relevant booking details for the selected service shown by 321, 323 and 325 (in different formats, as would be understood by a person skilled in the art).

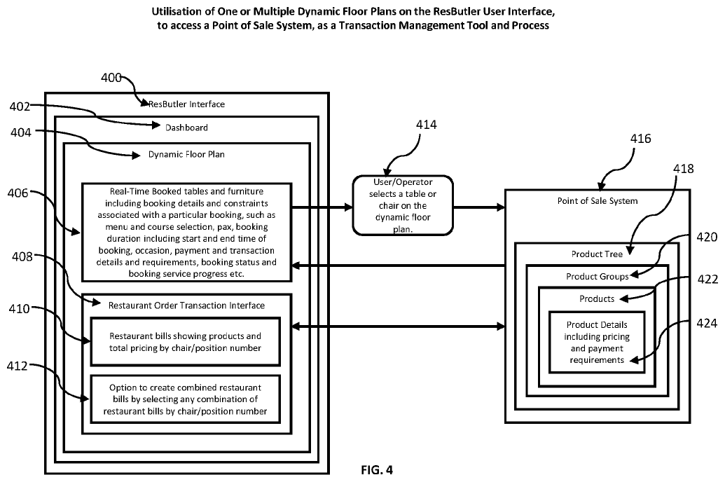

Referring now to FIG. 4, there is shown a modular outline of the modules and components that comprise the ResButler interface 400 when interacting with a Point of Sale (POS) system 416, in particular focusing on the role of the dynamic floor plan in seamlessly managing and reconciling booking and transactional processes As per FIG. 3, there is provided a dashboard 402 on the interface 400. The dashboard 402 includes a dynamic floor plan 404 including a real-time representation of booked tables 406, and a restaurant transaction interface 408 including restaurant bills 410 and an option to create restaurant bills (by combining individual bills) 412. The real time representation 406 allow a user to select a table or chair 414, which interacts with a POS system 416 to update the real-time booked tables. In addition, the POS system 416, which includes a product tree 418, which in turn includes product groups 420, and in turn includes products 422, each product having product details 424, interacts with the restaurant order transaction interface 408, to provide an ability to individually customise each invoice (bill) and also to provide the ability to perform any yield management operation desired by the operator.

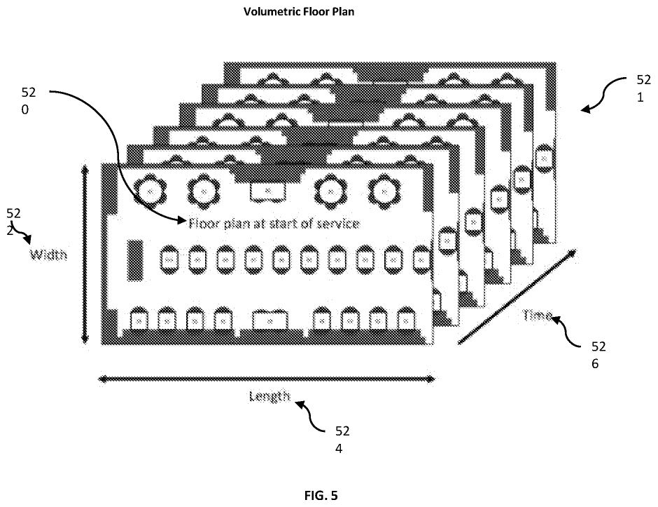

Referring not to FIG. 5, there is shown a representation of the “volumetric” approach to managing a floor plan, as embodied in the software and the interface in accordance with an embodiment of the invention. The volumetric approach models the floor plan across three dimensions, namely the width 522 and length 524 of the restaurant venue/space, with the third dimension being time 526. This is represented on the interface as a floor plan that varies over time (e.g. floor plan 520 represents a floor plan at one time, whereas floor plan 521 represents a floor plan at another time). The variances in floor plan 520 to 521 (as an example) is not limited to the bookings allocated to tables, but also includes the movement of furniture, thereby creating a dynamic floor plan that changes over the course of a period of time, the floor plan representing a visual indicator to the operator of the restaurant as to the manner in which the restaurant should be arranged.

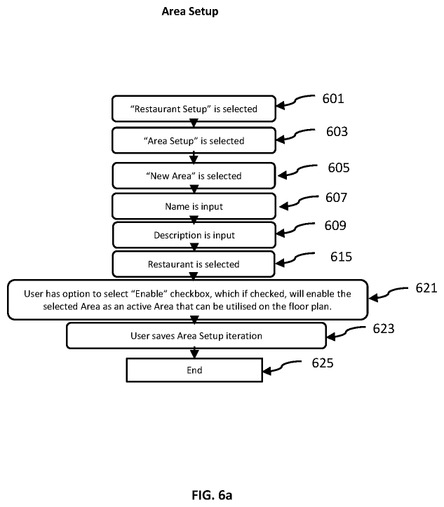

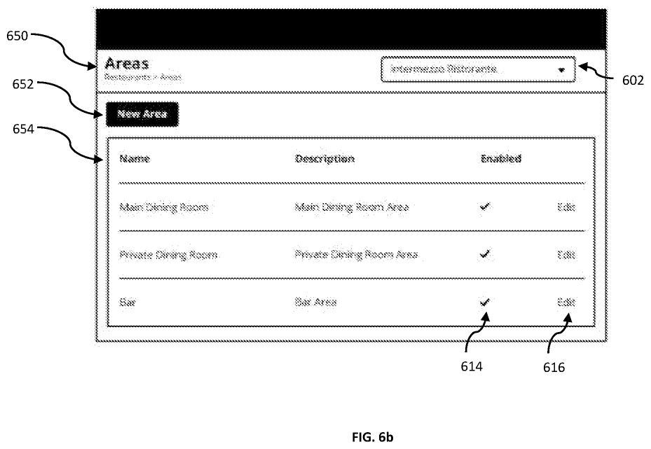

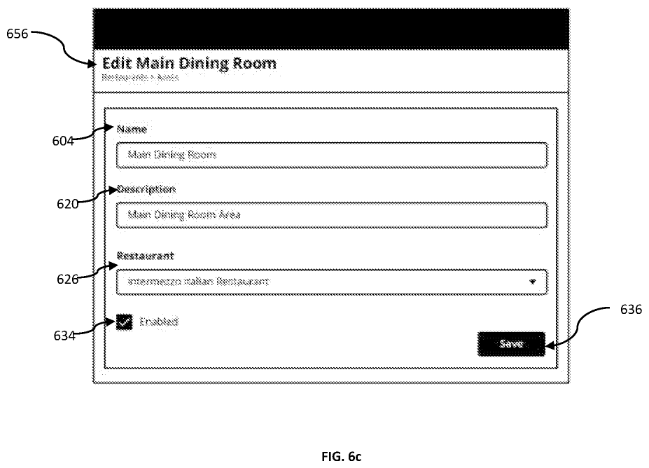

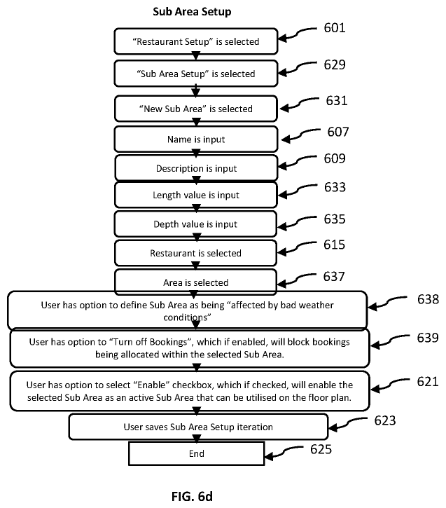

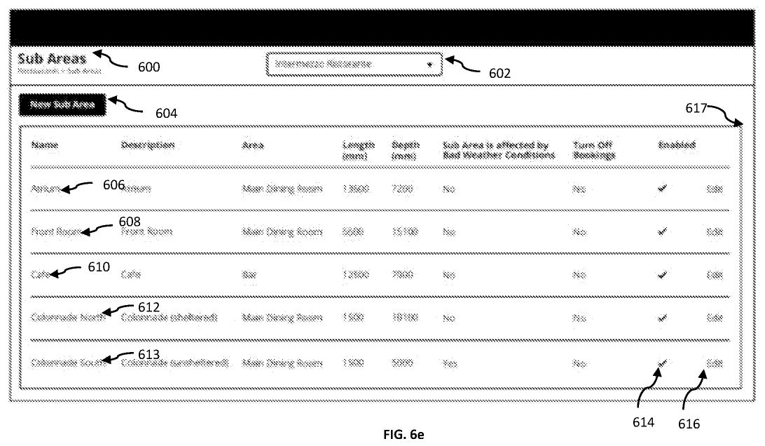

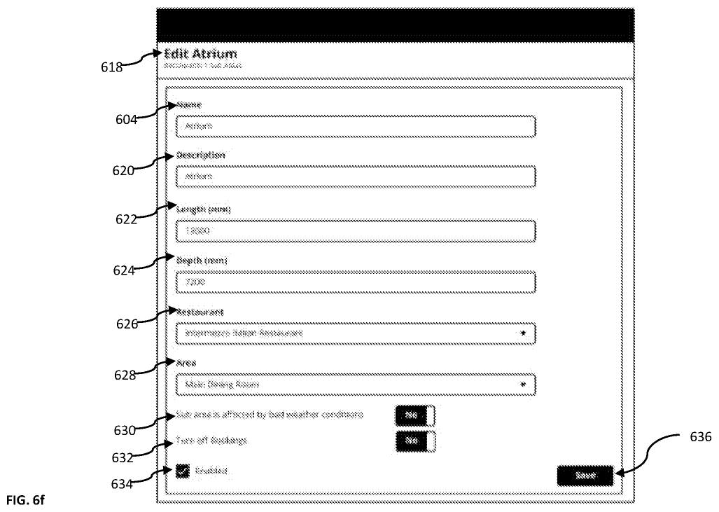

Referring now to FIG. 6a, there is shown a flowchart which outlines the process steps utilised to setup an area of a floor plan in a restaurant for placement on a floor plan (and the subsequent generation of constraints to be utilised in the determination of allocations of furniture in response to booking requests) in accordance with an embodiment of the invention. The setting up of a floor plan generates a set of constraints for use by the algorithm and also serves as a set of “starting conditions” for determining the placements of tables and chairs. However, it will be understood that the inclusion of a set of starting conditions does not serve to limit the ability of the algorithm to allocate or reallocate tables per se, but rather serves as a means by which to generate a series of constraints for use by the algorithm.

Importantly, at a practical level, the starting floor plan also serves as a visual indicator to a restaurant operator and other staff, as it serves as a visual “starting point” so that, before bookings are received, the operator is given a sense of the likely layout of a restaurant.

Turning to FIG. 6a, at step 601, the operator selects “Restaurant setup” and then at step 603 selects “Area setup”. A “new area” is selected at step 605 and a name for the new area is input at step 607. A description may also be input at step 609, and subsequently the new area is associated with a specific restaurant at step 615. At step 621, the operator can select to make the area active, such that it is displayed on the floor plan. The operator then saves the area at step 623 and the process ends at step 625.

Referring to FIGS. 6b and 6c there is shown two screenshots of area setup screens 650 and 656 which allow a user to set up areas in a restaurant to which sub-areas may be added to develop a floor plan and also generate associated constraints, as was described with reference to the process flows of FIG. 6a. Referring to FIG. 6b specifically, there is shown a screen shot 650 in which a restaurant may be selected at 602. There is also provided a new areas button 652, which if chosen, generates an interface in accordance with FIG. 6c (described below). There is further provided an area list 654 which includes the name and description of the area, and from which the operator can choose to enable the area by using check boxes 614 and edit the area by using edit function 616.

Referring to FIG. 6c, when the operator selects the new area button 652 (as shown in FIG. 6b), the interface 656 is displayed to the operator. The operator may then input a name at 604, input a description at 620, select a restaurant at 626 and determine whether the selected area is available for bookings. The operator may also save the selected and/or input options by using save button 636.

Referring to FIG. 6d there is shown a flowchart which outlines the process steps utilised to setup a sub-area in a restaurant for placement on a floor plan (and the subsequent generation of constraints to be utilised in the determination of allocations of furniture in response to booking requests) in accordance with an embodiment of the invention.

At step 601, restaurant setup is selected. Thereafter, the operator selects a sub area setup option 629. A new sub area option is selected at 631, after which a name is input 607, a description is input 609, a length value 633 is input, a depth value 635 is input, a restaurant is selected 615 and an area is selected 637. Thereafter, the operator has the option to define whether the area may be affected by weather conditions 638, the option to “turn off bookings” 639 (so that the algorithm will not allocate bookings to the sub area), select an enable checkbox 621, which allows for the utilisation of the sub area on the floor plan, and finally the operator saves the sub area setup at step 623 and the process ends at 625.

Referring to FIGS. 6e and 6f there is shown two screenshots of sub area setup screens 600 and 618 which allow a user to set up sub areas in a restaurant to which furniture may be added to develop a floor plan and also generate associated constraints, as was described with reference to the process flows of FIG. 6a. Referring to FIG. 6e specifically, there is shown a screen shot 600 in which a restaurant may be selected at 602. There is also provided a new sub area button 604, which if chosen, generates an interface in accordance with FIG. 6f (described below). There is further provided an area list 617 which includes the name and description of the sub area, and from which the operator can choose to enable the area by using check boxes 614 and edit the area by using edit function 616.

Referring to FIG. 6f, when the operator selects the new sub area button 604 or edit link 616, (as shown in FIG. 6e), the interface 618 is displayed to the operator. The operator may then input a name at 604, input a description at 620, select a restaurant at 626 and determine whether the selected sub area is available for bookings. The operator may also select whether the sub area is affected by weather at 630 and can turn off bookings at 632. Moreover, the user can choose to enable or disable the area using checkbox 634. The operator may also save the selected and/or input options by using save button 636.

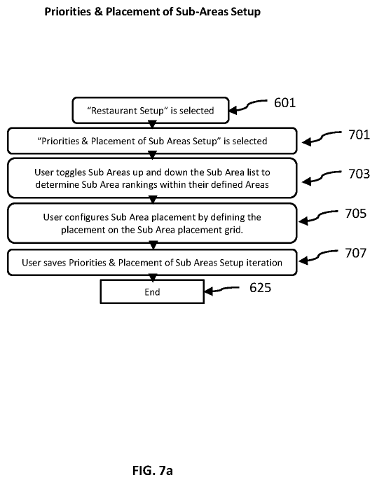

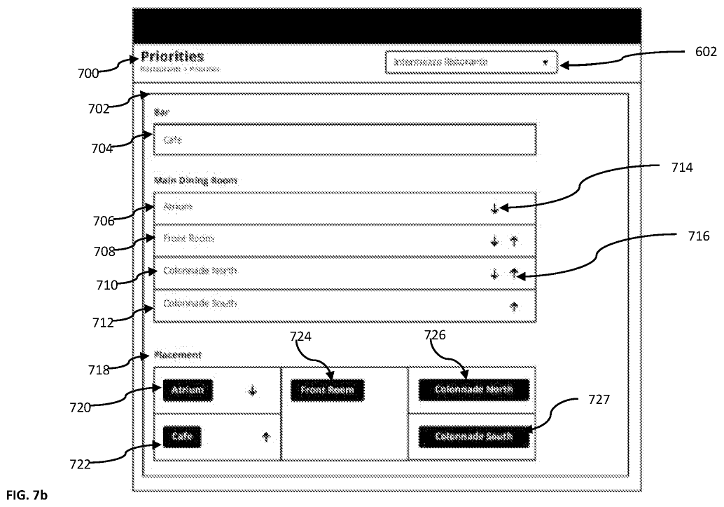

Referring to FIG. 7a there is shown a flowchart which outlines the process steps utilised to place sub-areas and prioritise sub-areas in a restaurant for placement on a floor plan (and the subsequent generation of constraints to be utilised in the determination of allocations of furniture in response to booking requests) in accordance with an embodiment of the invention. At step 601, the restaurant setup option is selected and subsequently at step 701 the priorities and placement of sub areas setup is selected. The operator may then, using the interface, move sub-areas up or down a list to allocate a relative ranking to each sub-area at step 703. The operator may also configure sub-area placement by defining the placement on a sub-area placement grid at step 705. The operator then saves the setup at step 707 and the process ends at step 625.

Referring to FIG. 7b there is shown a screenshot of setup screen 700 which allows a user to set up sub-areas and prioritise sub-areas in a restaurant and associated constraints, as was described with reference to the process flow of FIG. 7a. The operator can select a restaurant utilising selector 602. The operator can also input or configure existing data to generate constraints in area 702, which includes the ability to prioritise sub areas within an area, such as example sub areas 704, 706, 708, 710 and 712 by utilising arrows 714 and 716, and also affect the placement of sub-areas in the placement option 718, which allows for the movement of rectangular objects representing sub-areas, such as example sub-areas 720, 722, 724, 726 and 727.

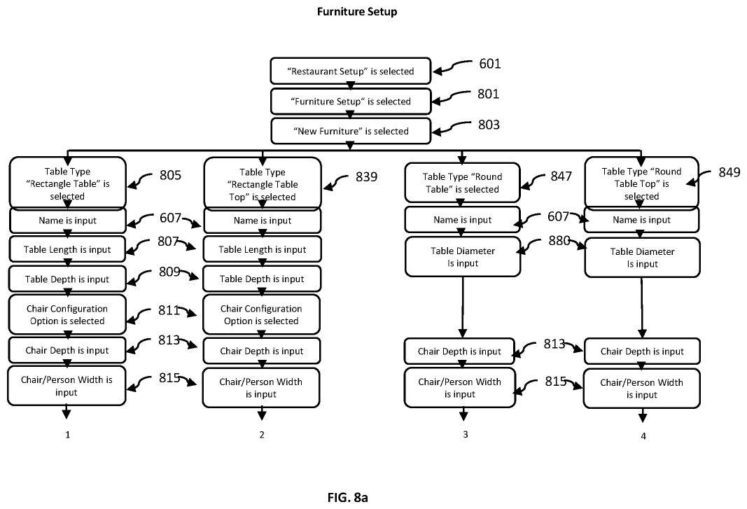

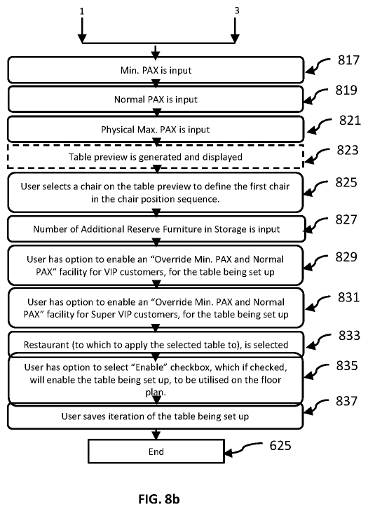

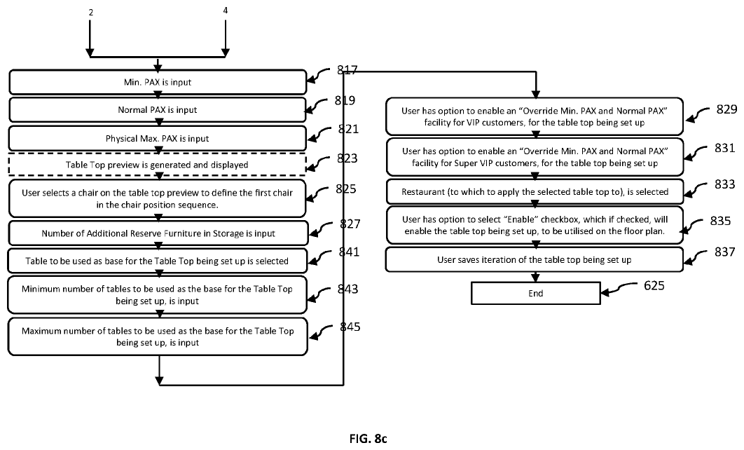

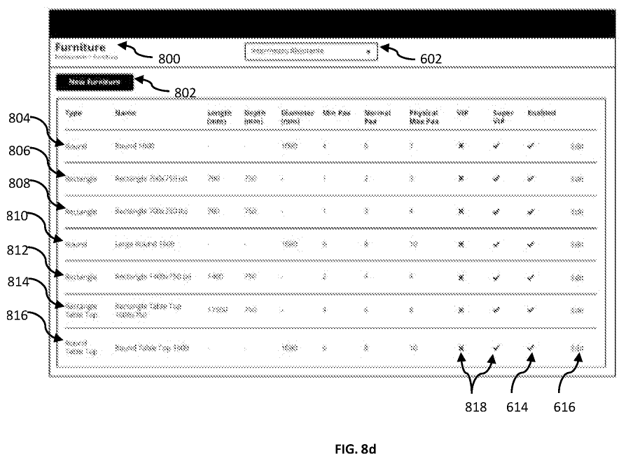

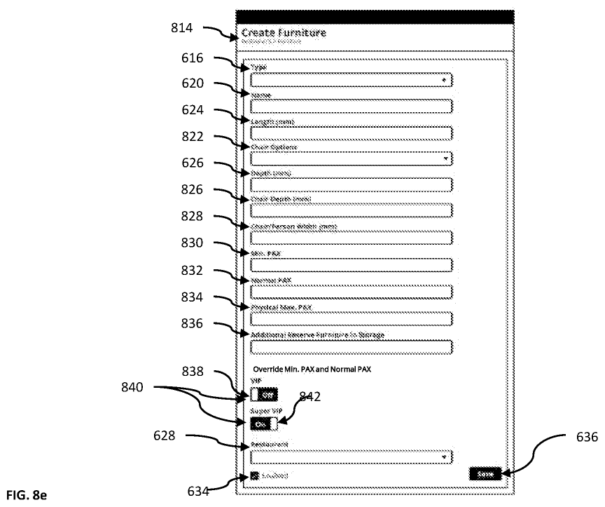

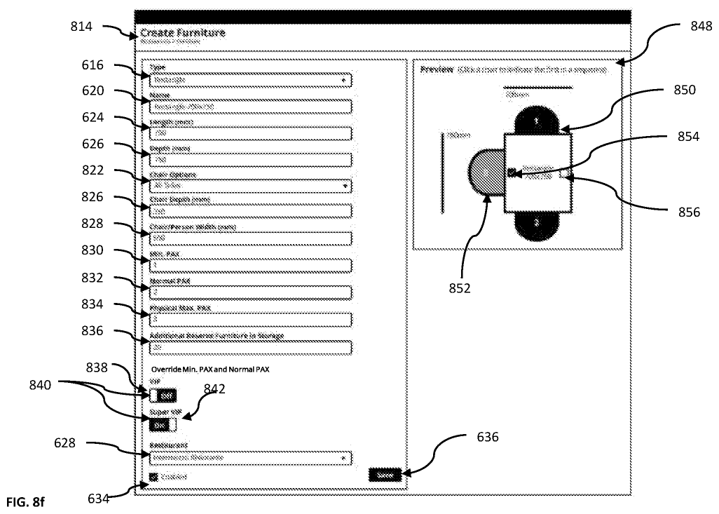

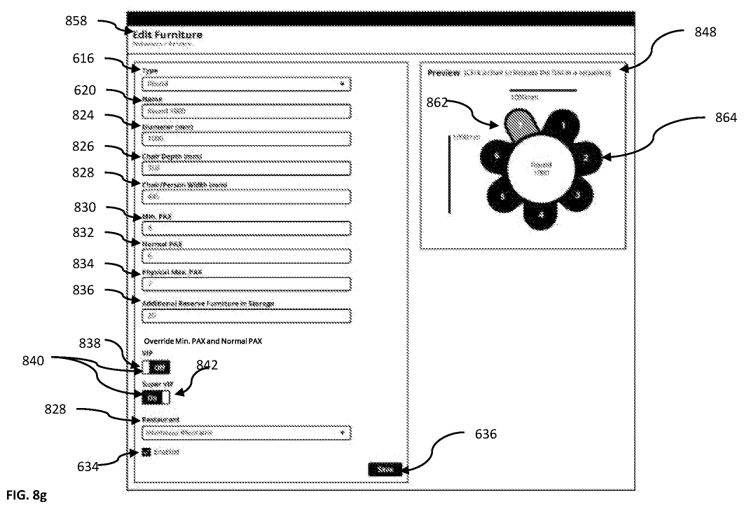

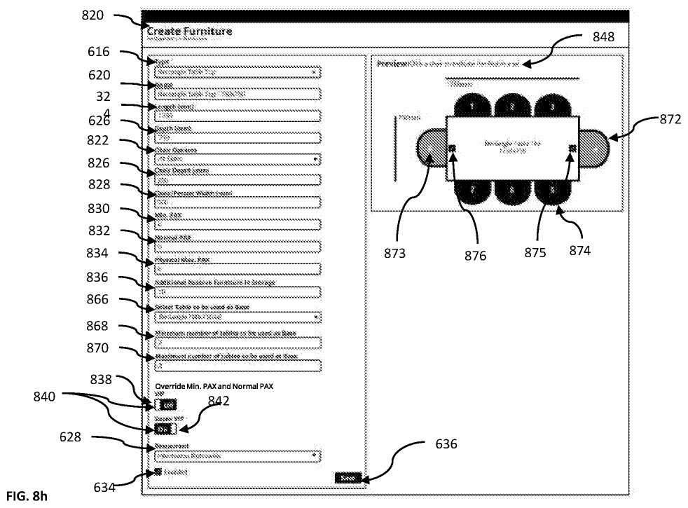

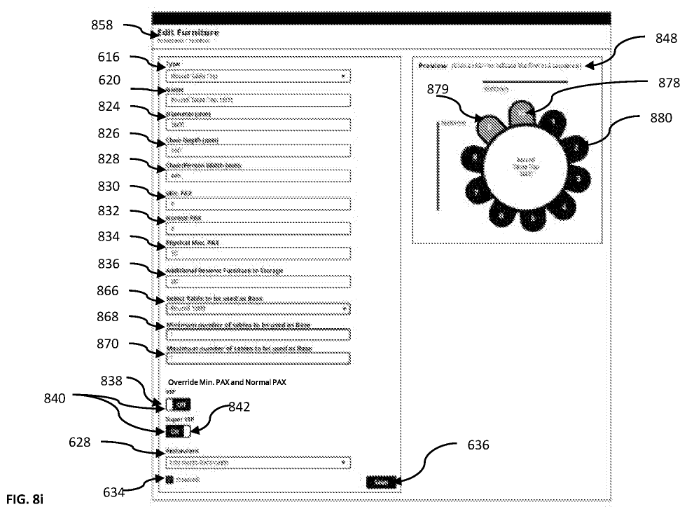

Referring to FIGS. 8a, 8b and 8c there is shown interconnected flowcharts which outline the process steps utilised to setup items of furniture in a restaurant for placement on a floor plan (and the subsequent generation of constraints to be utilised in the determination of allocations of furniture in response to booking requests) in accordance with an embodiment of the invention.

Referring firstly to FIG. 8a, there is shown a furniture setup process flow where at step 601, a restaurant setup is selected and at step 801, a furniture setup is selected, and subsequently the operator selects a new furniture option a step 803. Upon selecting a new furniture option, in the embodiment shown, there are provided four table types, namely rectangle table, rectangle table top, round table and round table top. It will be understood that these types are illustrative only and that the system may include any type of table type, of any shape and attribute.

At step 805, if the operator selects rectangle table type, the operator can then ascribe a name to the table type at step 607 (a free form name that may have significance to the operator), after which the operator inputs a table length at step 807, a table depth at step 809, a chair configuration option at step 811, a chair depth at step 813 and a chair width at step 815, before the process continues along arrow 1 which is described in FIG. 8b. Alternatively, at step 839, if the operator selects rectangle table top type, the operator can then ascribe a name to the table type at step 607 (a free form name that may have significance to the operator), after which the operator inputs a table length at step 807, a table depth at step 809, a chair configuration option at step 811, a chair depth at step 813 and a chair width at step 815, before the process continues along arrow 2 which is described in FIG. 8c. Alternatively, at step 847, if the operator selects round table type, the operator can then ascribe a name to the table type at step 607 (a free form name that may have significance to the operator), after which the operator inputs a table diameter at step 880, a chair depth at step 813 and a chair width at step 815, before the process continues along arrow 3 which is described in FIG. 8b. Alternatively, At step 849, if the operator selects round table top type, the operator can then ascribe a name to the table type at step 607 (a free form name that may have significance to the operator), after which the operator inputs a table diameter at step 880, a chair depth at step 813 and a chair width at step 815, before the process continues along arrow 4 which is described in FIG. 8c.

Referring to FIG. 8b, there is shown a continuation of arrows 1 and 3 of FIG. 8a. At step 817 the operator inputs the minimum number of people to be seated at the table, after which at step 819 the operator inputs the normal number of people to be seated at the table, after which the operator inputs the physical maximum number of people to be seated at the table at step 821 (which may be different from the “desired” maximum). At step 823, a table preview is generated and displayed. Using the generated display, at step 825 the operator selects an arbitrary chair to designate as chair ‘1’, at which time all other chairs are numbered accordingly. The number of spare tables in storage are then input at step 827 and the operator decides whether to enable an ‘override’ option which allows VIPs and SVIPs (at steps 829 and 831 respectively) to be seated at a table irrespective of whether the booking request meets the minimum criteria input in step 817, or exceeds the normal pax setting input in step 819. The operator then assigns the table to a restaurant at step 833, and also decides whether the table is to be used on the floor plan at step 835. Lastly, the user saves the iteration of the table at step 837 before the process ends at step 625.

Referring to FIG. 8c there is shown a continuation of arrows 2 and 4 of FIG. 8a. At step 817 the operator inputs the minimum number of people to be seated at the table, after which at step 819 the operator inputs the normal number of people to be seated at the table, after which the operator inputs the physical maximum number of people to be seated at the table at step 821. At step 823, a table top preview is generated and displayed. Using the generated display, at step 825 the operator selects an arbitrary chair to designate as chair ‘1’, at which time all other chairs are numbered accordingly. The number of spare tables in storage are then input at step 827. Subsequently at step 841, the table type which will be used as a base is selected, along with the minimum number of tables to be used as the base at step 843 and the maximum number of tables to be used as the base at step 845. The operator then decides whether to enable an ‘override’ option which allows VIPs and SVIPs (at steps 829 and 831 respectively) to be seated at a table irrespective of whether the booking request meets the minimum criteria input in step 817, or exceeds the normal pax setting input in step 819. The operator then assigns the table top to a restaurant at step 833, and also decides whether the table is to be used on the floor plan at step 835. Lastly, the user saves the iteration of the table at step 837 before the process ends at step 625.

Referring to FIGS. 8d through to 8i, there is shown a series of screenshots of furniture setup screens 800, 814, 858 and 820 which allow a user to set up furniture items for use in a restaurant and also generate associated constraints, as was described with reference to the process flows of FIG. 8a-8c.

Referring to FIG. 8d, there is shown a screenshot of all furniture types as inputted in an example. The screen 800 includes a restaurant selector 602, a button to add new furniture 802, and various types of furniture such as 804, 806, 808, 810, 812, 814 and 816 are shown. The user may select a furniture item as to allow for SVIP and or VIP customers to override the minimum pax and normal pax settings (818), enable furniture for use on the floor plan (614) and may edit the furniture item at 616.

Referring to FIG. 8e, there is shown a create furniture screenshot 814 which allows for a number of inputs, including selecting a furniture type 616, providing a name 620, inputting a length 624, inputting chair options 822, inputting a depth 626, inputting a chair depth 826, inputting a chair width 828, inputting a minimum number of people 830, inputting a normal number of people 832, inputting a physical maximum number of people 834 and inputting a number of reserve tables 836, plus the inclusion of toggles generally shown at 840 to override the minimum number of people and normal number of people to be seated at a table for VIPs 838 and SVIPs 842, selecting a restaurant 628 and enabling use of the table in the floor plan 634. The operator may save all changes by utilising save button 636.

Referring to FIG. 8f, in addition to the inputs shown with reference to FIG. 8e, there is shown a preview screen 848 which includes an example of the rectangular table and chair combination 850, the addition of a chair 852, and the ability to manually add or remove a chair by utilising the check boxes 854 and 856. All of the information captured at this stage serves to assist in the display of the floor plan, but more importantly, creates a series of constraints which are subsequently utilised by the allocation algorithm.

Referring to FIG. 8g in addition to the inputs shown with reference to FIG. 8e, there is shown a preview screen 848 which includes an example of a round table and chair combination 864 and the addition of a chair 862.

Referring to FIG. 8h in addition to the inputs shown with reference to FIG. 8e, there is shown a preview screen 848 which includes an example of a large rectangular table top and chair combination 874 and the addition of chairs 872 and 873, and the ability to manually add or remove a chair by utilising the check boxes 876 and 875.

Referring to FIG. 8i in addition to the inputs shown with reference to FIG. 8e, there is shown a preview screen 848 which includes an example of a round table top and chair combination 880 and the addition of two chairs 878 and 879.

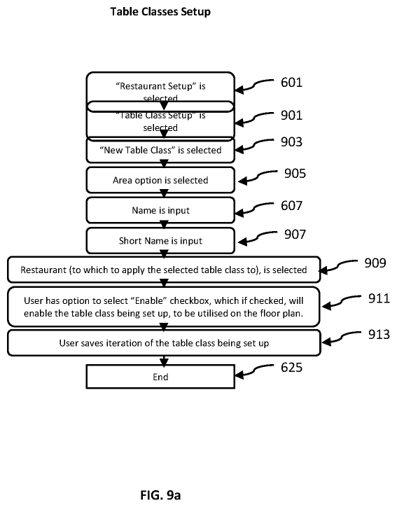

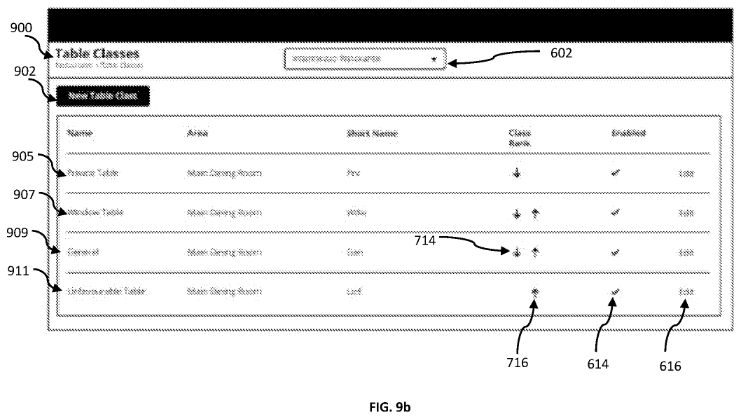

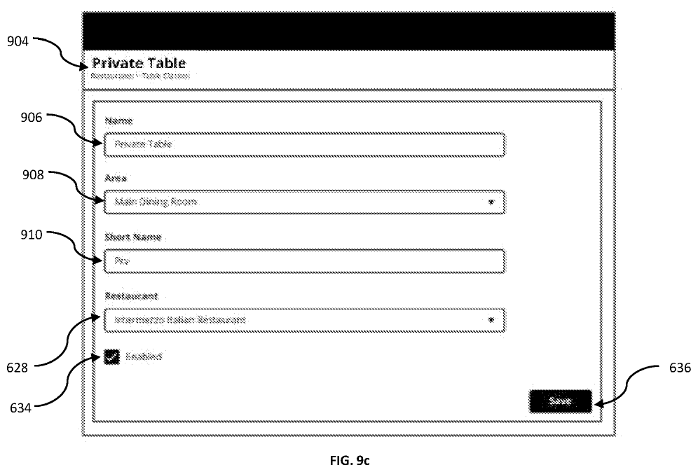

Referring to FIG. 9a there is shown a flowchart which outlines the process steps utilised to setup table classes and their relative rankings, to be utilised as one of various attributes that can be assigned to a table placed on the floor plan (and the subsequent generation of constraints to be utilised in the determination of allocations of furniture in response to booking requests) in accordance with an embodiment of the invention. At step 601 restaurant setup is selected, and subsequently at step 901 a table class setup option is selected, and then at step 903 a new table class is selected. The operator then selects an area option at step 905 and inputs a name at 607 and a short name at step 907. The operator subsequently selects a restaurant to which to apply the selected table class at step 909, and the user then selects whether the table class being set up will be utilised on the floor plan at step 911. Finally, the user saves an iteration of the table class at step 913 and the process ends at step 625.

Referring to FIG. 9b there is shown a screenshot of setup screen which allows a user to allocate classes to tables in a restaurant and associated constraints, as was described with reference to the process flow of FIG. 9a. At 900 there is shown a screenshot of the table classes setup screen 900 which includes a restaurant selector 602. A new table class can be added by utilising button 902, and various table classes associated with various areas are shown (905, 907, 909, 911) with each table class being moveable in terms of relative ranking by using arrows 714 and 716. The classes can also be enabled by using check box 614 and edited by using the edit link 616.

Referring to FIG. 9c if the new table button 902 is selected (in FIG. 9b), a new dialogue box 904 is displayed. The operator can create a name for the private table at 906, allocate the table to an area 908, add a short name (for display on the floor plan) 910 and allocate to a restaurant at 628, and also choose to enable the table as a member of a class by checking the enable box 634. The operator may also save the settings by using save button 636.

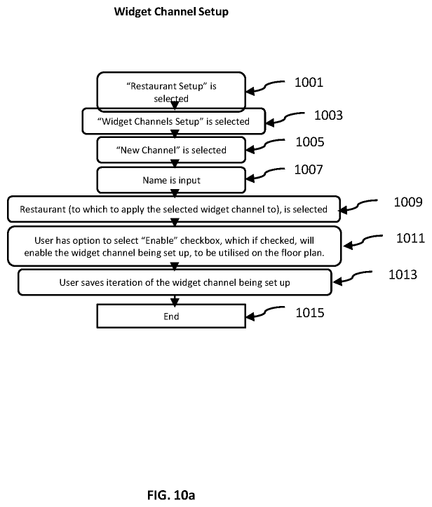

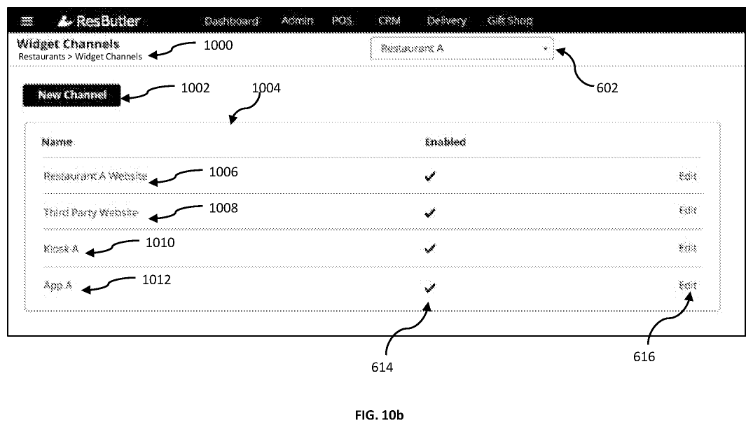

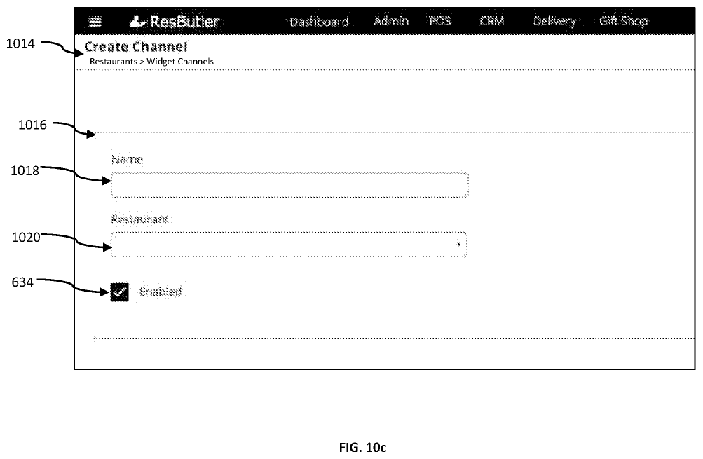

Referring to FIG. 10a there is shown a widget channel setup process flow, which allows a widget channel to be associated with a particular, restaurant, etc, to thereby allow the sets of constraints offered via processes including the booking, allocation and menu ordering processes, to be differentiated and customised by booking channel. At step 1001 restaurant setup is selected, and subsequently at step 1003, widget channels setup is selected, after which at step 1005, a new channel setup option is selected. The operator then inputs a name at 1007 and subsequently selects a restaurant to which to apply the selected widget channel at step 1009, and the user then selects whether the widget channel being set up will be utilised on the floor plan at step 1011. Finally, the user saves an iteration of the widget channel setup at step 1013 and the process ends at step 1015.

Referring to FIG. 10b there is shown a screenshot of the widget channels setup screen which allows a user to set up a floor plan and associated constraints, as was described with reference to the process flow of FIG. 10a. At 1000 there is shown a screenshot of the widget channels dialogue, including an option to select a restaurant 602 and an option to create a new channel 1002. Current channels are shown in section 1004, which include, in the screenshot shown, four example channels 1006, 1008, 1010 and 1012, which can be enabled via use of the check boxes generally shown at 614 and can be edited via use of the edit buttons generally shown at 616.

Referring to FIG. 10c, if the new channel button 1002 is selected (in FIG. 10b), a new dialogue box 1014 is displayed, and a section 1016 which allows the operator to add a restaurant name 1018, select a restaurant 1020 and enable the channel by using checkbox 634.

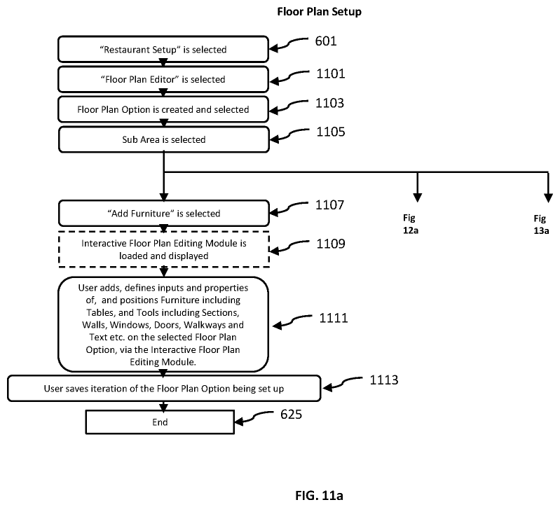

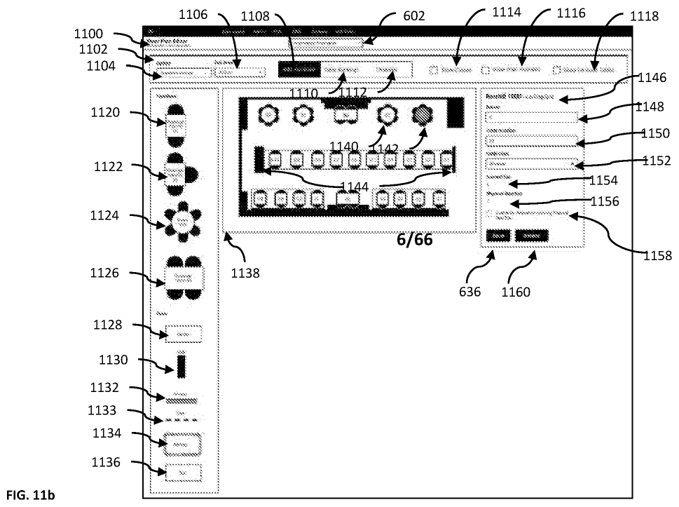

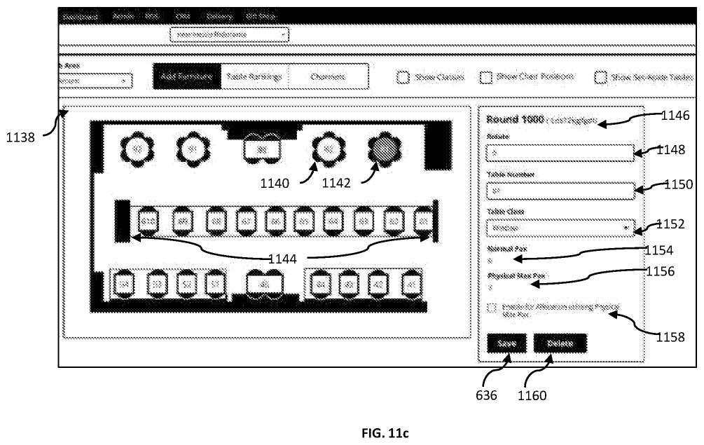

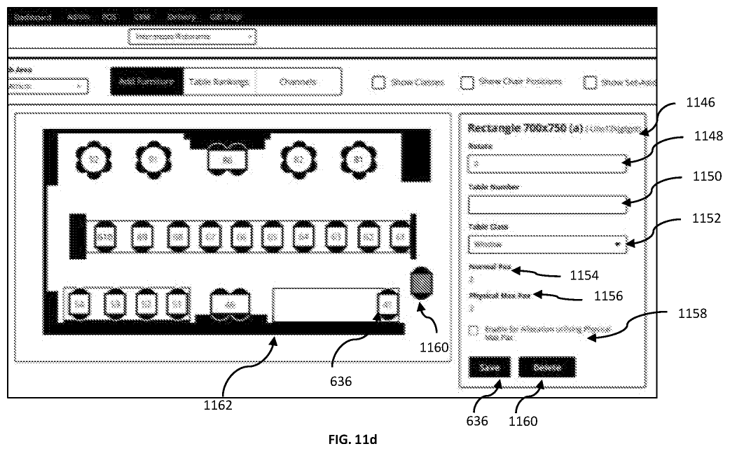

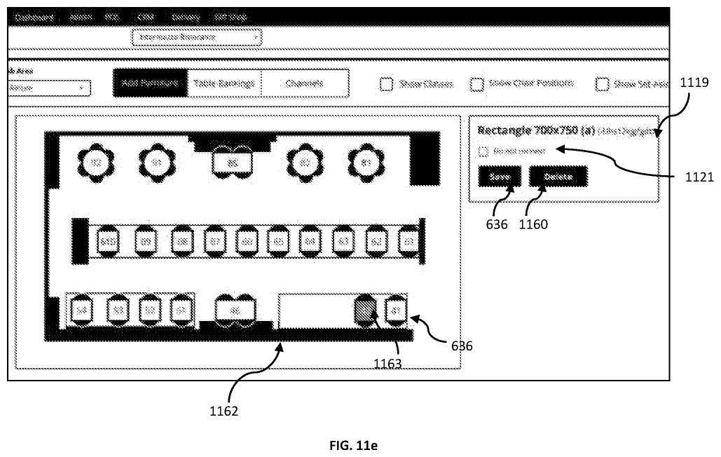

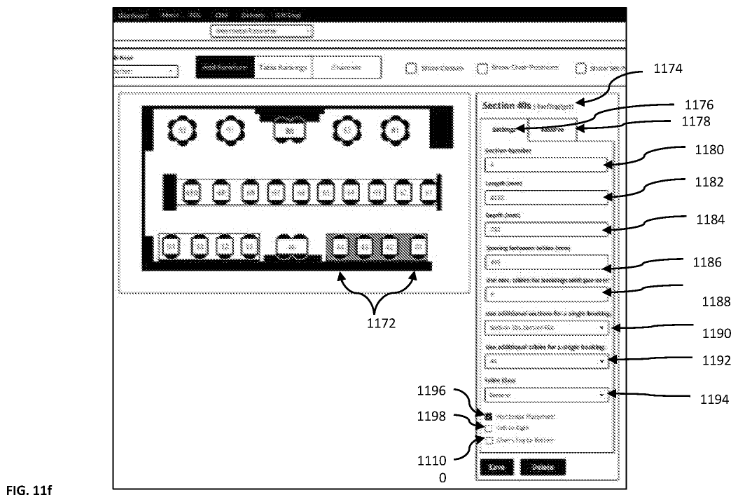

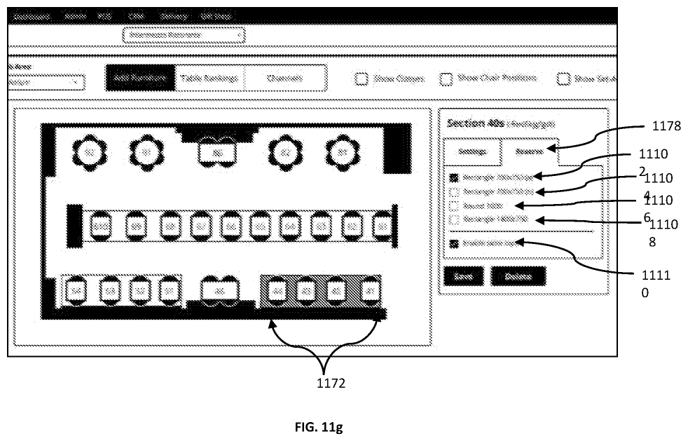

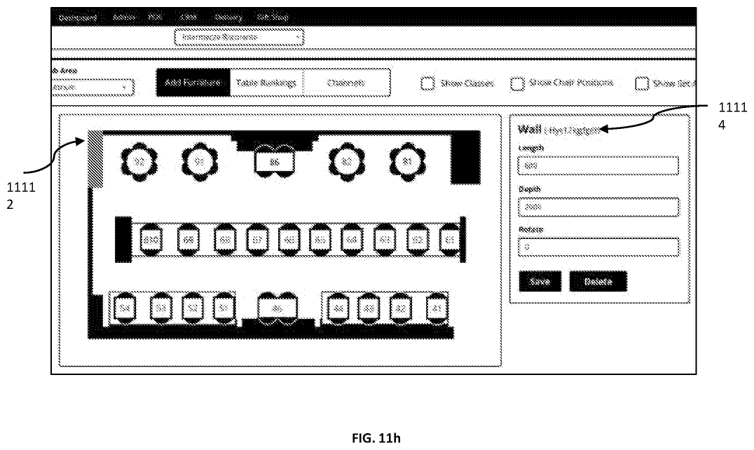

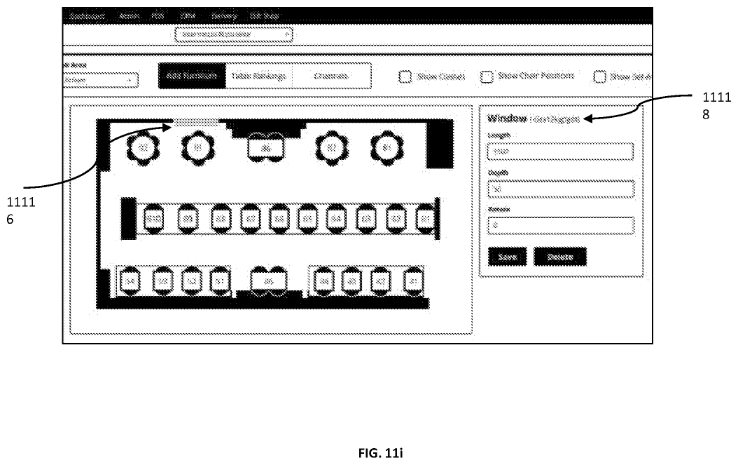

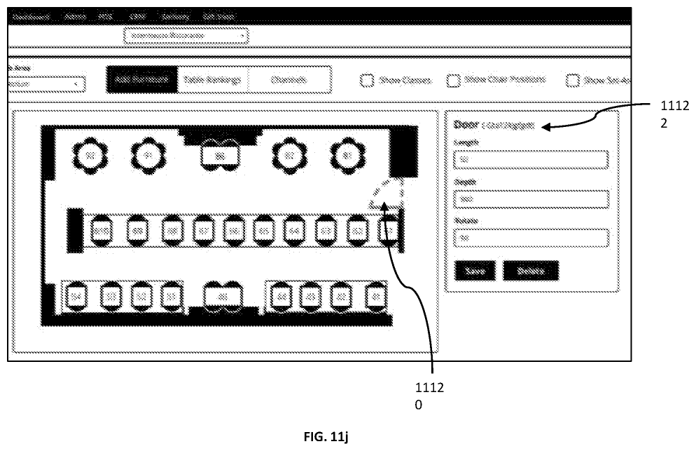

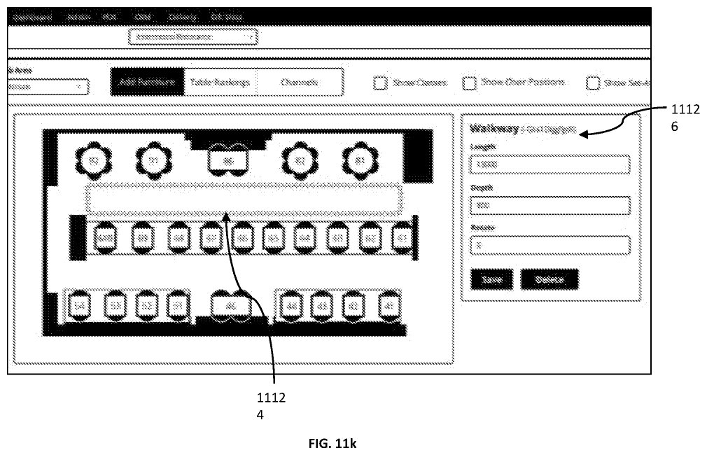

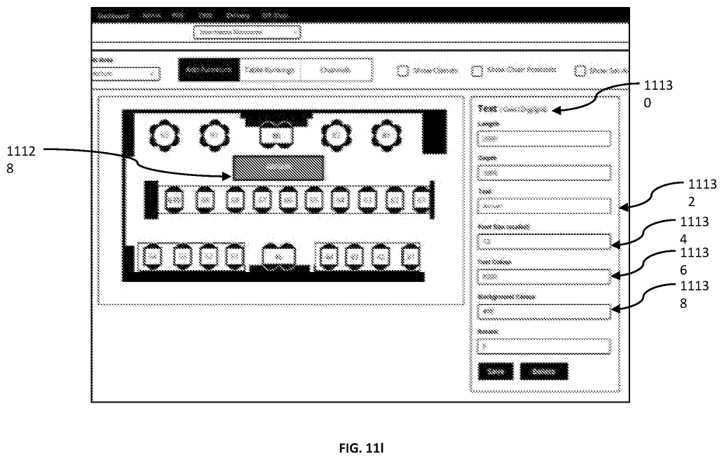

Referring to FIG. 11a, there is shown a floor plan setup process flow. The floor setup process flow advantageously allows a user with little or no planning experience to intuitively setup a floor plan and assign attributes to each item of furniture and various floor plan tools and features, to assign specific attributes to each specific sub-areas and/or section of the restaurant area/space, and to create an “initial” or “base” floor plan to which sets of detailed booking allocation constraints can be applied to. While the allocation algorithm is capable of allocating all furniture items independently of any manual intervention, utilising the constraints provided by the operator, it is generally necessary, for practical reasons, to present restaurant staff with a base or initial floor plan, thereby allowing staff to orient themselves.

Importantly, the floor plan setup interface also serves a second purpose, namely the provision of an interface that allows a user with little or no planning or programming experience to provide all relevant venue constraints in a manner that is visual in nature and guides the user through the necessary steps to build a comprehensive set of constraints. In other words, all prior art systems (whether related to the creation of a floor plan for a restaurant or a floor plan for any other purpose) require some knowledge of how to enter constraints, how such constraints affect the system as a whole, etc. However, in the embodiment described herein, the operator does not require any knowledge of planning, how to create specialised constraint files in specialised formats, etc. The operator simply “builds” a restaurant floor plan through the use of simple drag and drop icons and through the input of simple information, and the system generates all necessary constraints. In other words, the embodiment of the invention described herein allows for intuitive creation of a set of constraints that are then used by the allocation algorithm and other algorithms within the restaurant management and booking system to operate all aspects of the restaurant. There is no need for specialised programmer or planner input. As a corollary, where a fundamental change is required to the floor plan (e.g. all 600 mm wide tables are replaced with 700 mm wide tables), the operator simply needs to make the single change in the system, and all associated constraints which are affected by the single change are also immediately updated, with the floor plan and constraints being updated automatically. As such, decisions made regarding a change in the physical setup of the restaurant can be immediately reflected in the system, with no need for specialised reprogramming or “tweaking” of any kind.

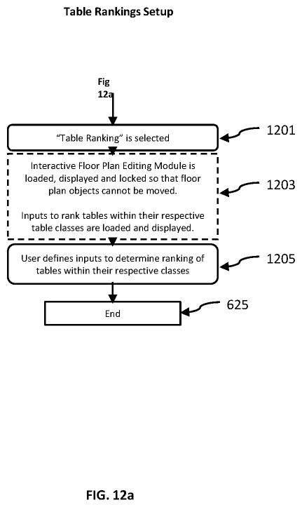

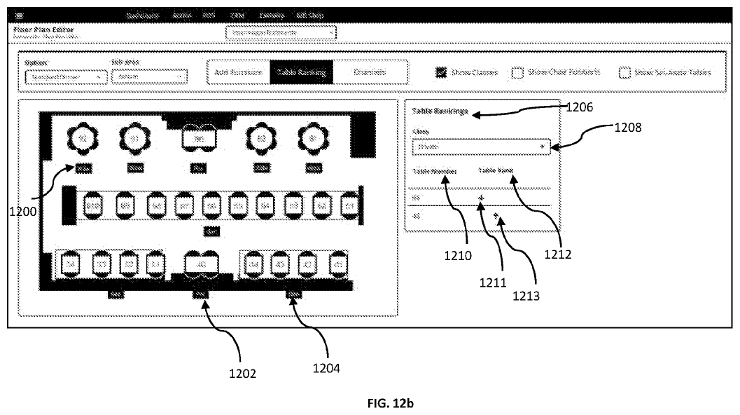

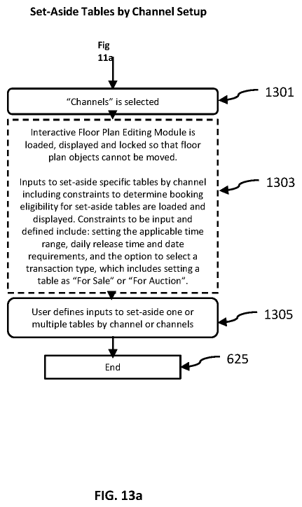

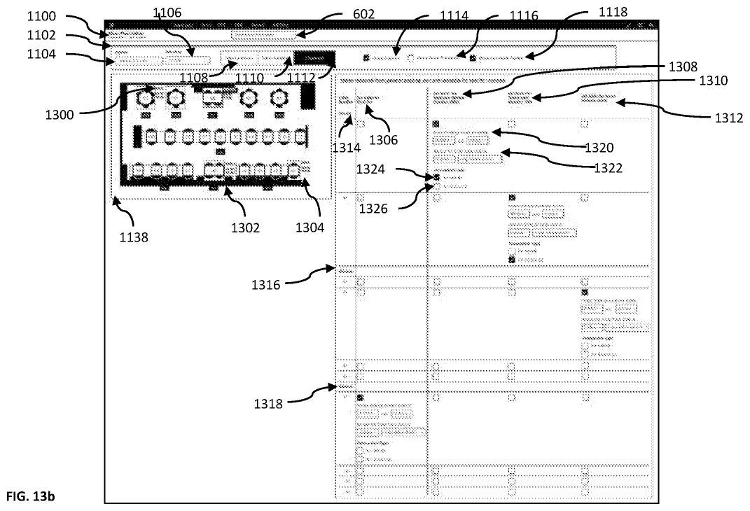

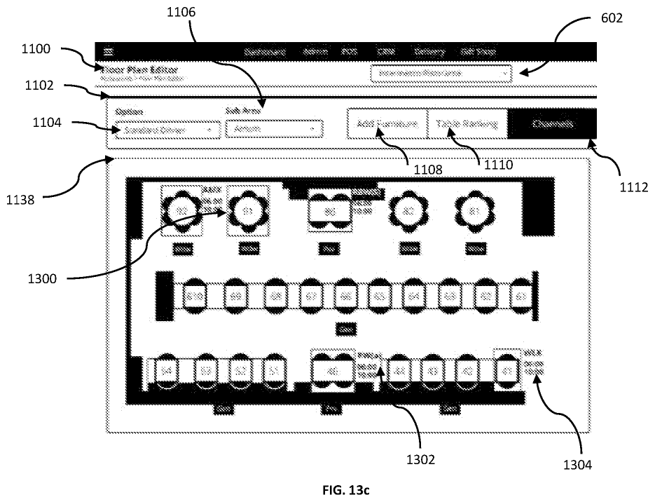

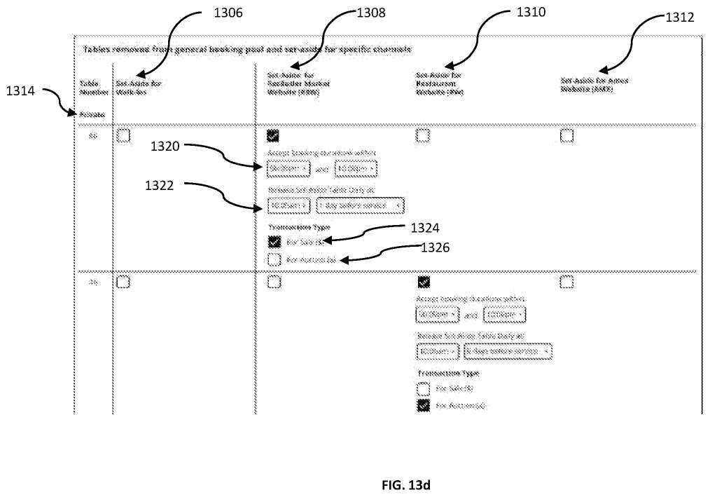

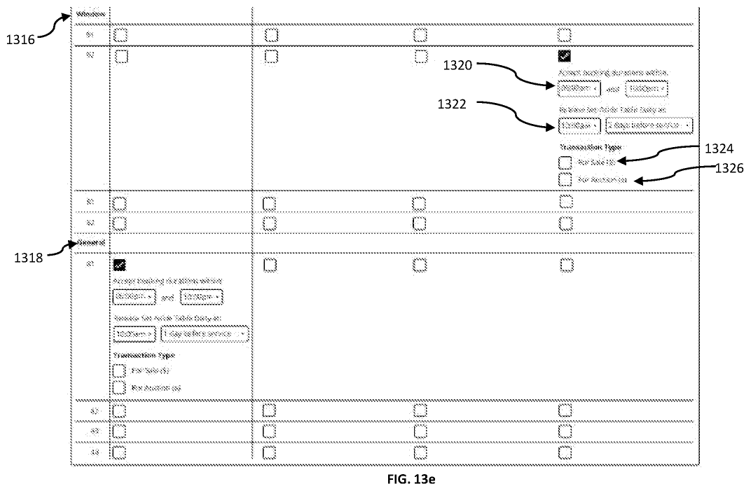

Returning to FIG. 11a, at step 601 the restaurant setup option is selected at step 601. If the operator is creating or editing a floor plan, the floor plan option is selected at 1101. The floor plan option is subsequently created and selected at step 1103, after which at step 1105, a sub-area is selected by the operator. Depending on whether the operator wishes to build a floor plan or update some other aspect of the constraints relevant to the floor plan, the process may continue to step 1107, or may continue to the process flows described in FIG. 12a or 13a (which are described herein below).

If the process continues to step 1107, the add furniture option is selected. This causes an interactive floor plan editing module to be displayed at step 1109. At step 1111, the operator can add walls, sections, windows, doors, walkways tables, etc., as required to correctly describe the venue and all furniture, as will be described with reference to the screenshots of FIGS. 11b to 11l. Once the operator has entered all details to their satisfaction, the input information is saved and the floor plan and constraints are generated at step 1113. Thereafter, the process ends at step 625.

Referring to FIG. 11b there is shown a screenshot of setup screen which allows a user to set up a floor plan and associated constraints, as was described with reference to the process flow of FIG. 11a. At 1100, there is shown the title of the screen, namely “Floor Plan Editor” and a restaurant selector 602. There is also provided an option editing area 1102 including a floor plan option selector 1104, a sub-area selector 1106, and three tabs 1108, 1110 and 1112 for adding furniture, ranking tables and associating with channels respectively. There is also shown a number of check boxes for displaying information on floor plan depiction 1138, including a show classes tick box 1114, a show chair position tick box 1116 and a show set-aside tables tick box 1118. Along the left hand side of the interface, there is shown a graphical representation of all furniture and other objects (including walls) that can be used to create the floor plan depiction 1138. The manner in which these items are generated are described in more detail below. In the screenshot of FIG. 11b, there is shown, by way of example, some of the items that may be generated an utilised, including a two person table 1120, a three person table 1122, a round table 1124, a rectangular four person table 1126, in addition to various “tools” that are not defined pieces of furniture, but rather are integral parts of the venue, such as sections 1128, walls 1130, windows 1132, doors 1133 and walkways 1134. Such tools are not objects per se, but are used to provide more information regarding the layout of the floor plan and are translated into constraints. For example, to take a simple example, by defining a walkway between two sections, the allocation algorithm utilises this information to know that a table cannot be placed in a walkway. Similarly, where a door is place, the allocation algorithm knows that a table cannot be placed in front of a walkway. In this way, such artefacts of the space or venue can be factored into the algorithms decision to rearrange tables or other objects within the space.

Referring to FIG. 11c, there is shown an example of how furniture items may be setup by the operator. Screen 1138 is a representative floor plan, where a user may drag and drop individual tables such as round tables 1140 and 1142, or may add tables to a section such as section 1144. In FIG. 11c, there is also shown an input screen 1146 for defining the characteristics of a round table 1142. Firstly, there is provided a rotate input box, which allows the table to be rotated relative to the space, which can be important in situations where tables must be rotated to fit into the space. Secondly, at 1150, each table can be allocated a number. Thirdly, each table is allocated a class at 1152, then fourthly, for the information of the operator, information is provided about the normal number of people that a table can sit at 1154, and the physical maximum a table can sit at 1156. This information is provided to assist the operator in deciding whether the table is the correct table to place in the selected space. The operator can also select whether the algorithm is allowed to use the physical maximum when allocating a booking by selecting option 1158. Finally, the user can save the floor plan using button 636 or delete the floor plan utilising button 1160.

Referring now to FIG. 11d, where like numerals refer to the same features as described with reference to FIG. 11c, there is also shown another example of how a rectangle table may be added to a section 1162. The operator has already placed one table 636 in section 1162, and newly generated table 1160 has not yet been placed in a section and is therefore labelled with a ‘?’ to indicate that the table is not yet placed in a defined location, nor has had any inputs including table number saved. Once the table 1160 of FIG. 11d is placed in a defined location, as shown in FIG. 11e, the newly located table (now labelled 1163) is provided with a table number (42) and a new dialogue box 1119 appears on the right hand of the interface, where the operator can select whether the table should be connectable to other tables. That is, whether the table can be joined with other tables to create a larger table. If the operator checks the “Do not connect” option, the algorithm will not use the table to connect to other tables, should there be a requirement due to a larger booking. The operator may make this decision for any reason whatsoever, such as requiring the maintenance of a specific ambiance in a specific area. By utilising options such as “Do Not Connect”, the operator is automatically generating a number of constraints to be utilised by the algorithm, but doing so in a manner and through an interface that is understandable to the operator and does not require any underlying knowledge of how the system operates. In other words, the embodiment of the invention does away with the need, by the operator, to have any understanding of how the system operates or how decisions are made by the algorithm. The operator simply needs to provide their requirements, from a restaurant operator point of view.

Referring to FIG. 11f there is shown a screenshot of an interface that allows an operator to apply constraints to a defined section, such as section 1172. The selection of a section 1172 causes a new dialogue box 1174 to appear on the right hand side of the interface. The dialogue box has two tabs, namely a settings tab 1176 and a reserve tab 1178. The settings tab 1176 provides a number of settings that influence constraints, including ascribing a section number 1180, defining a length 1182 and depth 1184 of the section, defining a minimum distance between tables 1186, defining an option to utilise the minimum number of combined tables possible for bookings over a certain number of people 1188, the ability to allow bookings to “spill over” into other sections 1190, the ability to allow the algorithm to use fixed tables from other sections 1192, and the attribution of a class to the section 1194. There is also provided three options for how the algorithm can generally place tables and chairs (i.e. the relative orientation of the tables and chairs). There is an option for the horizontal orientation of tables, the ability to add tables from left to right (or vice versa) and the ability to add chairs from top to bottom. Each of these options provide constraints which in turn affect the manner in which the algorithm dynamically allocates tables to the space.

Referring to FIG. 11g, if the reserve tab 1178 (as shown in FIG. 11f) is selected, the furniture allowed, from a reserve (e.g. a reserve in a storeroom or from an outside source) can be selected, such that the algorithm has knowledge of whether this is stock, and the ability, to place extra tables in the section. For example, in FIG. 11g, there are shown four types of tables 11102, 11104, 11106 and 11108 that can be selected or deselected, which causes the algorithm either to add, if necessary, or not add, if necessary, each table type. There is also provided an option to add “table tops” 11110 (i.e. where a table remains in situ, but a larger table top is added to provide for more chairs and increase the capacity of the table, without needing to remove the original table).

Referring to FIG. 11h, there is shown a screenshot of a screen for adding a wall to a floor plan. At 11112 there is shown a wall being drag and dropped into a location on the floorplan, which in turn causes a wall dialogue box 11114 to be displayed, so that the operator can provide specific dimensions for the walls.

Referring to FIG. 11i there is shown a screenshot of a screen for adding a window to a floor plan. At 11116 there is shown a window being drag and dropped into a location on the floor plan, which in turn causes a window dialogue box 11118 to be displayed, so that the operator can provide specific dimensions for the window.

Referring to FIG. 11j there is shown a screenshot of a screen for adding a door to a floor plan. At 11120 there is shown a door being drag and dropped into a location on the floor plan, which in turn causes a door dialogue box 11122 to be displayed, so that the operator can provide specific dimensions for the door.

Referring to FIG. 11k there is shown a screenshot of a screen for adding a walkway to a floor plan. At 11124 there is shown a walkway being drag and dropped into a location on the floorplan, which in turn causes a walkway dialogue box 11126 to be displayed, so that the operator can provide specific dimensions for the walkway.

Referring to FIG. 11l there is shown a screenshot of a screen for adding a text to a floor plan. The text does not affect the floor plan per se, but provides information to end users, where there is a need to label a section. At 11130 there is shown a dialogue box, where the operator can provide specific text 11132, adjust the font size 11134, adjust the text colour 11136 and adjust the background colour 11138.

Referring to FIG. 12a there is shown a table rankings process flow for the setting up of table rankings within table classes. At step 1201, the table rankings option is selected in the setup interface. This causes, at step 1203, the execution of an interactive floor plan editing module which provides an intuitive user interface for use by an operator of the restaurant. In particular, various input options are provided (as will be described in more detail with regard to FIG. 12b). At step 1205, the operator inputs various inputs to determine the ranking of tables within their respective classes. At step 625, the process ends.

Referring to FIG. 12b, there is shown a screenshot of an input screen for entering table rankings. The process flow of FIG. 12a is mediated via the input screen of FIG. 12b. As can be seen, at 1200, 1202 and 1204 there are shown labels representing various classes. For example, label 1200 indicates that table 92 is a window table, label 1202 indicates that table 46 is a private table and label 1204 indicates that the section that is shown having tables 41, 42, 43 and 44 is a section that is a “general” class. Each class comprises one or more tables, and where a class comprises one or more tables, the rankings of tables within the class can be modified by utilising table rankings box 1206. A class is selected at 1208, and then table numbers 1210 and rankings 1212 are displayed on the interface, where a user can change the relative rankings of the class by utilising the arrows 1211 and 1213

Referring to FIG. 13a, there is shown a flowchart illustrating the process by which set-aside tables are selected for each channel, where set-aside tables are tables that are made exclusively available for booking via the selected channels only within configurable time and transaction constraints. At step 1301, channel setup is selected. This loads, at step 1303, an interactive floor plan editing module, where at step 1305, the user defines inputs to set aside one or more tables by channel or channels, after which the process ends at step 625.

Referring to FIG. 13b, the process of FIG. 13a is illustrated with reference to screenshots of various input screens. FIG. 13b illustrates an interactive floor plan editing screen generated by the interactive floor plan editing module. The screen includes a title 1100, a restaurant selector 602, an area (1102) containing a grouping of selectors including a floor plan option selector 1104 and a sub-area selector 1106, setup interface selectors shown by three tabs 1108, 1110 and 1112 for adding furniture, ranking tables and setting aside tables by channel respectively. There is also shown a number of check boxes for displaying information on floor plan depiction 1138, including a show classes tick box 1114, a show chair position tick box 1116 and a show set-aside tables tick box 1118. There is also shown an indicator 1300 which illustrates the connection between a table and a specific channel (e.g. “AMX” next to table 92 indicates that table 92 is reserved for the American Express Website channel, “RW” next to table 46 indicates that table 46 is reserved for the Restaurant Website channel and “WLK” next to table 41 indicates that table 41 is reserved for “walk-in” customers (which in turn may be associated with bookings made through the kiosk).

The association of tables with channels is selectable via the interface shown at the right hand side of FIG. 13b, where there is shown a column 1314 of table numbers, a column 1306 including a tick box for every table, such that when a tick box in the same row as a table number is selected, the table becomes reserved for the relevant channel, such as in column 1308 which is the ResButler market website channel, where the tick box is checked, a number of further fields appear, including a time period setting field 1320 which allows the operator to accept bookings within a predetermined time window (where the time window is a condition set by a restaurant that allows any booking where the duration overlaps with this time window, and is booked via the specified booking widget channel, to have access to a pool of tables including the specified set-aside table during the allocation process), a release time 1322 (a time at which the table is no longer held and can now be booked through any channel), and tick boxes 1324 and 1326, which select whether the table booking incurs an extra charge, either via a flat sale price, or via an auction process. It can also be seen that, for ease of use by the operator, tables can be separated into categories according to class, such as can be seen at 1314, 1316 and 1318.

Referring to FIGS. 13c, 13d and 13e, there are shown close up views of portions of the screenshot of FIG. 13a, where the numerals of FIG. 13a refer to like features in FIGS. 13c, 13d and 13e.

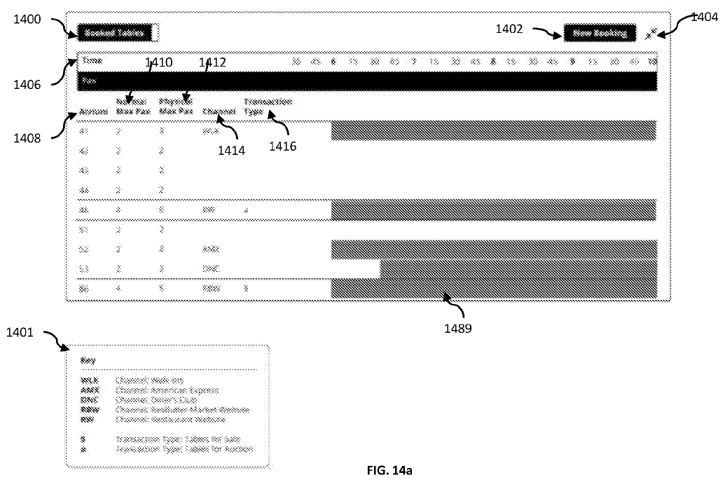

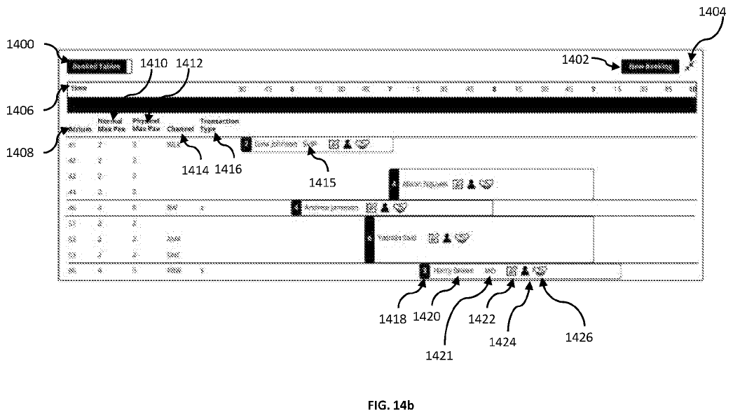

Referring to FIG. 14a, there is shown a screenshot of a Gantt chart in accordance with an embodiment of the present invention. The Gantt chart differs from prior art Gantt charts in that there is provided detailed information concerning bookings for a particular service period. There is firstly provided a “booked tables” toggle switch, which can be switched to show booked tables (as per FIG. 14a) or non-booked table (not shown). The operator can also manually add a booking if necessary by selecting the new booking button 1402, and may expand and contract the size of the chart by selecting arrow icon 1404. The Gantt chart also displays a timeline 1406, and tables by sub-area (1408), wherein for each table, the normal maximum capacity 1410 is shown, the physical maximum capacity is shown 1412, the channel which received the booking 1414 is shown, and the transaction type 1416 is shown. For ease of use, a key 1401 is also provided for the operator so that the operator can understand the relevant acronyms displayed on the screen. The provision of a Gantt chart provides an alternative view on table bookings, which may provide a more intuitive manner of viewing bookings for some operators of restaurants. The Gantt chart also provides a manner by which manual bookings may be added in an intuitive way.

Referring to FIG. 14b, there is shown an alternate Gantt chart. To the extent that the numerals in FIG. 14b mirror the numerals in FIG. 14a, the features are alike and refer to the same features. However, in FIG. 14b, there is shown a Gantt chart with some additional features. Each line representing a booking includes the number of people for the booking 1418, the name of the booking 1420, and three icons 1422, 1424 and 1426. Icon 1422 allows an operator to manually open the booking details in a popup window, so that the details may be edited. There is also shown summary information regarding each of the customers, such as MO (showing a booking that has a manual override allocation applied) 1421 and SVIP 1415. Icon 1424 opens the CRM entry for the person who has made the booking, and icon 1426 opens the run-sheet for the booking. In this manner, the operator is only “one click” away from any information the operator may be required to access with regard to the specific booking, whether it be the requirement to edit the booking, the requirement to review the customer's history, or the requirement to review a run sheet before or during service.

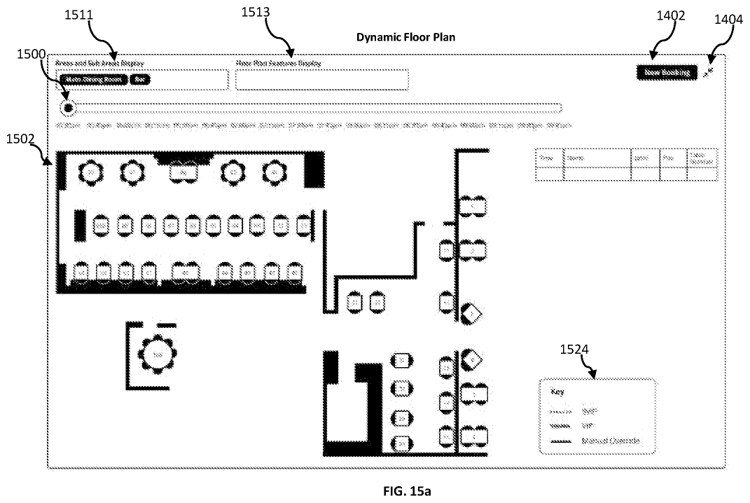

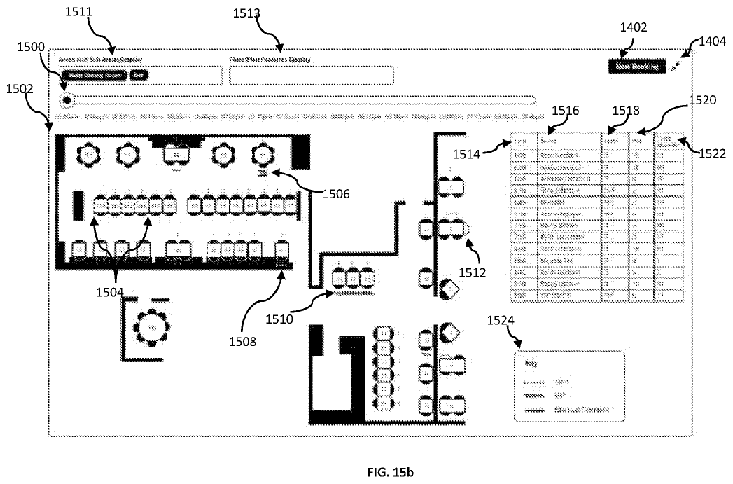

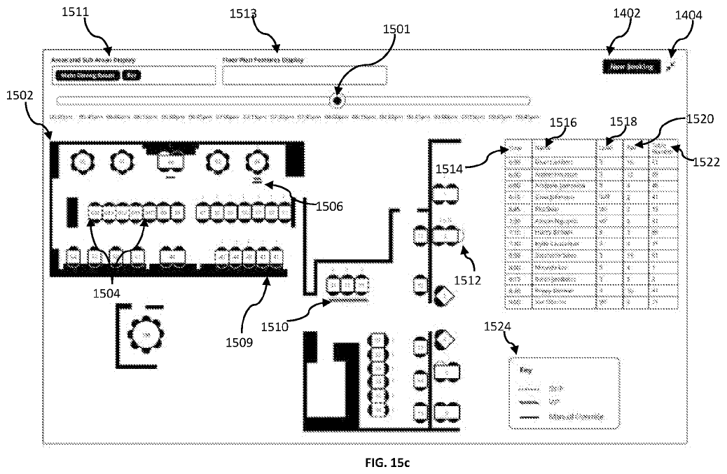

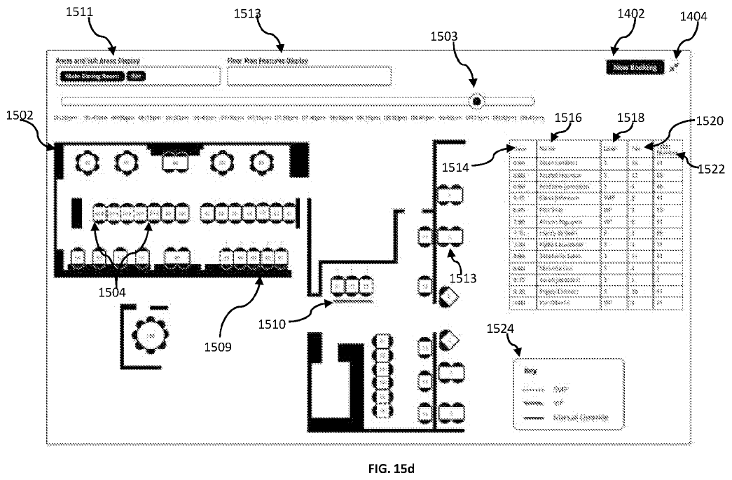

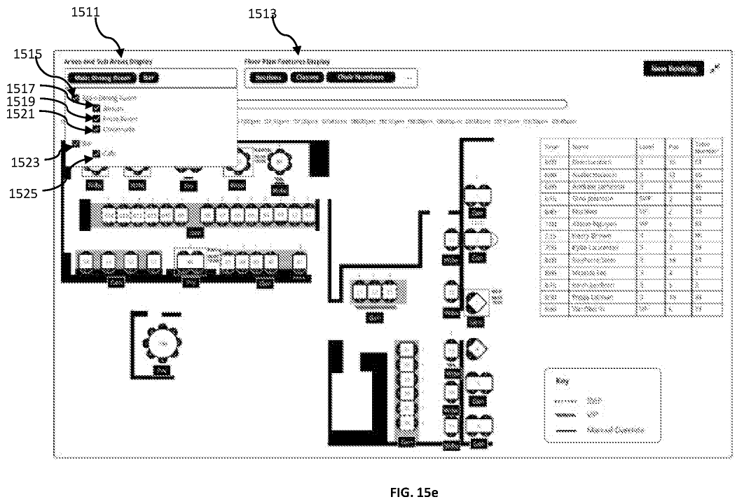

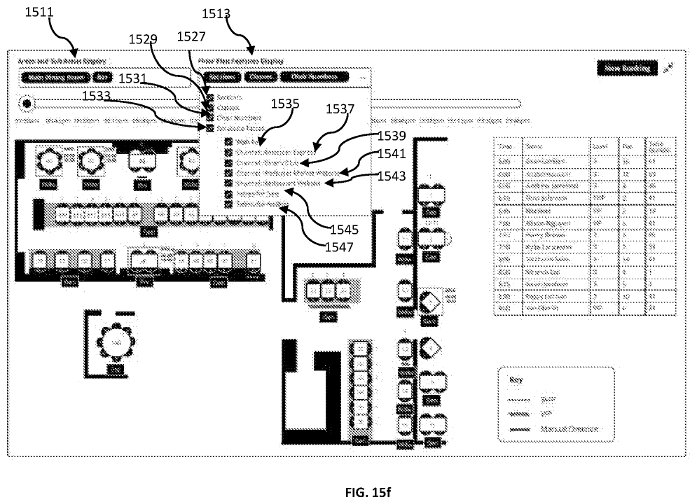

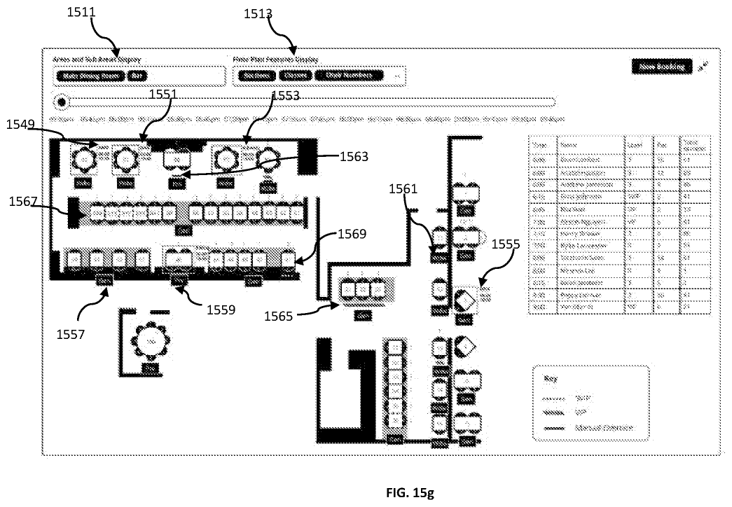

Referring to FIGS. 15a, 15b, 15c and 15d, there are shown four successive screen shots of a dynamic floor plan that changes over time, depending on bookings and the live status of the restaurant. Along the top there is shown a timeline indicator 1500, which in FIG. 15a is shown at a start time, namely 5.30 pm. As can be seen in subsequent FIGS. 15b and 15c, the timeline indicator 1500 of FIG. 15a moves to position 1501 in FIG. 15b and position 1503 in FIG. 15c. Corresponding changes can also be seen in the floor plan, as different bookings arrive or depart, and the restaurant tables and seating are rearranged (or rearrangeable) throughout the entire service period. For example, in floor plan 1502 of FIG. 13a, there is shown a series of connected tables to form a table of 12 at 1504, the fact that a VIP is seated at table 81 and that this booking was due to a manual override (1506), the seating of a VIP at tables 21, 22 and 23, the seating of a SVIP at table 41 (1508), the addition of a chair at table 2 (1512), and at FIG. 13b, there is shown the joining of table 41 to tables 42-45 (1509), and at FIG. 13c, the removal of the additional chair at table 2 (1513).

Moreover, for each of FIGS. 15a-15d, there is provided a basic booking list, including time 1514, name 1516, level 1518, number of people 1520 and table number 1522, plus a key 1524, so that operators have the maximum amount of information available to them in a condensed format, to allow the operator to easily manage and understand the restaurant. There is also provided a new booking button 1402 and a screen enlarge and contract icon 1404.

At FIGS. 15e and 15f, there is shown a screenshot of the dynamic interface, wherein certain indicators and summary information can be included or excluded from the display, As can be seen in pull down menus 1511 and 1513, there are shown options for showing or not showing areas 1515 and 1523, and sub-areas 1517, 1519, 1521, and 1525. Correspondingly in FIG. 15f, there is provided a pull down menu for showing or not showing aspects of tables, including showing sections 1527, classes 1529, chair numbers 1531, set-aside tables 1533, walk in bookings 1535, different channel bookings 1537, 1539, 1541 and 1543, tables for sale 1545 and tables for auction 1547.

At FIG. 15g, there is shown a screenshot with various attribute tags displayed, such as tables set-aside by channel 1549, 1551 and 1553, tables set-aside for walk-ins 1555, classes 1557, 1559 and 1561, reserve furniture 1567 and customer types 1563.

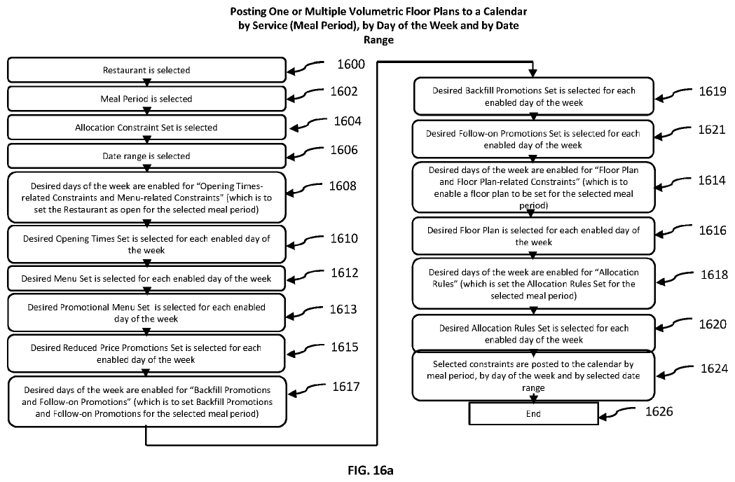

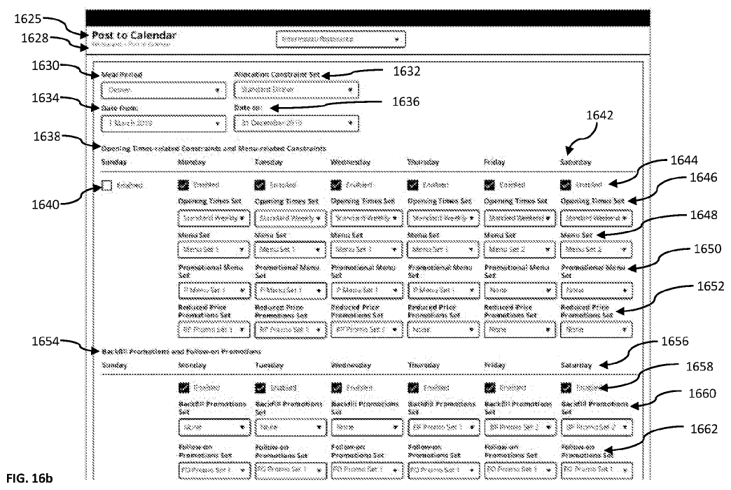

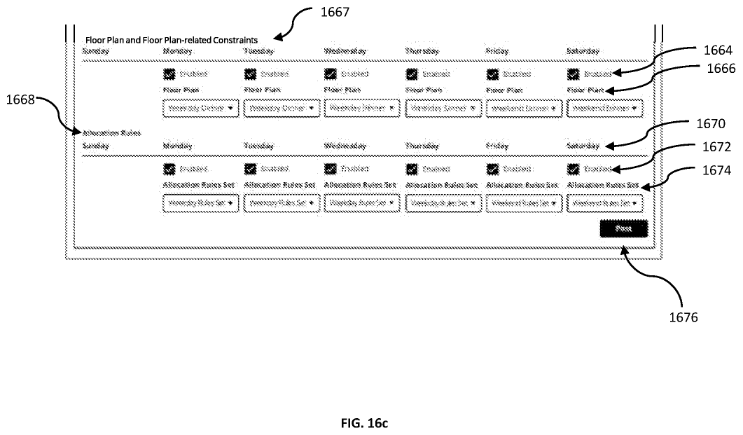

Referring to FIG. 16a there is shown a flowchart depicting the posting process for one or multiple volumetric floor plans to a calendar by one of service, day of the week and date range, allowing the operator to post customisable combinations of constraint sets by service, day of the week and date range. At step 615 a restaurant is selected. At step 1601 a meal period is selected, followed by the selection of an allocation constraint set at step 1603. Subsequently, a date range is selected at step 1605.

Next, at step 1607, the desired days of the week are enabled, and at step 1609, the desired opening times are set. At step 1611, the desired menu is set and then the desired days of the week are enabled for a floor plan at step 1613. The desired floor plan is selected for each enabled day of the week at step 1615, followed by the desired days of the week being enabled for the allocation rules at step 1619. Lastly, the selected constraints are posted to the calendar by meal period, day of the week and selected date range, before the process ends at step 625.

Referring to FIG. 16b, there is shown a screenshot of an interface utilised by an operator to effect the method steps described with reference to FIG. 16a. In FIG. 16b, at 1600 there is shown a title for the screen, and there is provided a restaurant selector 602. There is also provided a number of selectors including a meal period selector 1602, an allocation constraint set selector 1604, and a date range selector as indicated at 1606 and 1608. There are also provided three sets of selectable constraints, namely an opening-time and menu related set of constraints 1610, a floor plan set of constraints 1620 and an allocation rules set 1621. The opening-time and menu constraint set allows the selection of an opening time set 1612 and a menu set 1614 for each defined service/day period. Similarly, the floor plan constraints 1620 allows the selection of a floor plan set 1618 for each defined service/day period, and the allocation rules set 1621 allows for the selection of an allocation rules set 1622 for each defined service/day period. Once all relevant sets have been selected, the operator posts the selected sets to the calendar by using the post button 1626. In this manner, each service/day period can utilise a customised set of constraints.

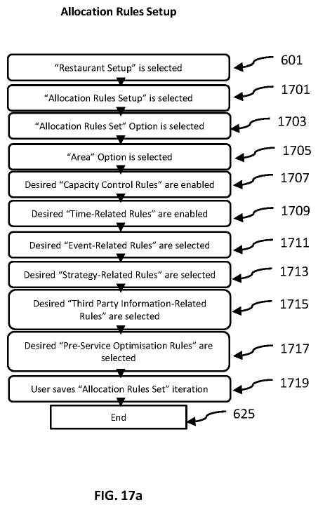

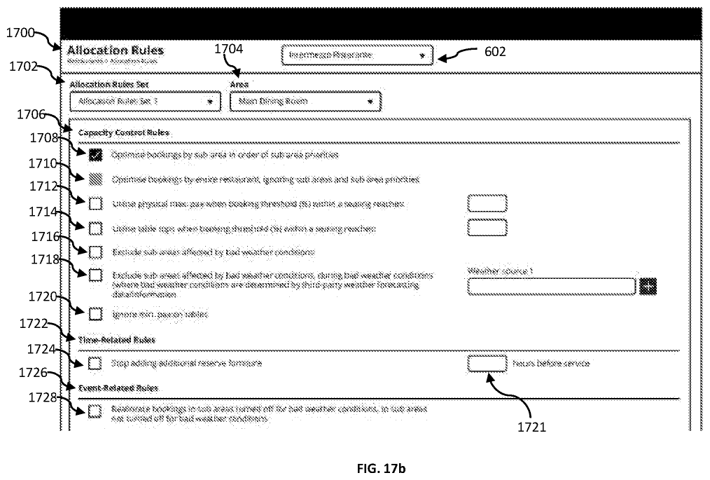

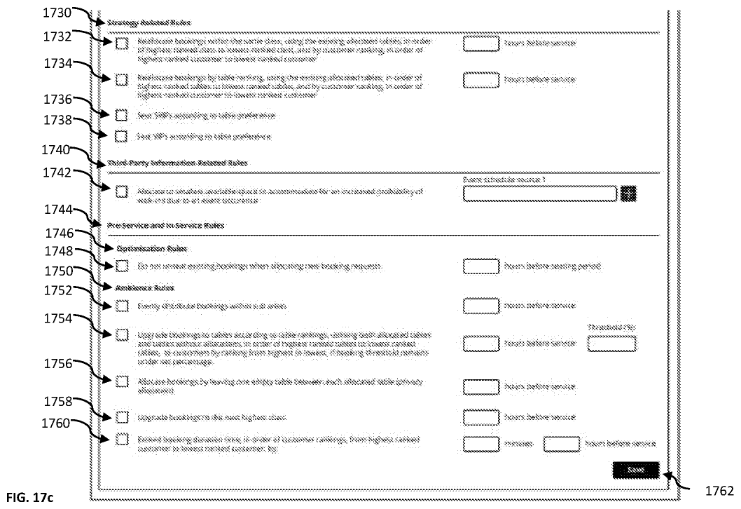

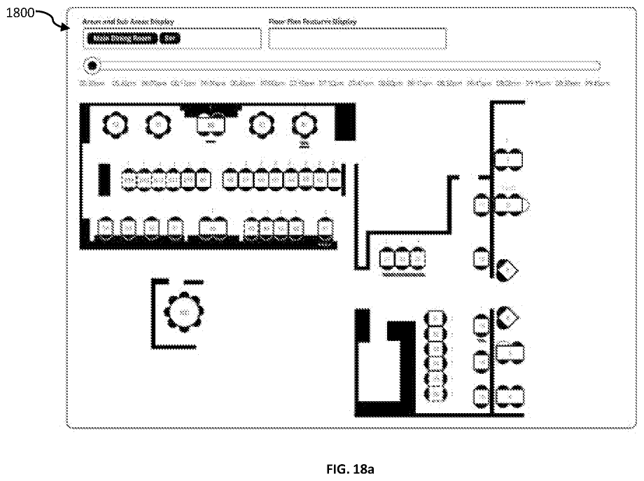

Referring to FIG. 17a there is shown a process flow diagram for an allocation rules setup which allows the operator to create sets of enabled and disabled specific allocation rules which can be posted to the calendar by service, by day of the week and by date range. At step 601, the restaurant setup option is selected. Subsequently, at step 1701 the allocation rules setup is selected, and an allocation rules set option is selected at step 1703. The area option is selected at step 170, and a desired capacity control rules are enabled at step 1707, then a desired time related rules is enabled at step 1709, followed by an event related rules being selected at step 1711. At step 1713, a strategy related rules is selected, followed by a third party information related rules being selected at step 1715. A Pre-service optimisation rules is selected at step 1717 and at step 1719 the user saves the allocation rules set before the process ends at step 625.

Referring to FIG. 17b and FIG. 17c, there are shown screenshots of a screen which an operator utilises to input information in accordance with the process flow of FIG. 17a. At 1700, there is shown the Allocation rules title and at 602, an operator can select a restaurant. At 1702 the operator selects an allocation rules set and at 1704 an area is selected. There are provided certain categories, including a capacity control rules category 1706, which includes the ability to set a series of constraints related to capacity control, including an optimise bookings by sub-area option 1708, an optimise bookings by entire restaurant 1710, a utilise physical max pax when a booking threshold is achieved 1712, a utilise table tops when a booking threshold is achieved 1714, an exclude sub areas affected by weather option 1716, an exclude sub areas affected by bad weather, during bad weather option 1718 and an ignore minimum pax on tables option 1720. There is also a time related rules category 1722 which includes a stop adding additional furniture option 1724 and a further constraint 1721 which activates option 1724 fora defined number of hours before service. There is also provided an event-related rules section 1726 including a relocate bookings for bad weather option 1728. Referring now to FIG. 17c, there is shown a strategy-based rules section 1730 including a reallocate bookings by class rankings option 1732, a reallocate bookings by table ranking 1734, a seat SVIPs by table preference 1736 and a seat VIPs by table preference 1738. There is also provided a third-party information related rules section 1740 including an apply rules for event occurrence option 1742. Lastly, there is provided a pre-service and in-service rules section 1744 including optimisation rules 1746 and ambience rules 1750. Optimisation rules include a do not unseat existing bookings when allocating new booking requests option 1748. Ambience rules include an evenly distribute bookings within sub areas option 1752, an upgrade bookings to tables according to table rankings option 1754, an allocate bookings by leaving one empty table between each allocated table option 1756, an upgrade bookings to the next highest class option 1758 and an extend booking duration time in order of customer rankings option 1760. The operator may at any time save the selected options by utilising save button 636.

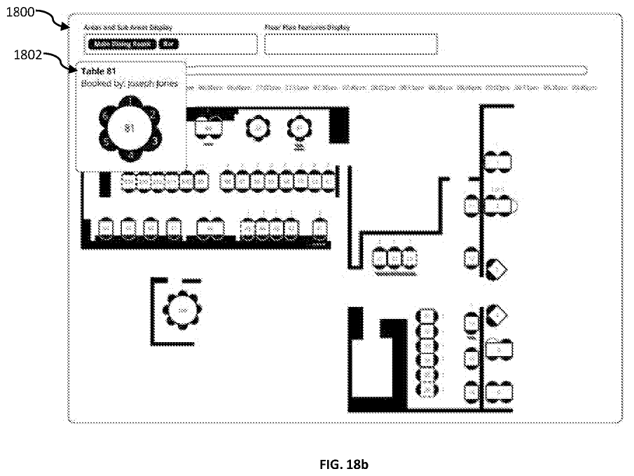

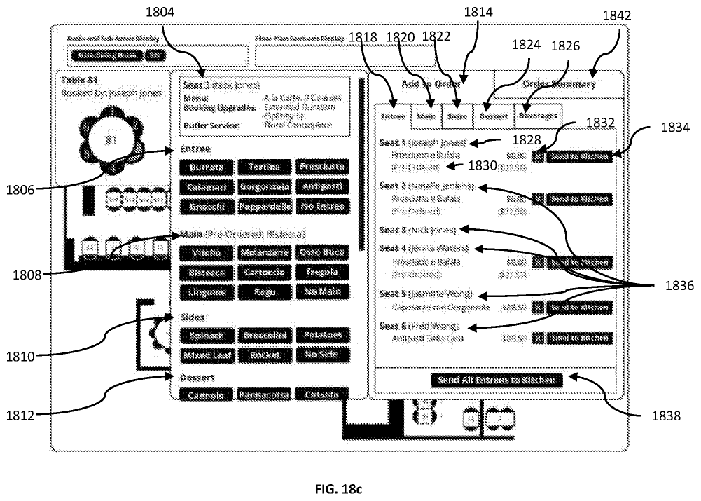

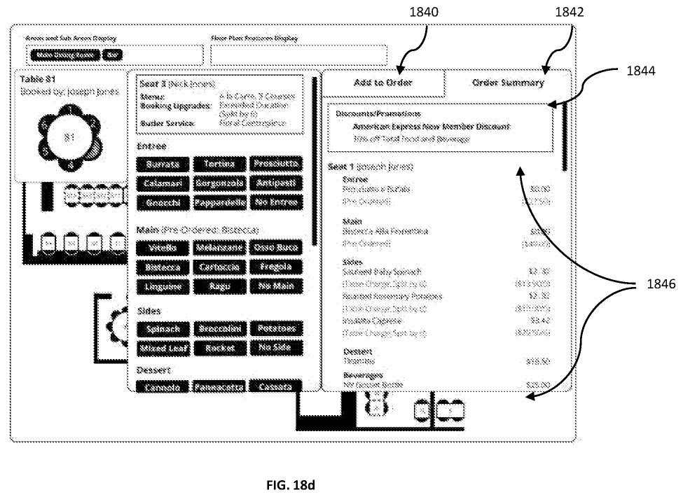

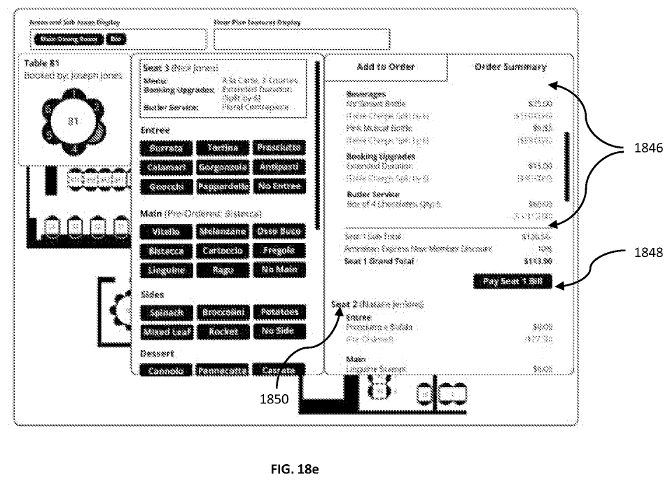

Referring now generally to FIGS. 18a-e, there is shown a screenshot of a dynamic floorplan 1800, which can be utilised by the operator in an interactive menu ordering process. An operator may select a specific table, as shown in FIG. 18b, wherein the selected table will be shown in a popup screen 1802. Upon selecting a seat on the table, a full menu 1804 is shown, including different courses 1806, 1808, 1810 and 1812. The menu is specific to the type of booking. There is also provided a facility to add to the order, by using tabs 1818, 1820, 1822, 1824 and 1826. As can be seen, each seat is shown 1828 (and 1836), and an operator can cancel an order 1832 or send to kitchen 1834. Also, the operator can send all orders for a course to the kitchen 1838. In this manner, the operator can efficiently change orders, send orders to the kitchen, or cancel orders easily.

Referring to FIG. 18d-e, by clicking the order summary tab 1842, the operator can view a summary of payment and promotion details 1844 and a summary of the entire meal 1846, including costs. The operator can also select an option to pay the bill for the customer at 1848. Summary information for other customers on the table can also be shown, as seen at 1850.

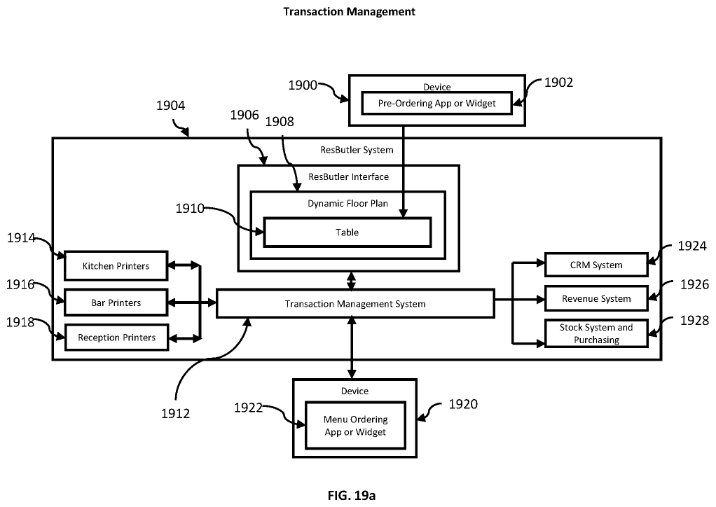

Referring now to FIG. 19a, there is shown a high level schematic diagram of the components (hardware and software) that interface with the ResButler system 1904 to manage a transaction. In the context of FIG. 19a, a “transaction” is not merely the aspect of payment for goods and services, but is intended to encompass the entire transaction from when a customer first interfaces with the app or widget, through to the point at which the customer leaves the restaurant. There is shown at 1912 a transaction management system which is arranged to interface with a device 1920 which includes a menu ordering app or widget 1922. The ResButler System 1904, in turn, interchanges information with devices such as device 1900 which also includes an instance of pre-ordering app or widget 1902. The transaction management system 1912 interacts with the ResButler interface 1906 which includes a dynamic floor plan 1908. The dynamic floor plan includes tables (such as table 1910) which have specific attributes. The attributes associated with the tables such as table 1910 are used by transaction management system 1912 to interface with various hardware devices, such as kitchen printers 1914, bar printers 1916 and reception printers 1918. The transaction management system 1912 also interfaces with the CRM system 1924, the revenue system 1926 and the stock system 1928. In this manner, the transaction management system 1912 acts as a hub, relaying information between disparate hardware devices and software modules, to effectively automate all aspects of the management of the restaurant.

Unlike prior art solutions, the embodiment described herein, while being comprised of different modules, works in cooperation with all computerised aspects of the operation of a restaurant. Rather than manually entering data into different systems or attempting to link (generally in a crude manner) various disparate systems, the embodiment described herein utilises a central hub (the transaction management system 1912) to ensure the entire transaction is managed correctly.

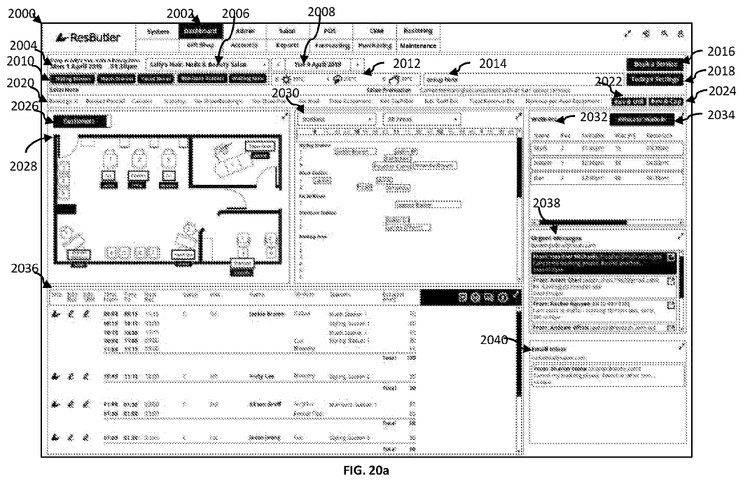

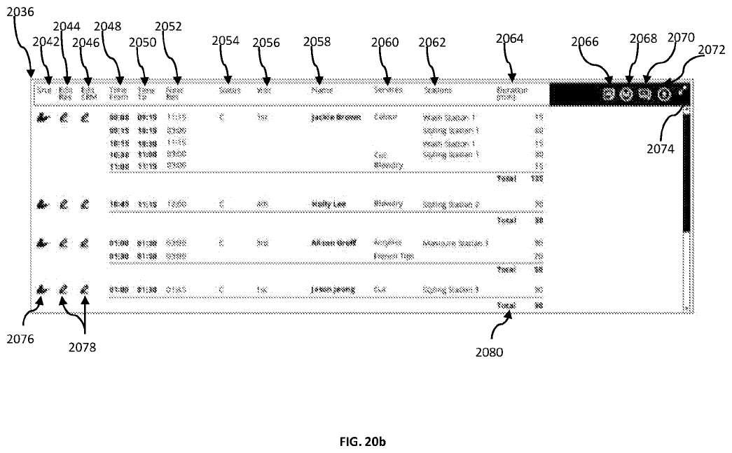

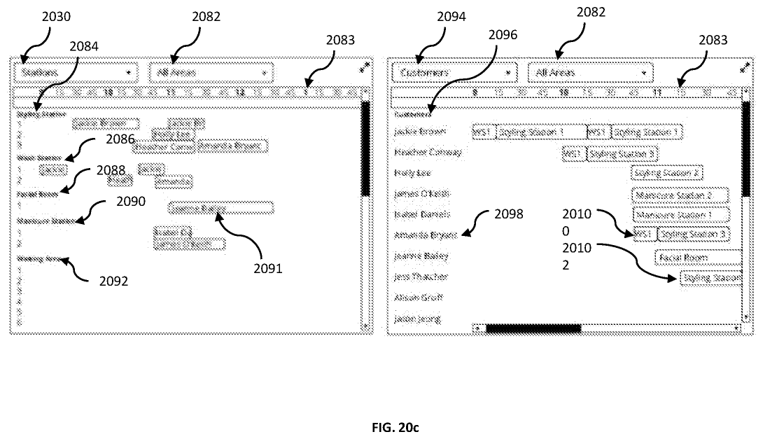

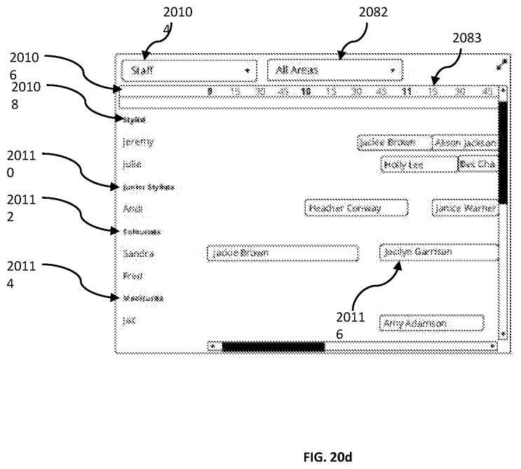

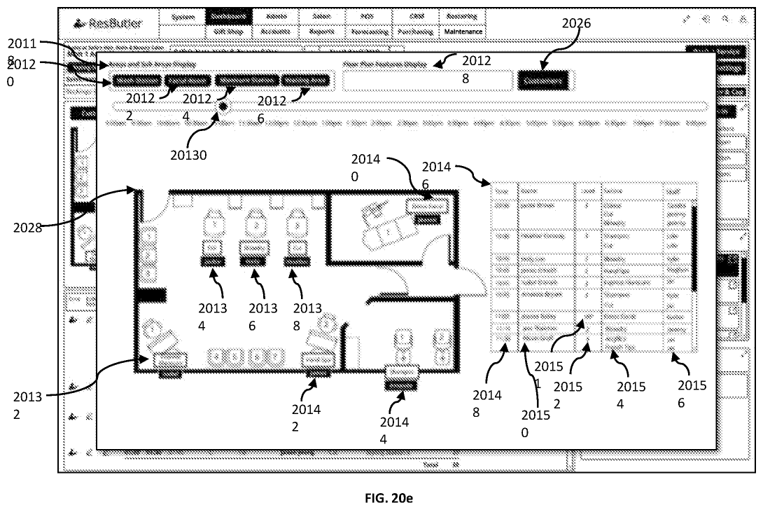

Referring to FIG. 20a, there is shown a screenshot 2000 of the ResButler dashboard in accordance with an embodiment of the invention. To access the dashboard an operator can select button 2002 which provides an interface which summarises most aspects of the operation of the business, which in this example is a salon. The interface displays the current date 2004 and provides a pull-down menu to select the space (venue) 2006 to be viewed by the operator. There is also provided a pop up calendar to change date 2008 and an option to display or hide the display of items (tools/equipment/tables/chairs) by using buttons 2010. There is further provided a summary of weather conditions 2012 and a group note (which may include information relevant to all bookings) 2014. If operating via a Point of Sale device, the operator may book a service directly from the dashboard using button 2016 and may also review and/or vary the day's settings by clicking button 2018 or display a summary of all bookings for the day at 2020, which may be varied by using button 2022 to change summary shown to revenue and utilisation statistics, or button 2024 to change summary to revenue and capacity for day shown. The operator may display the allocation of customers to equipment/tables by selecting slide switch 2026 which is displayed on floor plan 2028. The user may then select a Gantt chart summary by using pull down menu 2030 and further select which areas to display on the Gantt chart by using pull down menu 2032 or may manually override the system to allocate a walk-in customer 2034. There is also provided a comprehensive run sheet 2036 and a section which displayed email messages in areas 2038 (urgent) and 2040 (all).

Referring to FIG. 20b, there is shown a screenshot of a portion (area) of a run sheet generated after application of a method in accordance with an embodiment of the invention. Run sheet 2036 (described in the context of the dashboard in FIG. 20a) includes a column that indicates the source of booking 2042, an edit reservation column 2044, an edit CRM column 2046, a start time column 2048, an end time column 2050, a next reservation after end of reservation column 2052, a status of reservation column 2054, a how many visits by customer column 2056, a name of customer column 2058, a service booked column 2060 and a stations utilised for booking 2062, including a column for the duration of use (broken down by station) 2064. Returning to the run sheet 2036, there is provided a ResButler icon to display the source of booking 2076 and a click to edit entry icon 2078, plus a value indicating the total time for service of a customer 2080.

Referring to FIG. 20c, there is shown a screenshot of Gantt charts generated after application of a method in accordance with an embodiment of the invention. The left hand side Gantt chart displays use of equipment by time 2030 and the operator can use pull down menu 2082 to display one or more areas. There is also provided a time line (time of day) 2083, a list of specific pieces of equipment 2084, 2086, 2088 and 2090 and the customer time at a specific piece of equipment 2091, as well as use of other resources, such as waiting areas 2092. In the second example displayed on the right hand of FIG. 20c, there is shown a Gantt chart where the display is display by customers 2094 including example customers 2096 and 2098 and bars 20100 and 20102 display the equipment used by a customer as a function of time.

Referring to FIG. 20d, there is shown a screenshot of a Gantt chart generated after application of a method in accordance with an embodiment of the invention. The Gantt chart displays stylist by time 20104 and the operator can use pull down menu 2082 to display one or more areas. There is also provided a time line (time of day) 2083, a list of specific stylists 20108, 20110, 20112 and 20114 and the customer time at a specific piece of equipment 20116.

Referring to FIG. 20e, there is shown a screenshot of the ResButler dashboard in accordance with an embodiment of the invention including a pop up displaying the floor plan over time. Using slide switch 2026 the operator can choose to view by customers assigned to equipment of by stylist assigned to equipment 2028. Screen 20118 further includes buttons 20120, 20122, 20124 and 20126 arranged to display or hide sections of the floor plan. At box 20128 there is shown a summary of a floor plan features display. Using sliding bar 20130 the operator can visualise how the allocation of customers and stylists to equipment varies over time. Equipment in the example provided in FIG. 20e includes stations 20132, 20134, 20136, 20138, 20140, 20142 and 20144. At area 20146 there is shown a table which displays a summary of all bookings for the service period including a start time 20148, a name 20150, a customer level 20151 and 20152, the service being provided to the customer 20154 and the staff performing the service 20156.

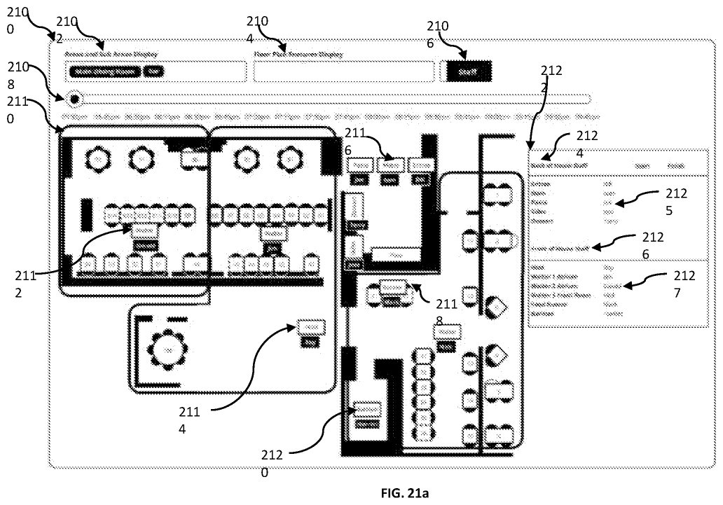

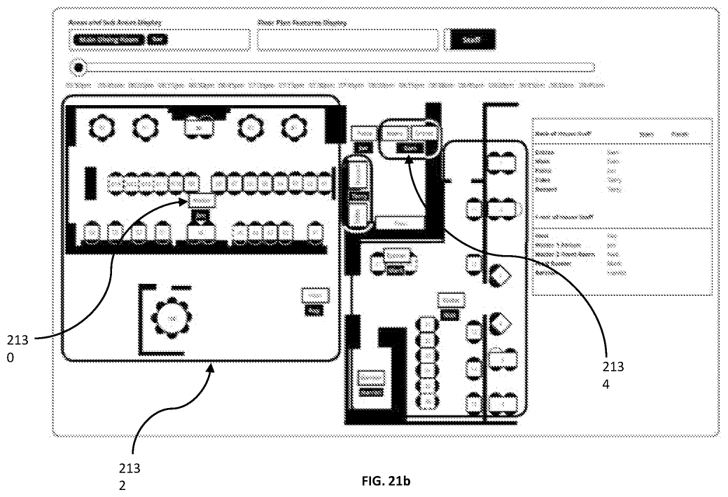

Referring to FIG. 21a, there is shown a screenshot 2100 of the ResButler floor plan for a restaurant with variability by time in accordance with an embodiment of the invention. In particular there is shown the allocation of staff to particular areas of the restaurant, which shows staff movement and rostering information on the floor plan by time. At 2102 there is shown a summary of the areas displayed and at 2104 there is shown a summary of the floor plan features displayed. The option to show staff may be turned on and off by utilising slide switch 2106. The changes over a service period or day may be viewed by the operator by utilising slider 2108. Area box 2110 indicates a bounded area allocated to a staff member, as shown by tags 2112, 2114, 2116, 2118 and 2120. A summary table is displayed at area 2122 which includes a staff list 2124 and 2126, which in turn display (as an example) staff members 2125 and 2127 and their allocation to particular tasks or jobs.

Referring to FIG. 21b, there is shown is shown a screenshot of the ResButler floor plan for a restaurant with variability by time in accordance with an embodiment of the invention. As can be seen when compared to FIG. 21a, areas may be combined (such as 2132) thereby varying the staff member attached to the area 2130. A similar example can be seen with reference to 2134, where two separate jobs in the kitchen are merged and one staff member is allocated to two pieces of equipment/jobs.

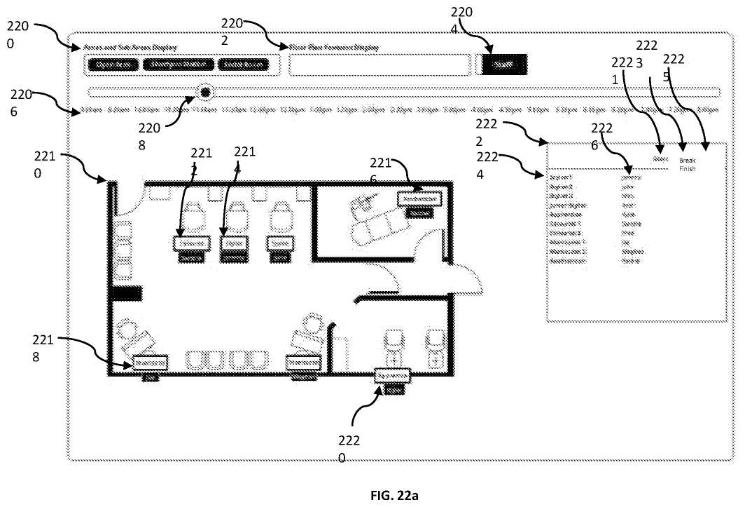

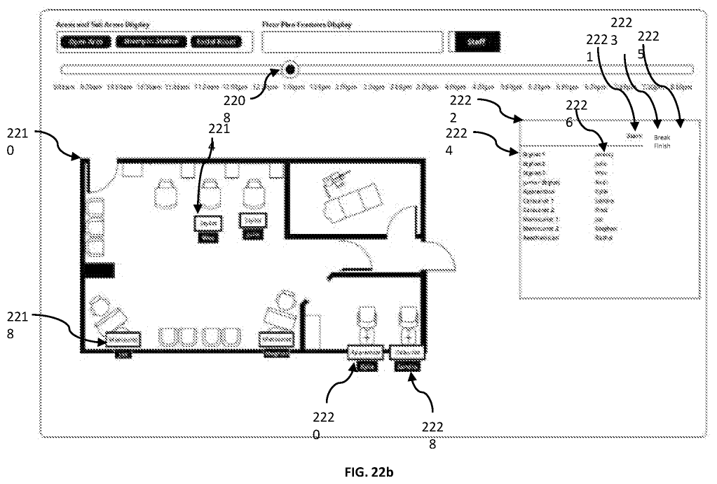

Referring to FIG. 22a, there is shown is shown a screenshot of the ResButler floor plan for a hair salon with variability by time in accordance with an embodiment of the invention. In particular there is shown the allocation of staff to particular areas of the salon. At 2200 there is shown a summary of the areas displayed and at 2202 there is shown a summary of the floor plan features displayed. The option to show staff may be turned on and off by utilising slide switch 2204. The changes over a service period or day may be viewed by the operator by utilising slider indicated by 2206 and 2208. Area box 2210 indicates a floor plan for a salon, including equipment 2212, 2214, 2216, 2218 and 2220. A summary table is displayed at area 2222 which includes a stylist list 2224, which in turn displays specific staff members 2226 with specific start times 2221, break times 2223 and finish times 2225.

Referring to FIG. 22b, there is shown is shown a screenshot of the ResButler floor plan for a hair salon with variability by time in accordance with an embodiment of the invention. As can be seen when compared to FIG. 22a, staff will move to different equipment over time thereby varying the staff member attached to the area. For example, at 2228 there is a different staff member.

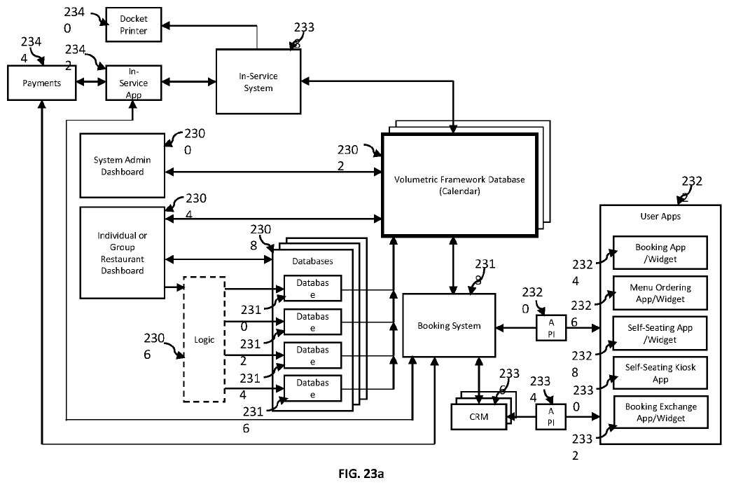

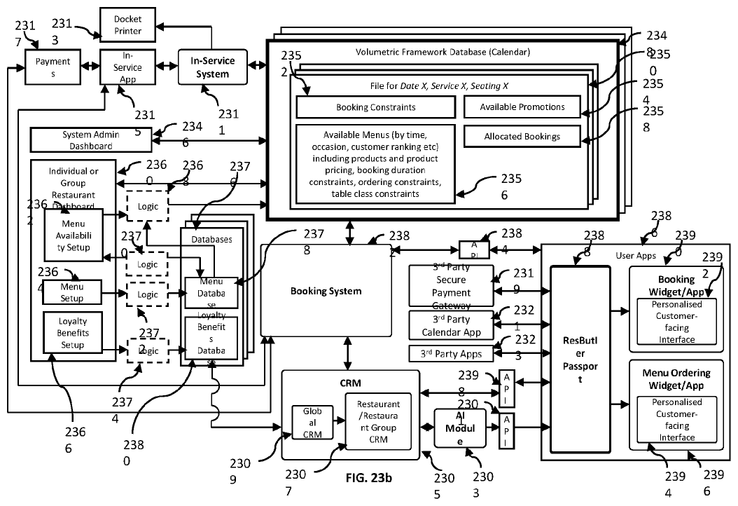

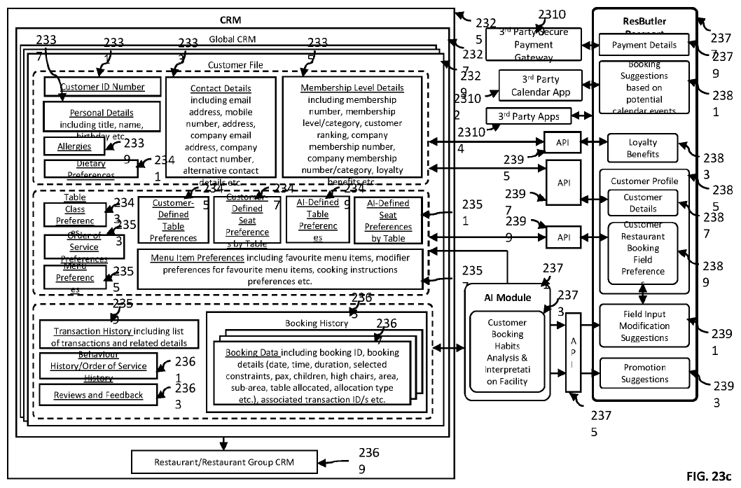

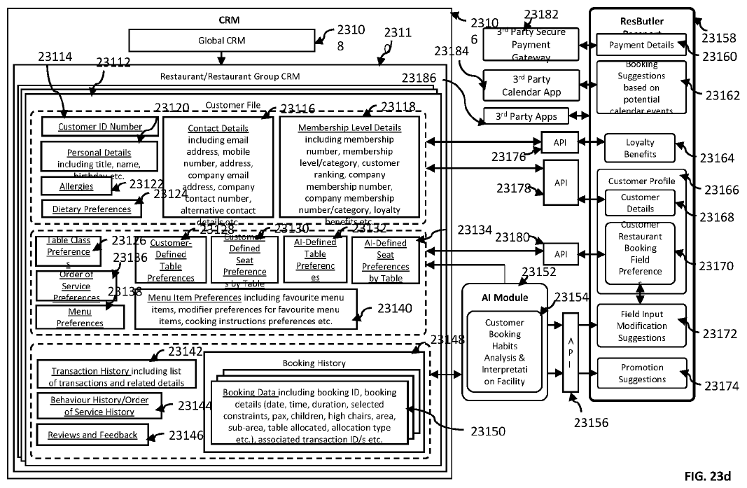

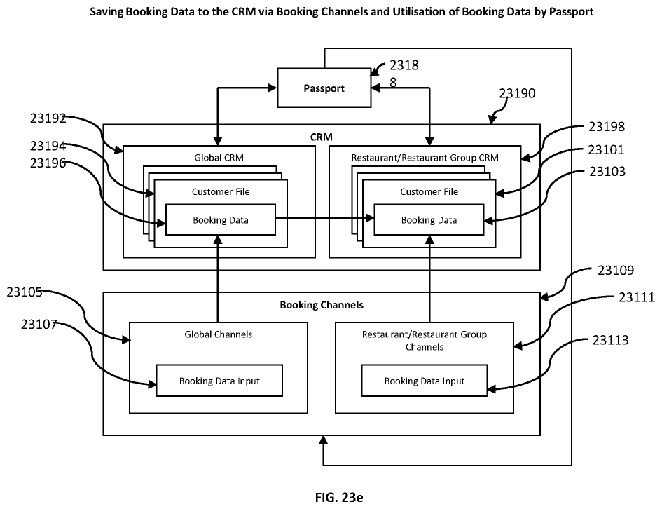

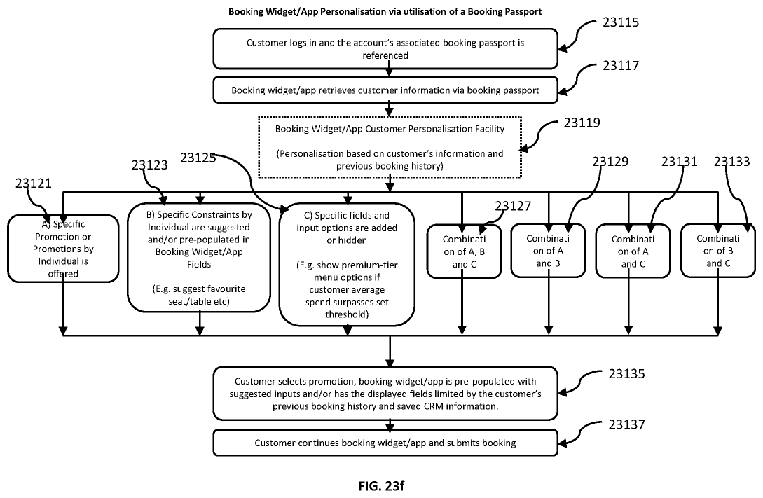

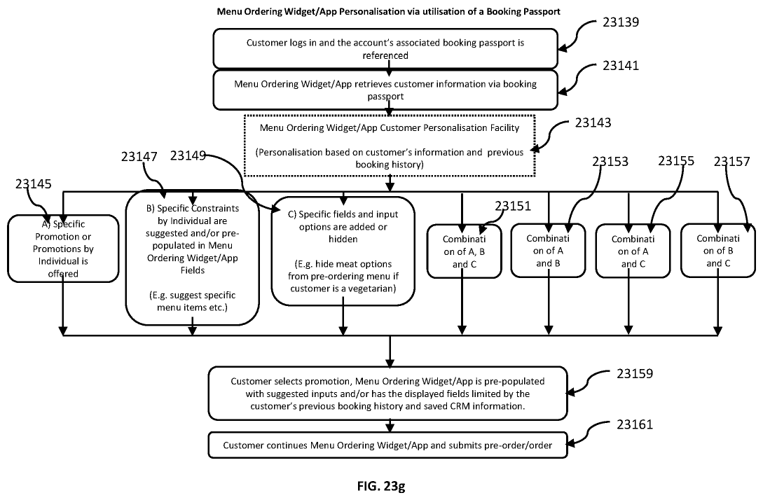

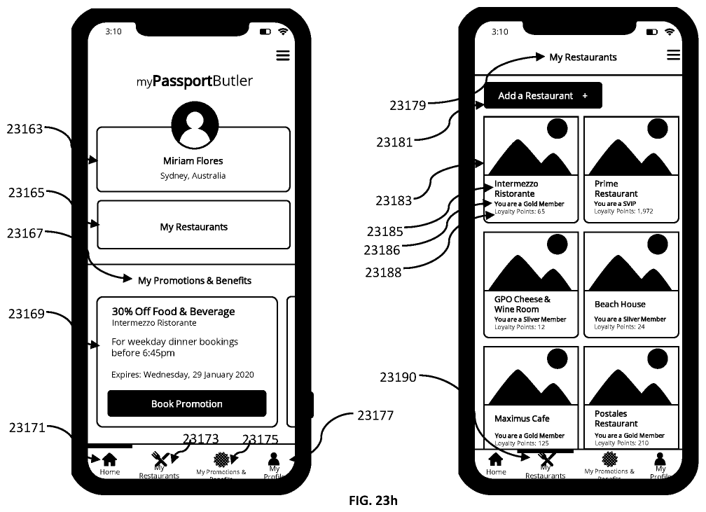

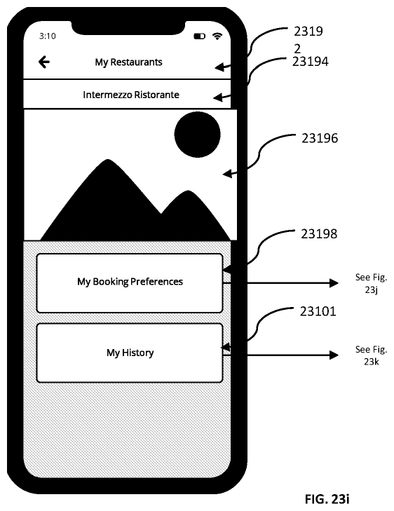

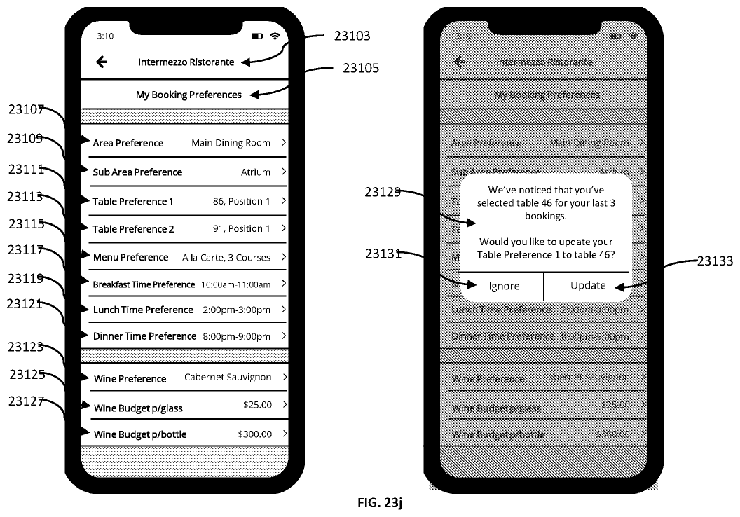

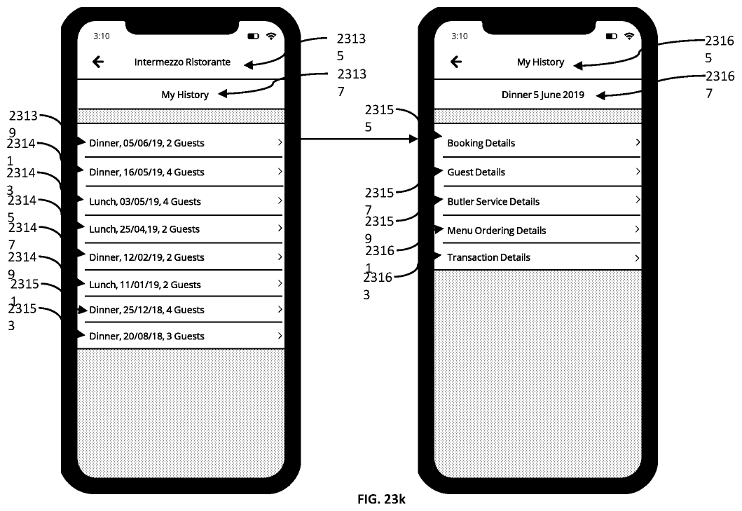

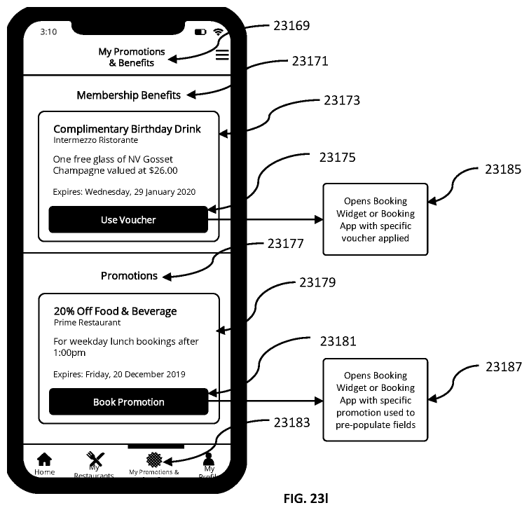

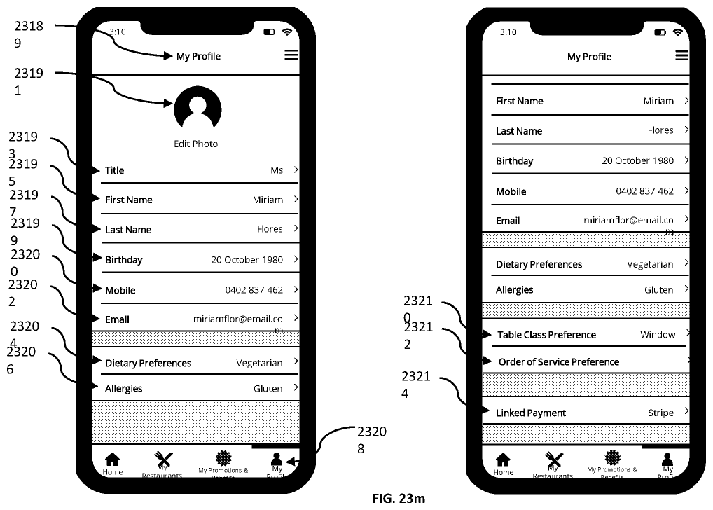

Referring to FIG. 23a, there is shown a high-level modular diagram of the ResButler system in accordance with an embodiment of the invention. The operator interacts with a system admin dashboard 2300 which is in communication with a Volumetric Framework Database (Calendar) 2302. In turn, there are also provided individual or group restaurant dashboards (an instance of which is illustrated at 2304) which interfaces with logic 2306 (i.e. a system arranged to assist in communication with databases 2308 which includes individual databases such as 2310, 2312, 2314 and 2316, which in turn are also connected to the Volumetric Framework 2302. The volumetric framework 2302 is also connected to a booking system 2318, which interacts with one or more CRMs 2336. In turn the booking system 2318 uses an API 2320 to interface with one or more user apps collectively shown at 2322, including a booking app/widget 2324, a menu ordering app/widget 2326, a self-seating app/widget 2328, a self-seating kiosk app 2330, a booking exchange app/widget 2332.

Referring to FIG. 23b, there is shown a more detailed modular diagram of the ResButler system in accordance with an embodiment of the invention. The more detailed diagram of FIG. 23b is focused on aspects of the “passport” system in accordance with an embodiment of the invention. The ResButler passport 2388 is an app that forms part of the group of user apps 2386 accessible by the user. The passport 2388 interfaces with the booking widget/app 2390 and the menu ordering widget/app 2396 and provides, respectively, a personalised customer-facing interface 2392 and 2394. The Passport 2388 interfaces via three APIs 2384, 2398 and 2301 with either the booking system 2382, a CRM 2305 or an AI module 2303. In turn, the passport may also interface directly with third party secure payment gateway 2319, third party calendar apps 2321 and other third party apps 2323.

Returning to the booking system 2382, the booking system interfaces with the volumetric framework 2348, which includes multiple files 2350, each file representing a particular service period 2350, including booking constraints 2352, available promotions 2354, allocated bookings 2358 and multiple menus 2356. In turn, the volumetric framework 2348 also interfaces with an in-service system 2311, including an in-service app 2315, a payment getaway 2317 and a docket printer 2313. The volumetric framework 2348 interfaces with a system admin dashboard 2346 and an individual or group restaurant dashboard containing menu availability setup interfaces 2362, menu setup interface 2364, and loyalty benefit set up 2366, each of which utilise logic engines 2368, 2370, 2372 ad 2374 to interface variously with the volumetric framework 2348, databases 2376 including menu database 2378 and loyalty benefits database 2380, which in turn interfaces with CRM 2305 including global CRM 2309 and individual restaurant CRMs 2307.

Referring to FIG. 23c, there is shown a more detailed breakdown of the CRM 2305 and passport 2388 of FIG. 23b. In FIG. 23c, the passport 2377 is equivalent to passport 2388 of FIG. 23b and CRM 2325 of FIG. 23c is equivalent to CRM 2305 of FIG. 23b. Referring to CRM 2325 of FIG. 23c, there is shown a global CRM 2327 including customer files 2329, which include various fields of data, such as customer ID 2331, contact details 2333, membership level details 2335, personal details 2337, allergy information 2339, dietary preferences 2341, table class preference 2343, customer defined table preferences 2345, AI defined table preferences 2349, AI defined seat preferences 2351, order of service preferences 2353, menu preferences 2355, menu item preferences 2357, transaction history 2359, behaviour history 2361, reviews and feedback information 2363, and booking history information 2365, which includes booking data 2367. All of this data is made available to the restaurant CRM 2369.

Returning to the customer file 2329, the information from customer file 2329 is provided, via various APIs such as 2395, 2397 and 2399, or via the AI module 2371 and corresponding AI API 2375 to the passport 2377, through which a customer (user) can provide payment details 2379, or receive booking suggestions 2381, loyalty benefits 2383, a customer profile 2385 including customer details 2387, customer preferences 2389, field input suggestions 2391 and promotion suggestions 2393. As previously described with reference to FIG. 23b, the passport 2377 also interfaces with a third party payment gateway 23100, third party calendar apps 23102 and other third party apps 23104.

In short, the CRM 2325 acts with the passport 2377 via various APIs to provide a comprehensive and detailed “assistant” to simplify and enrich the experience the customer (user) has with the ResButler system. The passport acts as a portal into a comprehensive set of information that allows the CRM to integrally operate with the ResButler booking system to provide a number of functions which include but are not limited to:
1. The pre-filling of certain fields (such as customer name, details, etc.);
2. The ability to identify and provide, to the customer, promotions which best suit the customer, such as offers available at times the customer is more likely to dine, tables that the customer prefers, menus that the customer prefers, etc.;
3. The ability to autonomously improve the customer experience, through the autonomous updating of information captured from prior and current bookings, the tracking of customer behaviour to identify patterns (and thereby derive preferences); and
4. The ability to provide feedback to the restaurant for further manual improvement.

In addition to the advantages summarised above, the passport is not tied to a single restaurant or group of restaurants, but provides a “global” set of preferences which allows the customer to be provided with a personalised service across all restaurants that provide a booking service through the ResButler platform. In this manner, the information in the Global database is universalised in a manner that allows the information to be used across different restaurants with different layouts, different cuisines, different menus, etc. For example, while the customer may not have specific knowledge of a restaurant, if the preference data includes information that suggests that the customer prefers a table with a view, such information can be applied to any restaurant with a view, without the need for specific knowledge by the customer. To take a more (arguably) important example, utilising allergy information, the passport, in conjunction with the volumetric framework, the CRM and the menu database, is capable of building a customised menu which automatically excludes menu items that contain allergens, and/or autonomously provide alternative menu items to the customer that do not include ingredients that are allergens. As such, the passport allows the customer to have a completely unique experience in keeping with their preferences, irrespective of the restaurant chosen, the customer's fellow diners, the service period, or any other factor that would normally result in the need for manual intervention to accommodate the customer. This information is provided to the restaurant CRM from the Global CRM autonomously.

Referring to FIG. 23d, there is shown a more detailed overview of the Restaurant CRM 2307 of FIG. 23b. Referring to CRM 23106 of FIG. 23d, there is shown a restaurant CRM 23110 including customer files 23112, which include various fields of data, such as customer ID 23114, contact details 23116, membership level details 23118, personal details 23120, allergy information 23122, dietary preferences 23124, table class preferences 23126, customer defined table preferences 23128, customer defined seat preferences 23130, AI defined table preferences 23132, AI defined seat preferences 23134, order of service preferences 23136, menu preferences 23138, menu item preferences 23140, transaction history 23142, behaviour history 23144, reviews and feedback information 23146, and booking history information 23148, which includes booking data 23150. All of this data may be made available from the Global CRM.

Returning to the customer file 23112, the information from customer file 23112 is provided, via various APIs such as 23176, 23178 and 23180, or via the AI module 23152 and corresponding AI API 23156 to the passport 23158, through which a customer (user) can provide payment details 23160, or receive booking suggestions 23162, loyalty benefits 23164, a customer profile 23166 including customer details 23168, customer preferences 23170, field input suggestions 23172 and promotion suggestions 23174. As previously described with reference to FIG. 23b, the passport 23158 also interfaces with a third party payment gateway 23182, third party calendar apps 23184 and other third party apps 23186.

In short, the CRM 23106 acts with the passport 23158 via various APIs to provide a comprehensive and detailed “assistant” to simplify and enrich the experience the customer (user) has with the ResButler system, with the advantages previously described.

As seen when FIGS. 23c and 23d are taken together, the global CRM and the restaurant CRM may interchange information and while there is some information overlap between the two CRMs, the CRMs operate in a synergistic manner to exchange common information but also keep information that is unique to each CRM. For example, an individual restaurant may have a particular class of tables not common to other restaurants. Therefore, the information regarding table class preferences for an individual restaurant may overlap, but not be identical to the information contained in the global CRM. In the situation where a booking requires specific information, one CRM is given precedence over the other, depending on context. However, in most situations, it is expected that the local restaurant CRM will take precedence, especially with regard to preferences that are restaurant specific. However, it will be understood that each implementation of the restaurant CRM may have a rule set or other information which provides the booking system with information on which CRM data to use when allocating a booking or providing a recommendation to the customer. Such variations are within the purview of a person skilled in the art.

In one embodiment, the CRMs may exist in a strict hierarchical format. That is, information may only “flow” in one direction, with one CRM being a master CRM and the other being a slave CRM. In more detail, the Global CRM may be set up as the “single source of truth”, with information captured from the customer/client/booking requestor by the global CRM and then only provided to the Restaurant CRM as required. This hierarchical structure may be instituted to ensure that customer data is only collected by the Global CRM when the customer is making a booking via a Global Channel. In this way, any customers making bookings via any Restaurant-owned channels do not have their data copied or replicated to the global CRM, which may be important for commercial reasons (e.g. ownership of data) or for legal reasons (e.g. maintaining privacy of data). Such variations are within the urview of a person skilled in the art.

Referring to FIG. 23e, there is shown a simplified methodology, in diagrammatic form, for how booking data is saved to the CRMs via booking channels. The passport 23188 interacts with both the CRMs 23190 and booking channels 23109. In the same manner as there is a global CRM 23192 and a restaurant CRM 23198, there is a corresponding global booking channel 23105 and a restaurant channel 23111. The customer may input data 23107 via the global channel 23105 or input data 23113 via restaurant channel 23111. The data 23196 is provided to either the global CRM 23192 and customer file 23194 or data 23103 is provided to restaurant CRM 23198 and customer file 23101. Data is interchanged between customer files 23194 and 23101 as required, as was described above with regard to the interaction between the global CRM and the restaurant CRM.

Referring to FIG. 23f, there is shown a flowchart depicting the methodology followed by a booking widget/app via utilisation of a booking passport in accordance with an embodiment of the invention. At step 23115, a customer (user) logs into their account and the customer's passport is referenced. The widget/app subsequently retrieves customer information via the passport at step 23117. Consequently, at step 23119, the booking widget/app personalisation facility provides a customised interfaced based on customer information including booking history information. Subsequently, the customer may be offered a promotion at 23121, specific constraints may be suggested at 23123, or specific options may be added or removed at step 23125, or any combination of the aforementioned steps may be taken as shown by steps 23127, 23129, 23131 and 23133. Thereafter, the customer selects the options of interest (e.g. a promotion) and the interface is updated accordingly at step 23135. Lastly, the customer continues along the booking process path (as described elsewhere) at step 23137.

Referring to FIG. 23g, there is shown a flowchart depicting the methodology followed by a menu ordering widget/app via utilisation of a booking passport in accordance with an embodiment of the invention. Referring to FIG. 23g, there is shown a flowchart depicting the methodology followed by a menu ordering widget/app via utilisation of a booking passport in accordance with an embodiment of the invention. At step 23139, a customer (user) logs into their account and the customer's passport is referenced. The menu ordering widget/app subsequently retrieves customer information via the passport at step 23141. Consequently, at step 23143, the menu ordering widget/app personalisation facility provides a customised interfaced based on customer information including booking history information. Subsequently, the customer may be offered a promotion at 23145, specific constraints may be suggested at 23147, or specific options may be added or removed at step 23149, or any combination of the aforementioned steps may be taken as shown by steps 23151, 23153, 23155 and 23157. Thereafter, the customer selects the options of interest (e.g. a promotion) and the interface is updated accordingly at step 23159. Lastly, the customer continues along the booking process path (as described elsewhere) at step 23161.

Referring to FIG. 23h-m, there are shown screenshots of the passport interface in accordance with an embodiment of the invention. Referring firstly to FIG. 23h, there is shown on the left hand side of the page a screen including various interactive buttons including customer identification information 23163, a “My Restaurants” button 23165, a promotions area 23167 including promotion button 23169, and various control buttons 23171, 23173, 23175 and 23177 at the bottom of the interface. Upon the user selecting the My Restaurants button 23165, the user is taken to the interface screen shown at the right hand side of the screen including heading 23179, and various selectable icons such as 23183, which includes an image or logo of the restaurant 23183, the restaurant name 23185, the membership level of the user 23186 and the number of loyalty points 23188. The user can add a restaurant by selecting button 23181 and the bottom of the screen at 23190 indicates the section of the interface that is currently displayed.

Referring to FIG. 23i, there is shown an interface screen that is displayed if the user selects the selectable icon 23183 of FIG. 23h. There is shown a heading 23192, the restaurant name 23194, the image or icon of the restaurant 23196, a booking preferences button 23198 which is described with respect to FIG. 23j and a history button 23101 which is described with reference to FIG. 23k.

Referring to FIG. 23j, there is shown there is shown an interface screen that is displayed if the user selects the selectable icon 23198 of FIG. 23i. Referring to the screenshot of the interface on the left hand side of the Figure, there is shown the restaurant name at 23103, and a title that indicates that the user is in the Booking Preferences screen at 23105. In the Booking Preferences screen, the user is provided with the ability to select an area preference 23107, a sub area preference 23109, a first table preference 23111, a second table preference 23113, a menu preference 23115, a breakfast time preference 23117, a lunch time preference 23119, a dinner preference 23121, a wine preference 23123 a wine budget per glass 23125 and a wine budget per bottle 23127. Referring to the interface screen on the right-hand side of the Figure, from time to time the user may be presented with a notification which provides suggestions, such as the suggestion 23129. Where the user believes the suggestion is correct and would like to update their preferences, they can choose the update button 23133. Alternatively, they can ignore the notification by choosing the ignore button 23131.

Referring to FIG. 23k, there is shown there is shown an interface screen that is displayed if the user selects the selectable icon 23101 of FIG. 23i. Referring to the screenshot of the interface on the left hand side of the Figure, there is shown the restaurant name at 23135, and a title that indicates that the user is in the My History screen at 23137. In the My History screen, the user is provided with the ability to select from any current booking, which are numbered, in the screenshot example, 23139, 23141, 23143, 23145, 23147, 23149, 23151 and 23153 respectively. Upon clicking one of the current bookings, such as booking 23139, the user is taken to the interface screen on the right-hand side of the Figure, which displays the My History title at 23165 and the date and service period of the booking at 23167. The user can view booking details by selecting button 23155, guest details by selecting button 23157, butter service details by selecting button 23159, menu ordering details by selecting button 23161 and transaction details by selecting button 23163.

Referring now to FIG. 23l, there is shown there is shown an interface screen that is displayed if the user selects the selectable icon 23175 of FIG. 23h. At 23169 on the screen shown at the left-hand side of the Figure, there is displayed the title of the screen, which is split, in the embodiment, into two sections, namely membership benefits 23171 and promotions 23177. In the membership benefits section 23171 there is shown one or more benefits in the form of a virtual “voucher”, such as the voucher shown at 23173, which the user can select by selecting button 23175. By selecting button 23175, the booking widget or booking app is opened at 23185, with the specific voucher being applied. Referring to the promotions section 23177, there is shown one or more promotions in the form of a virtual “voucher”, such as the voucher shown at 23179, which the user can select by selecting button 23181. By selecting button 23181, the booking widget or booking app is opened at 23187, with the specific voucher being applied.

Referring to FIG. 23m, there is shown there is shown an interface screen that is displayed if the user selects the selectable icon 23163 of FIG. 23h. At 23189, there is shown the My Profile title 23189, including an image of the user at 23191. The user may enter personal information such as their title 23193, first name 23195, last name 23197, birth date 23199, mobile phone number 23200, email 23202, dietary preferences 23204 and allergies 23206. The My Profile tab is highlighted at 23208, as a secondary visual indication that the user is in the My Profile section. If the user scrolls down the screen, the interface displays the additional fields shown at the right-hand screenshot of the Figure. The additional preferences include table class preference 23210, order of service preference 23212 and linked payment details 23214.

### Advantages

The embodiment and broader invention described herein provides a number of advantages.

Firstly, the system allows an unskilled restaurant operator to enter information to define the space/venue, define rooms, define furniture, define classes, define menus, etc., in a manner that is instantly understandable to the restaurant operator. The floor plan configurator then utilises this information to create a series of constraints and options in a manner that is usable by the underlying allocation methodology and or the one or more allocation algorithms.

Secondly, the system allows the addition of constraints with respect to individual tables, classes of tables etc., that permit a level of product differentiation and the incorporation of dynamic pricing levels not possible under the prior art.

Thirdly, the system, once set up, works with the allocation methodology and/or the one or more algorithms to provide seamless management of all aspects of the customer's dining experience, from the initial booking, through to meal preparation, service, and payment for the dining service. As such, very little to no manual intervention is required (mainly limited to bringing the meal to the table and assisting diners with enquiries).

Fourthly, in combination with the widget and with the CRM, the system is capable of providing truly individual service not only to each dining party, but to each individual guest in each dining party. Depending on the number of options and the constraints of the venue, the system can provide billions of customised experiences, such that no two dining experiences are exactly alike. To put it another way, the system allows the diner to choose any option and any combination that is possible, without the need for intervention by the restaurant operator.

Fifthly, the system allows for the seamless integration into other financial and operational systems so as to minimise and/or eliminate all manual intervention within those systems such as the manual set-up and transfer of operational and financial information.

The use of the computer-enabled method, system and computer program disclosed herein has provided examples within the restaurant industry, however, they are equally applicable within other industries and businesses such as airlines, accommodation, hotels, travel, cruise ships, car rentals, clubs, pubs, gyms, hairdressers, workspaces, and the provision of advice and consulting services.

### Disclaimers

Throughout this specification, unless the context requires otherwise, the word “comprise” or variations such as “comprises” or “comprising”, will be understood to imply the inclusion of a stated feature or group of features but not the explicit exclusion of any other feature or group of features.

Those skilled in the art will appreciate that the embodiments described herein are susceptible to obvious variations and modifications other than those specifically described and it is intended that the broadest claims cover all such variations and modifications. Those skilled in the art will also understand that the inventive concept that underpins the broadest claims may include any number of the steps, features, and concepts referred to or indicated in the specification, either individually or collectively, and any and all combinations of any two or more of the steps or features may constitute an invention.

Where definitions for selected terms used herein are found within the detailed description of the invention, it is intended that such definitions apply to the claimed invention. However, if not explicitly defined, all scientific and technical terms used herein have the same meaning as commonly understood to one of ordinary skill in the art to which the invention belongs.

Although not required, the embodiments described with reference to the method, computer program, computer interface and aspects of the system can be implemented via an Application Programming Interface (API), an Application Development Kit (AD K) or as a series of program libraries, for use by a developer, for the creation of software applications which are to be used on any one or more computing platforms or devices, such as a terminal or personal computer operating system or a portable computing device, a smartphone or a tablet computing system operating system, or within a larger server structure, such as a ‘data farm’ or within a larger computing transaction processing system.

Generally, as program modules include routines, programs, objects, components and data files that perform or assist in the performance of particular functions, it will be understood that the functionality of the method, computer program and computer interface defined herein may be distributed across a number of routines, programs, objects or components to achieve the same functionality as the embodiment and the broader invention claimed herein. Such variations and modifications are contemplated by the inventor and are within the purview of those skilled in the art.

It will also be appreciated that where methods and systems of the present invention and/or embodiments are implemented by computing systems or implemented across multiple computing systems then any appropriate computing system architecture may be utilised without departing from the inventive concept. This includes standalone computers, networked computers and dedicated computing devices that do not utilise software as it is colloquially understood (such as field-programmable gate arrays).

Where the terms “computer”, “computing system”, “computing device” and “mobile device” are used in the specification, these terms are intended to cover any appropriate arrangement of computer hardware for implementing the inventive concept and/or embodiments described herein.

Where the terms “software application”, “application”, “app”, “computer program”, “program” and “widget” are used in the specification when referring to an embodiment of the invention, these terms are intended to cover any appropriate software which is capable of performing the functions and/or achieving the outcomes as broadly described herein.

Where reference is made to communication standards, methods and/or systems, it will be understood that the devices, computing systems, servers, etc., that constitute the embodiments and/or invention or interact with the embodiments and/or invention may transmit and receive data via any suitable hardware mechanism and software protocol, including wired and wireless communications protocols, such as but not limited to second, third, fourth and fifth generation (2G, 3G, 4G and 5G) telecommunications protocols (in accordance with the International Mobile Telecommunications-2000 (IMT-2000) specification), Wi-Fi (in accordance with the IEEE 802.11 standards), Bluetooth (in accordance with the IEEE 802.15.1 standard and/or standards set by the Bluetooth Special Interest Group), or any other radio frequency, optical, acoustic, magnetic, or any other form or method of communication that may become available from time to time.

### ANNEXURE 1

### 1. Prior Art—Performance Measures and Metrics

The following is an extensive list of the current theoretical revenue measures applied to restaurants. There are no prior art systems that can provide measures related to space, classes of tables, extended durations, by differentiated products etc., as such information is beyond the capture of existing systems and hence calculations and performance monitoring and adjustment is also beyond current systems.
RevPASH (Revenue Per Available Seat Hour)
CMPASH (Contribution Margin Per Available Seat Hour)
RevPASM (Revenue per Available Square Meter)
ProPASH (Profit per Available Seat Hour)
ProPASM (Profit per Available Square Meter)
RRM (Restaurant Revenue Management)
   Time Per Table Turn
   Times Table Turn
   Cancelled/No Show/Covers as a % of Reserved Covers
   Average revenue per person
   Average revenue per table
   Average revenue per chair

### Notes:

1. To date the restaurant performance measures and metrics of the only known and placed reliance on a few single dimensional applied metrics such as table turns, average spend per customer and theoretical but not applied metrics such as revenue per available seat hour. These applied and theoretical measurements and metrics by themselves, do not offer any proper or significant guidance as to what decisions a restaurant should take. This has resulted in restaurants being limited to and merely focusing on discounting prices during low demand periods and systems that cannot be automated and for artificial intelligence to be applied.
2. The prior art use of single measures as shown above and applied to PASH and PASM do not offer information as to what inputs need to be changed, how they need to be changed or other information that would assist a person in their decision-making process or provide the necessary information that could be used within an artificially intelligent system for the autonomous changing of constraints. The reason that the prior art fails is that all prior art cannot distinguish between the inputs and variables that impact the simple measures such as PASH and PASM that have been measures identified by the prior art.

### ANNEXURE 2

### 2. Floor Plan Guidelines, Benchmarks, Rankings and Space Efficiency Measures for the Claimed Invention

### 1. Spatial Guidelines and Measures

Floor Space Allocation

| | |
|---|---|
| Total Floor Plan Area | (100%) |
| Kitchen Floor Plan Area | (30%) |
| Wash Up Store Room, Locker Room, Admin Floor Plan Area | (10%) |
| Dining Room and Bar Plan Area (includes toilets and waiters' | (60%) |
| stations) | |

Dining, Bar and Customer Spaces (Required to Scale)
Dining Room Area 1 Floor Plan
Dining Room Area 2 Floor Plan (etc)
Private Dining Room Area 3 Floor Plan (etc)
Dining Room Subarea 1 Floor Plan (etc)
Dining Room Section 1 Floor Plan (etc)
Bar Area Floor Plan

Table Top Size Guide

| Minimum recommended table top size per person | 0.18 | square meters |
|---|---|---|
| Minimum table top size (for two) | 600 mm by 600 mm | |
| Table Top Fine Dining (minimum) | 750 mm by 750 mm | |
| Table Top Full-Service Restaurant Dining | 700 mm by 750 mm | |
| Casual Restaurant Full-Service Dining | 600 mm by 700 mm | |
| Bar Area dining top | 300 mm by 500 mm | |
| Round Top 1 to 2 people diameter | 600 | mm |
| Round Top 2 to 4 people diameter | 800 | mm |
| Round Top 4 to 5 people diameter | 1000 | mm |
| Round Top 5 to 6 people diameter | 1200 | mm |
| Round Top 6 to 7 people diameter | 1350 | mm |
| Round Top 7 to 8 people diameter | 1500 | mm |

Fixed and Flexible Seating Areas to scale including walkways
Number of Fixed tables within the floor plan
Number of Flexible Tables within the floor plan
Number of Fixed Tables to total tables
Percentage of Flexible Tables to total tables

Chair Size Guide

| | |
|---|---|
| Minimum chair footprint | 450 mm by 450 mm |

Spacing Between Tables (Allowing for Chairs and Movement)

| Space between rectangular tables including chairs | 1250 mm to 1550 mm | |
|---|---|---|
| Space between table to table with chair only on | 1050 | mm |
| one side | | |
| Space between back to back chairs for movement | 460 | mm |
| Space between diagonal chairs | 460 | mm |
| Space between tables in row seating | 150 mm to 700 mm | |
| Space between round tables | 1350 | mm |
| Space allowed for chairs along a table | 600 | mm |
| Walk way between table with no chairs | 600 | mm |
| Walk way fire egress depends on regulations | 1000 | mm |

Waiter Stations Size Guide

| | |
|---|---|
| Waiter Stations small up to 20 chairs/diners | 0.50 to 1.00 square meters |
| Waiter Stations up to 60 chairs/diners | 2.25 to 3.75 square meters |

Bars Space and Bar Stools Size Guide

| | |
|---|---|
| Bar Area Floor Plan | |
| Bar Stool seating Distances | 510 mm to 600 mm |

Area per Person Size Guide

| | |
|---|---|
| Square meters per patron Fine Dining | 1.70 to 1.90 square meters |
| Square meters per patron Full-Service | 1.10 to 1.40 square meters |
| Restaurant Dining | |
| Square meters per patron Counter Service | 1.70 to 1.90 square meters |
| Square meters per patron Fast Food Medium | 1.00 to 1.30 square meters |
| Square meters per patron Table Service, | 1.40 to 1.70 square meters |
| Hotel/Club | |
| Square meters per patron Banquet, Minimum | 0.90 to 1.10 square meters |

### 2. Area, Sub Area, Class, Section and Table and Stool Rankings

Ranking of areas
Ranking of subareas within areas
Ranking of sections within areas
Ranking of classes
Ranking of sections
Ranking of all individual tables within the venue
Ranking of all chairs within each table and location
Ranking by table characteristics; view, privacy, etc., by groups or classes

### 3. Table Analysis

Table size by day by time, seating, service, by area, by subarea, by section
Table size by occasion
Table size by product
Table size by duration
Table size by class
Quantity of tables (and chairs) by class and by area
Quantity of tables (and chairs) by utility
Requested tables (by all permutations)
Usage and Occupancy of Requested tables (by all permutations)
Rates of Requested tables versus other tables (by all permutations)
Revenue of Requested tables versus other tables (by all permutations)
Preferred Tables (by all permutations)
Usage and Occupancy of Preferred Tables (by all permutations)
Rates of Requested Tables versus other tables (by all permutations)
Usage of the fixed Tables versus total tables (by all permutations)
Usage of the Flexible Table versus total tables (by all permutations)
Usage of Alternate Floor Plans and Layouts (by all permutations)
Usage of additional Furniture by the optimisation algorithm (by all permutations)
Removal of Furniture shown on the Floor Plan by the optimisation algorithm (by all permutations)
Number of bookings that could not be accommodated by booking size and timing (by all permutations)
Revenue analysis of all tables by distribution channel (by all permutations)

### 4. Tables for Sale, Tables for Auction, Tables Dedicated to Specific Partners for Distribution and or Channels

Tables for sale by partner (by all permutations)
Tables for sale by distribution channel (by all permutations)
Tables for auction (by all permutations)
Tables dedicated to specific channels (by all permutations)
Usage and occupancy of requested tables versus available capacity
Revenue comparisons of all table combinations (by all permutations)
Chair analysis similar to table analysis (by all permutations)

### 5. Location Analysis

Revenue by location by floor space (by all permutations)
Revenue by total floor space

### 6. Floor Space Efficiency

Revenue per square meter by total productive floor space
Revenue per square meter by total floor space including non-productive floor space
Revenue by per square meter by different floor space sub-sets, classes, etc. (by all permutations)

### ANNEXURE 3

### 3. Capacity, Utilisation and Revenue Efficiency Measures for the Claimed Invention

The below measures and metrics must include additional tables and chairs added for a service and deduct the tables and chairs removed for a service. That is the use of one embodiment of the claimed invention and dynamic allocation process which permits which the addition and removal of tables from the capacity and inventory made available for the allocation of a booking. The concept of adding or removing tables and chairs from the available capacity during the booking allocation process is outside the scope (and beyond the prior art). Also refer to Annexure 7 for further details of this embodiment.

### 1. Revenue Yield

AR (Actual Revenue)—Used by prior art to calculate RevPASH
PR (Potential Full Revenue—all items sold and free items provided at RRP)
RY (Revenue Yield)

### 2. Seat Capacity (Production) and Utilisation

Capacity
ASH (Available Seat Hours)—Capacity—Used by prior art to calculate RevPASH

Revenue
RSH (Revenue Seat Hours)—Equivalent to the prior art of RevPASH

Utilisation
SUF (Seat Utilisation Factor)

Efficiency
SEF (Efficiency Factor—Revenue Yield (RY) multiplied by (SUF))

Costs
Cost levels can be calculated by available seat capacity or revenue seat capacity

### 3. Table Capacity (Production) and Utilisation

Capacity
ATH (Available Table Hours)

Revenue
RTH (Revenue Table Hours)

Utilisation
TUF (Table Utilisation Factor)

Efficiency
TEF (Table Efficiency Factor)

Costs
Costs levels can be calculated by available table capacity or revenue table capacity

### 4. Units of Measure of Capacity

Physical Constraints
NOR (Number of Restaurants)
NOT (Number of Tables)
NOS (Number of Seats)

Hours Open
HRO (Hours Restaurant Open)
HKO (Hours Kitchen Open)

Service Periods Open
SPO (Service Periods Open)
BPO (Breakfast Periods Open)
LPO (Lunch Periods Open)
DPO (Dinner periods Open)
SPO (Supper Periods Open)

Service Hours Open
BSHO (Breakfast Service Hours Open)
LSHO (Lunch Service Hours Open)
DSHO (Dinner Service Hours Open)
SSHO (Supper Service Hours Open)

Back of House (Kitchen) Hours
HKP (Hours Kitchen Preparation)
HKS (Hours Kitchen in Service)
HKC (Hours Kitchen Clean-up)

Front of House (Dining Room) Hours
HDRP (Hours Dining Room Preparation)
HDRO (Hours Dining Room Open)
HDRC (Hours Dining Room Clean-up)

### ANNEXURE 4

### 4. Booking Analysis for the Claimed Invention

### 1. Booking Requests Allocated Analysis

Booking requests by time, date, etc, made that could be accommodated by booking size by occasion, by service, by area, subarea, section, class, specific table

### 2. Booking Profile Analysis

Booking lead time profile
Booking group size
Booking occasion
Booking composition by adults, by children, by high chairs, by etc.,
By duration
By menu
By time
By Butler Service
By table size
By table requested
By table preferred
By postcode/address

### 3. Booking Requests Rejected Analysis

Booking requests by time, date, etc, made that could not be accommodated by booking size by occasion, by service, by area, subarea, section, class, specific table
Booking requests by time, date, etc, made where a person took an alternate booking without an incentive by booking size by occasion, by service, by area, subarea, section, class, specific table
Booking requests by time, date, etc, made where a person took an alternate booking with an incentive by booking size by occasion, by service, by area, subarea, section, class, specific table
Booking Requests by time, date, etc, made that went on a waitlist by service by time by booking size by occasion, by service, by area, subarea, section, class, specific table
Booking Requests by time, date, etc, that went on a wait list that could be accommodated by service by time by booking size by occasion, by service, by area, subarea, section, class, specific table
Booking requests by time, date, etc, made that went on a wait list that could not be accommodated by service by time by booking size by occasion, by service, by area, subarea, section, class, specific table
Booking lead time profile
Booking source, by website, by third party, by app, by referral

### 4. Source of Booking Analysis

Booking source (Source of Revenue), by website, by third party, by app, by referral
Cost of booking source and cost of referrals

### ANNEXURE 5

### 5. Duration Time Analysis for the Claimed Invention

### 1. Duration Time Analysis

Duration time by booking size compared to standard booking time
Duration time by booking size by menu compared to standard booking time
Duration time by booking size by menu by number of courses compared to standard booking time
Duration time by booking size by customer type compared to standard booking time
Duration time by booking size by day compared to standard booking time
Duration time by booking time interval by day compared to standard booking time
Duration times by booking size by menu, by time taken for each activity, being seated, taking food order, taking drink order, time taken for the first course to be prepared, time taken for the first course to be consumed, time taken for the second course to be delivered from time of seating and from time to being called away, time to consume the second course, time third course order taken, time before third course delivered, time to consume third course, other items ordered, time other items delivered, time bill given, time bill paid compared to standard booking times.
Duration times by occasion using the same metrics as booking size compared to standard booking time.
Table reset times by table type by day of the week by time compared to standard booking time

### 2. Extended Duration Time Analysis for the Claimed Invention

Extended duration time by table, class of table, section, class, subarea, area, channel, booking partner
Increase in revenue comparing normal duration bookings with extended duration bookings

### ANNEXURE 6

### 6. Product Mix Analysis for the Claimed Invention

1. Food (by, time, by service, by day, by server or channel)
A la Carte One Course
   Two Courses
   Three Courses
   Degustation Menu
Pre-Theatre Menu
Post Theatre Menu
Promotional Menus
Take away revenue
Home Delivery revenue
   2. Beverage (by time, by service, by day, by server or channel)
Alcoholic Beverage Revenue
Non-Alcoholic Beverage Revenue
Soft Drink Revenue
Tea & Coffee revenue
   3. Supplementary (by time, by service, by day, by server or channel)
Window seat surcharge
Preferred booking time surcharge
Extended Time Surcharge
Booking Fee
Gift box
Chocolates
Roses
Other retail items, books, oil,
Room Hire Charges
   The above analysis, similar to all other embodiments detailed within the submissions and within this annexure can be undertaken by area, subarea, class, table, distribution channel or any other definable input, constraint, or item within the scope of the claimed invention.

### ANNEXURE 7

### 7. Revenue and Customer Performance Analysis for the Claimed Invention

1. Revenue Analysis
RRSH (Revenue per Revenue Seat Hour)
RASH (Revenue per Available Seat Hour)
RRTH (Revenue per Revenue Table Hour)
RATH (Revenue per Available Table Hour)
Revenue per Chair
Revenue per Table
Revenue Per Person
Revenue per person by courses, by class, by menu, by time booked, by booking duration
Revenue by area, subarea, section, class and by their respective square meters (also prorata over the whole restaurant)
Revenue by additional restaurant items, by area, subarea, section, class, table
Revenue by supplementary items, by area, subarea, section, class, table
Revenue by table type
Revenue by Table number
Revenue per Total Hours including prep and closing up
Revenue per Kitchen Hour (Kitchen Hours−Open Hours)
Revenue by Front of House Hours (Front of House Hours−Open Hours)
Customer Retention rate (Total Customers−Total New Customers) divided by total Customers
By time of Booking
By seating
By repeat versus new customers
By type of Customer
Revenue During peak Times
Revenue During Non-Peak times
Revenue During Shoulder Periods
Average spend per customer by all metrics
Times Tables Turn (total duration times divided by the number of people)
Function Revenue (also as a 5 of total revenue)
Home delivery as a % of total Revenue
Take Away as a % of total Revenue

2. Customer Analysis
Customers per Service
Customers by booking time, by service, by day
Customers by menu, by course, by class, by area, by subarea, by section, by day
Customers by occasion
Customers by group size
Customers with Supplementary Items and by Supplementary items
Customers without Supplementary Items
Customers by duration booked prior to the service requested
Customers by booking source
Customers by promotion
Customers by Average Spend
Loyalty Members Average Spend
Average Spend by member type
Repeat Customers by average spend
New Customers by Average Spend
Average spend by individual type, adult, child, high chair
Total customers versus repeat customers versus new customers

3. Customer Ranking
Ranking by venue membership
Ranking by number of visits
Ranking by Spend total and per visit
Ranking by social media profile and social influence
Ranking by relationship (agent, reseller, friend, family, supplier, etc,)

4. Channel Analysis
Revenue by channel
Ranking by channel

### ANNEXURE 8

### 8. Staff Analysis and Roster Parameters for the Claimed Invention

1. Staff Analysis and Ratios (based on customer numbers, menu complexity and menu diversity)
Kitchen staff per customer (ratio)
Kitchen Staff Hours per customer
Kitchen Hand per customer (ratio)
Kitchen Hand Hours per customer
Wait staff per customer (ratio)
Wait staff hours per customer
Food Runner per customer (ratio)
Food Runner hours per customer
Bar Staff per customer (ratio)
Bar Staff hours per customer
Food Runner per customer (ratio)
Food Runner Hours per customer
Reception staff per customer
Reception Hours per customer
Kitchen preparation times to tables and customer ratios
Set-up times to tables and customer ratios

### ANNEXURE 9

### 9. Restaurant Profit and Loss Layout (a La Carte)—Example, for the Claimed Invention

| Different Areas | | | | |
|---|---|---|---|---|
| Main Dining | Private Dining | Bar | Total | % of |
| Room | Room | | Restaurant | Revenue |

### Revenue

Food Revenue
Breakfast Menu
A la Carte Menu: One Course
   Two Courses
   Three Courses
Tapas menu
Café menu
Bar Menu
Degustation Menu
Pre-Theatre Menu
Post Theatre Menu
Promotional Menus
Supper Menu
Take away Menu
Home Delivery Menu
Total Food Revenue

Beverage Revenue
Alcoholic Beverage Revenue
Non-Alcoholic Beverage Revenue
Soft Drink Revenue
Tea & Coffee revenue
Total Beverage Revenue

Supplementary Revenue
Window seat surcharge
Preferred booking time surcharge
Booking Fee
Gift box
Chocolates
Roses
Other retail items, books, oil,
Room Hire Charges
Total Supplementary Revenue

Less: Credit Card Fees

Less: Commissions

Less: Variable Booking Fees

Less: Loyalty program allowance (“hard currency”)

Net Revenue

### Cost of Goods Sold Variable Costs 1

Food Costs

Beverage Costs

Alcoholic Beverage Costs

Non-Alcoholic Beverage Costs

Tea and Coffee Costs

Total Cost of Goods Sold

Contribution 1

### BH (Back of House) Wages Variable Costs 2

Gross Back of House Wages (including overtime and temp workers)

On-Cost Back of House Wages (super, workers comp, payroll tax)

Back of House additional Costs (staff meals, uniforms, etc,)

Total Back of House Wage Costs

Contribution 2

### Front of House Wages Variable Costs 3

Gross Front of House Wages (including overtime and temp workers)

On-Cost Front of House Wages (super, workers comp, payroll tax, staff meals)

Front of House additional Costs (staff meals, uniforms, etc,)

Total Front of House Wage Costs

Contribution 3

### Operational Variable Costs 4

Packaging

Repairs and maintenance

Breakages

Delivery Costs

Laundry

Chemicals

Linen

Tea towels

Kitchen Duct Cleaning

Restaurant Cleaning

Garbage and Sanitation

Printing and Menus

Decoration Expenses (flowers)

Equipment Hire

Transport

Security

Variable Booking Fees

Total Operational Variable Costs 4

Contribution 4

### Entertainment Variable Costs 5

Entertainment (Bands, Djs)

Events

Total Entertainment Variable Costs 5

Contribution 5

### Marketing Variable Costs 6

Social Media

Advertising

Total Marketing variable Costs 6

Contribution 6

### Utility Variable Costs 7

Water

Electricity

Rates and Taxes

Utility Variable Costs 7

Contribution 7

### Premises Overhead Costs 1

Rental Costs

Lease marketing levy

Lease Outgoing expenses

Council Rates and Fees

Contribution 8

### Ownership Overhead Costs 2

Depreciation

Interest

Insurance

Health Inspections and Compliance

Ownership Overhead Costs 2

Contribution 9

### Head Office Overhead Costs 3

Administration Wages

Accounts

Marketing (Memberships and registration)

Telephone & Communications

Consultants

Computer

Head Office Overhead Costs 3

### Net Profit/Loss (Contribution 10)

Other Items (Extra Ordinary items)

### ANNEXURE 10

### 10. Break Even and Cost Analysis for the Claimed Invention

1. Break-Even Analysis
BESUF (Breakeven Seat Utilisation factor)
BERSH (Breakeven Revenue Seat Hours)
BERPH (Breakeven Revenue per Hour)
BERPP (Breakeven revenue per Person)
BERPT (Breakeven Revenue per Table)
BEASH (Break Even per Available Seat Hour)
BERY (Break Even Revenue Yield)

2. Profit and Loss Statement, Cost Analysis Ratios and Percentages
To model the business and the performance of the business the profit and loss statement needs to be restructured so that all costs parameters can be identified independently and within homogeneous groups. All prior art systems do not detail items in the detail listed below and with our minimum 10 level contribution and analysis system.

a) Level 1 Analysis—Cost of Goods Sold
Menu Costings
Mark-up per menu item as a percentage
Mark-up per menu item as a dollar value
Food COGS (Split by venues and courses)
Alcohol Beverage COGS
Non-Alcoholic Beverage COGS
Tea and Coffee Beverage COGS
Contribution Margin after COGS

b) Level 2 Analysis—Back of House Wages
BH Wages Gross (Wages split by preparation, by service and by clean-up)
BH Wages On-Costs
BH Wages Total Costs
Contribution Margin after COGS and BH Wages

c) Level 3 Analysis—Front of House Wages
FH Wages Gross (Wages split by preparation, by service and by clean-up)
FH Wages On-Costs
FH Wages Total Costs
Contribution Margin after COGS and BH Wages and FH Wages

d) Level 4 Analysis—Operational Variable Costs
Operational Variable Costs 4
Contribution Margin after COGS, BH Wages, FH Wages and Operational Costs 4

e) Level 5 Analysis—Entertainment Costs
Entertainment Variable Costs 5
Contribution Margin after COGS, BH Wages, FH Wages, Operational Costs 4 and Entertainment
Variable Costs 5

f) Level 6 Analysis—Marketing Variable Costs
Marketing Variable Costs 6
Contribution Margin after COGS, BH Wages, FH Wages, Operational Costs 4, Entertainment
Variable Costs 5 and Marketing Variable Costs 6

g) Level 7 Analysis—Utility Variable Costs
Utility Variable Costs 7
Contribution Margin after COGS, BH Wages, FH Wages, Operational Costs 4, Entertainment
Variable Costs 5, Marketing Variable Costs 6 and Utility Variable Costs 7

h) Level 8 Analysis—Premises Fixed Overhead Costs
Premises Overhead Costs
Contribution Margin after all Variable Costs and Premises Overhead Costs

i) Level 9 Analysis—Ownership Fixed Overhead Costs
Ownership Overhead Costs
Contribution Margin after all Previous Costs and Ownership Overhead Costs

j) Level 10 Analysis—Head Office Administration Overhead Costs
Head Office Overhead Costs
Net Profit Margin after Head Office Overhead Costs

### 3. Other Cost Performance Measures and Analysis

Total Payroll Costs as compared to revenue (all operational payroll costs)
EBITDA
Inventory Turnover
Overhead Rate per metric
Customer Acquisition Cost (Marketing Variable Costs divided by Total New Customers)
All cost categories by: (per Available Seat Hour)
   (per Revenue Seat Hour)
   (per Available Table Hour)
   (per Revenue Table Hour)
   (Opening Hours versus total kitchen Hours)
   (Open Hours versus total Front of House Hours)

### ANNEXURE 11

### 11. Supplier Pricing Comparisons and Monitoring for the Claimed Invention

Comparison of Pricing by suppliers for the same item
Reliability of Suppliers
System to select the best supplier to send the order to

1. A computer-enabled method for creating a volumetric space/time framework of constraints for the dynamic allocation of a booking request to one or more spaces in a venue, comprising the steps of,
providing a user interface arranged to receive input regarding spatial and qualitative attributes of the one or more spaces as represented within a volumetric space/time framework, and also to receive input regarding physical and spatial and qualitative attributes of one or more furniture items including modifications to the furniture items and the associability of the one or more furniture items to the one or more spaces in the venue as represented within the volumetric space/time framework, whereby the attributes define a plurality of relativities and contextual relationships between the one or more spaces and each one of the one or more furniture items, the user interface further being arranged to receive input regarding one or more quantitative and qualitative constraints utilisable by the framework to optimally allocate the booking request,
whereby the relativities and contextual relationships within the volumetric space/time framework provide dynamic variation in the allocation of furniture items within the one or more spaces in response to a booking request for one or more of the one or more furniture items in the one or more spaces in the venue, to satisfy the quantitative and qualitative optimisation criteria,
whereby upon cation of the algorithm, the framework is arranged to produce an optimised allocation instruction set for the one or more spaces and the allocated bookings, whereby the optimised allocation instruction set is saved in the database and displayed, upon request, by a space allocation user interface to one or more users.

2-56. (canceled)
